(19) United States
(12) Patent Application Publication
(10) Pub. No.: US 2019/0189302 A1
(43) Pub. Date: Jun. 20, 2019

(54) Applied Sciences Absolute Technologies GODPARTICLES Balancing The Magnetosphere

(71) Applicant: Svetozar B. Petrovich, Chicago, IL (US)

(72) Inventor: Svetozar B. Petrovich, Chicago, IL (US)

(21) Appl. No.: 16/350,746

(22) Filed: Dec. 31, 2018

Related U.S. Application Data
(63) Continuation-in-part of application No. 15/731,310, filed on May 22, 2017, now abandoned.
Application No. 15/731,310 is a continuation-in-part of application No. 15/530,056, filed on Nov. 28, 2016, now abandoned.
Application No. 15/530,056 is a continuation-in-part of application No. 14/545,930, filed on Jul. 9, 2015, now abandoned.
Application No. 14/545,930 is a continuation-in-part of application No. 13/999,086, filed on Jan. 10, 2014, now abandoned.
Application No. 13/999,086 is a continuation-in-part of application No. 13/135,617, filed on Jul. 11, 2011, now abandoned.
Application No. 13/135,617 is a continuation-in-part of application No. PCT/US2010/000188, filed on Jan. 25, 2010.
Application No. PCT/US2010/000188 is a continuation-in-part of application No. 15/998,165, filed on Jul. 10, 2018.
Application No. 15/998,165 is a continuation-in-part of application No. 15/932,502, filed on Mar. 7, 2018.
Application No. 15/932,502 is a continuation-in-part of application No. 15/932,525, filed on Mar. 9, 2018, now abandoned.
Application No. 15/932,525 is a continuation-in-part of application No. 15/330,085, filed on Aug. 2, 2016, now abandoned.
Application No. 15/330,085 is a continuation-in-part of application No. 13/999,105, filed on Jan. 13, 2014, now abandoned.
Application No. 13/999,105 is a continuation-in-part of application No. 13/068,587, filed on May 16, 2011, now abandoned.
Application No. 13/068,587 is a continuation-in-part of application No. 12/658,099, filed on Feb. 1, 2010, now abandoned.
Application No. 12/658,099 is a continuation-in-part of application No. 12/153,036, filed on May 13, 2008, now abandoned.

(30) Foreign Application Priority Data
Jul. 11, 2012 (US) PCT/US2010/000319
Dec. 6, 2012 (US) PCT/US2012/000572

(51) Int. Cl. G21H 7/00; F01K 27/00

(52) U.S. Cl. CPC G21H 7/00; F01K 27/00

(57) ABSTRACT

A super plant comprises absolute technologies an ultra-transport system, an ultra-cycling light fluids bulk power electromagnetic fluids creep, stiffness precise balancing displacements energy, minimum energy balancing, minimal energy displacements for cosmological global gravitational dynamics conforming nullities relativity energy cycles to energy relativity structures comprising:
means for opposing global air warming, affecting Heat Rate maximum efficiencies of the ultra-transport system, Regions 1-5 ultra-longevity boundaries ultra-fluxing, ultra-conserving the bulk power, the mega bulk power, boundaries perfections, and the magnetosphere mega bulk power Regions 4 portions mega bulk power portion.

### BACKGROUND OF THE INVENTION

Nuclear power generation by absolute technologies, ultimate energy conservation claims science.

Applied sciences-technologies, theoretical physics disunity roots emerge three hundred years ago with accepted phenomenon of gravitational mass attraction force. Einstein, scientific community at al. eighty years ago claims theoretical physics discovery of curved space time phenomenon not unlike, in fact affirms, existence of said gravitational attraction. For last three decades, scientific community insists GODPARTICLES being atomic structures ingredient. Scientific communities also claims that CO2 concentration in air causes global are warming. None of it is absolute truth.

For two centuries, the USPTO licenses energy devices, based on structure appearance of devices. Congressional Rules and Regulations—for certain—licenses intellectual property on merits based on an energy device performance criteria. Also,—for certain—structure appearance and structure performance is not one and the same energy device intelligence, as the performance intelligence.

Cosmological gravitational dynamics is superior intelligence continuously revealed the Universe energy structure. The scientific community for centuries claim science advancements, where the Universe shows the science advancements. Again,—for certain—the two are not the same. Thus, structure appearance, at best, may be licensed as a superficial intelligence of intelligent property. In each and every instance, effects of cycling energy dynamics, of an energy device intelligence, is energy device intelligence; the two differentiate enormously, one is artificial and the other real.

Respectful request, herewith, is made that the intelligence of energy device in these applications, this application claims, is based on performance not on appearance; since intelligence is revealed by energy device performance in environment—not on energy device appearance in environment. Herewith, respectfully submits, energy device performance, in examining Procedures to adopt to, where each claim on the device as multiple dependent claim, reads on device as dependent claim.

Energy device intelligent property resides incontrovertibly in performances within the device and into light fluids' environment within energy cycling dynamics successive boundaries perfections.

For decades, scientific world looks into atomic structure for GODPARTICLES to eventually find none. If it looked in cycling intelligence cycling successive boundaries perfections which bodies cycling cosmological global gravitational energy affect, it finds them. We did, and here they are.

“Global warming” cosmological roots, herewith, explains. Applied science technologies explain. The Universe cosmological gravitational dynamics cycle plasma. Earth gravitational field cycles light molecular fluids and plasma. The light molecular fluids, the plasmas cycle incompatibly; in time domain, Earth gravitational field energy dynamics climate changes outflow plasma to space.

First and foremost, the Universe, the Earth are essentially energy device precise cycling the light fluids energy wherein the Earth's light molecular fluids cycling supports life and sets up the light molecular fluids, the plasmas energy transports longevity issues respective incompatible cycling.

A nuclear power plant, the Earth and the Universe embody similarities, comprising inventions or applied science innovations, and theoretical sciences understanding cosmological energy cycling. It turns out with extraordinary regularity, theoretical science theoreticians misconstrue cycling of cosmological gravitational dynamics. At advent of science, where not much is known in the last eight decades, because elite theoreticians ‘do know better’ fundamental Laws are ignored. In the meantime, the applied science practitioners languish motivated by—good enough is good enough.

Earth's life existence cycling molecular fluids' imperfection face challenge, where cosmological gravitational dynamics cycling plasma fluids unyielding absolute conformance insistences insists on perfections. Applied science technologies absolute, unprecedented, par excellence perfection, on par with those of best theoretical science, best offers the life existence imperfections a chance.

“We choose . . . and do the other things, not because they are easy, but because they are hard. . . . The greater our knowledge increases, the greater our ignorance unfolds . . . ” Inventions innovation and declarations support that. A decade is a very long time and most likely time ‘We’ have, also.

Principal Theories' crucial, profound, blunders effectuated by the prior theoretical sciences these CIP applications correct, especially application Ser. No. 15/932,502 with its CIP application Ser. No. 15/998,165. Corrections of the Principal Theories' blunders disclose that the only valid technologies the ADS CIP applications disclose and claim. Affecting the energy devices Fluid Elements and Advanced Fluid Elements energy devices inbred technologies in bounders' perfections energy, henceforth—boundaries perfections—cosmological gravitational dynamics cycling energy dynamics sets forth.

Said Fluid Elements, boundaries perfections and said energy devices claiming structures disclose cosmological gravitational energy dynamics spawned effects of global air warming phenomenon, which a no surprise to this inventor, an energy evolution of the Earth's gravity field phenomenon affects. Effects of Earth's gravity field's evolution technologies of boundaries perfections and in energy devices these applications disclose and claim and the USPTO denies for the last ten years.

It took about ten years, at least, to realize the USPTO licensing criteria for energy devices relying on the prior art and structure appearance cannot properly examine a device energy structure. The cited prior applications state precisely and succinctly the licensing criteria for the energy devices.

Boundaries perfections absolute technologies, the Fluid Elements, said Advanced Fluid Elements cosmological gravitational dynamics effects entirely govern. Academia and industry, in the prior art, utilize energy structure stresses to design energy structures; energy devices such structures, it turns out, cannot meet boundaries perfections criteria cosmological gravitational dynamics do set forth perfections for energy device structures in the Universe; otherwise energy evolution occurs;

Avoiding evolution in Earth's gravity elastoplastic energy field, this, said CIP applications claim. First and foremost these applications correct deep and profound flaws in the prior sciences; going back nigh one hundred and the roots of sciences, these deep and profound flaws weigh on human race, wherein, now, said deep and profound flaws threatens all life extinction on the planet Earth.

For over ten years, the filed applications persistently submit advances in licensing that pertains to energy dynamics cycling technologies, from a dark age into and well beyond the 21^{st} century; the applications disclose/claim absolute Laws of Nature sciences, absolute technologies and absolute energy devices, which must become ubiquitous ever present match to climate changing potential.

Each application of over fifty applications follows its co-pending prior application in the chain of applications, where the ADS detail up to present date a third of that chain. The over fifty number of applications includes PCT filed, also, published applications. The PCT published applications claim the priority documents applications and, therein, subject matter, comprising the intellectual property published under the inventor's name, which identifies owner of the intellectual property which the inventor claims. The inventor also claims the USPTO filed and published applications and all applications filed and on record in the USPTO database. The ADS is the continuity detail in portion of the over fifty applications the inventor files with USPTO and the USPTO PCT R/O.

### SUMMARY OF THE INVENTION

A super plant comprises absolute technologies an ultra-transport system, an ultra-cycling light fluids bulk power electromagnetic fluids creep, stiffness precise balancing displacements energy, minimum energy balancing, minimal energy displacements for cosmological global gravitational dynamics conforming nullities relativity energy cycles to energy relativity structures comprising:
a reactor to steam generators (SGs), primary coolant loops radially inline piping hot legs to the SG, cold legs return portions inside a primary containment, comprising Regions 1;
the reactor, primary coolant loops piping Regions 1, radial inline hot legs from the SG to turbines, condenser units to the SGs, secondary coolant loops cold legs return, Regions 2;
a containment, annex structures slight negative pressures in Regions 2 portion, Regions 3;
hydrosphere, underground aqueducts, cooling water, mega bulk power cycling Regions 4;
and bulk power electrical distribution and environment cycled epigene energy, Regions 5;
and means for opposing global air warming, affecting Heat Rate maximum efficiencies of the ultra-transport system and Regions 1-5 ultra-longevity boundaries an ultra-fluxing, an ultra-conserving the bulk power, the mega bulk power, sustaining boundaries perfections, the magnetosphere mega bulk power and Regions 4 portions of mega bulk power portion.

These: Hydrogen, Helium, Nitrogen, Oxygen atomic weight 1, 4, 14, 16 form light fluids and water, water vapor or steam molecular weight 18, in mixtures of 78% nitrogen, 21% oxygen, and nigh 0.04% of CO₂ and other gases and the nitrogen, oxygen, water based molecules and ions, in mass with energy mixtures engendering cycling nullities, including radiations, in space and time.

Herein, Heat Rates maximum efficiencies exclude the reactor, the SGs, the high pressure pumps, the turbines, the condenser units and secondary piping coolant loops, a cold legs return and pump house pumps, which imposes mechanical machinery fabrication art on the ultra-transport system. Primary, secondary coolants are the light fluids, water threated, processed, specific compositions.

Cycling gravitational field mega bulk power in environment cycles coolant fluids' a tertiary loop. The Regions 1, the Regions 3 comprise the containment building annexing of the annex building. Space time domain, epigene surface, atmosphere, ionosphere, magnetosphere embodies the mega bulk power fluxing and cycling through underground aqueducts inside the Regions 4 boundaries; Geographical areas Regions 5 portion fluxes gravitational sink mass energy and electrical power. Gravitational sink, mass energy spin, orbit, and precession dynamics binds the mega bulk power.

The mega bulk power embodies spin, orbit and precession energy dynamics of energy actions in time domain balanced to spin, orbit and precession energy dynamics in much larger mega bulk power within Universe energy structure. In time domain of gravitational field geneses, the much larger mega bulk power acts as energy of reactions; in being much larger, it forces spin, orbit and precession in common spin, orbit and precession an energy dynamics conformance. Conforming boundaries perfections of the mega bulk power effectuates the mega bulk power large boundaries perfections where Earth's gravity field resides inside Milky Way and Solar System gravity fields.

Genesis of a celestial body by cosmological gravitational dynamics spin, orbit and precession ultimately balance a spin, orbit, and tumble and/or precession energy dynamics, in portion of that Universe energy structure. In genesis of the celestial bodies, a presence of a Sun solar insolation, in space time, comprises energy on action dynamics, spin, orbit, and tumble, and/or precession in that portion of the Universe energy structure. Solar insulation radiation redistributed energy adds energy reaction dynamics in boundaries perfections radiations penetrate; when energy reaction dynamics overpower momentum of energy action, an evolution of boundaries perfections occurs.

When evolution of boundaries perfections occurs, energy outflowing may occur; where such evolution of boundaries perfections is that of the magnetosphere and the energy outflowing is of permanent nature, such permanent energy outflowing spawns the Earth's gravity field evolution.

Global air warming, “global warming” phenomenon, of the Earth's atmosphere spawns most fundamental science, since Earth's gravity field an overabundance of water vapors must respond to Sun's insolation. Feedback response to solar insulation in such a space time spawns global air warming, since ample water masses and rising temperatures feed abundance of water vapors into the Earth's atmosphere. There should not be a scientific issue with any of such events occurring.

At the root cause issue is prior theoretical sciences promulgated flawed theories. The Theory of Relativity has flaws. E mc²; no curved space-time and no attraction mass property can exist. Cycling cosmological gravitational dynamics energy, eternalized energy and masses with energy cycling dynamics bind Universe energy structure masses and energy. Earth's Gravity in Gravity Fields Evolution continued in par application Ser. No. 15/932,502 In Evolution of Gravity Fields explains. In these applications, eternalized energy and the prior sciences mass pertain to one and the same.

Evolution of gravity fields is eternal space time phenomenon in the Universe energy structure that reveals flaws in the prior science. Glacial ice mass over entire globe start to disappear as the first and most sensitive responder to global air temperature rise. The prior science, especially the theoretical science, cannot accept that prior Principal Theories embodies science profound flaws, which incontrovertible and prima facie evidence in the cited applications extensively documents.

It turns out that CO₂ concentration improves air conductance of energy, which assists the Air Cells cycling to cool the gravity field global air masses, where such concentration, in turn, deters water vapors concentration. Excess water vapors in air boosts cycling energy dynamics a gravity field evolution. The theoretical and experimental sciences, the Principal Theories force profound flows and scape goat these flows by blaming CO₂ emissions for the Theories outright blundering. Our Universe energy structure highly fundamental dynamics and human existence provide prima facie evidence that the Universe is not a semi static structure that the principal scientific Theories or therein taken constants would have us believe; these Theories profound science is pure fiction.

Cosmological gravitational dynamics, nonradioactive atomic elements ultra-conserve energy, mass to ultra-retain subatomic particles eternal longevities absolute boundaries absolute spinning and cycling of electrons mass about nuclei. Conversely the radioactive atomic elements emitting quantum energy through atomic boundaries spawn cycling mass and energy half-life phenomena.

The ultra-longevity boundaries cycle energy dynamics which retain the light fluids; wherein, cosmological gravitational energy dynamics infinity upon infinity of everything cycle and/or flux quantum energy paths-of-passage (PP) lengths of a PP lengths sums least sum (PPLSLS) nullity, the PPLSLS nullity sum. Boundaries perfections engender a compiling of all quantum sums into nullities, constituting respective mass quantal quanta, which spawn the PPLSLS nullity sum. All of, which comprise the bulk power in Regions 1 and Regions 2 into the mega bulk power cycling dynamics of the energy relativity structures, the stratosphere boundaries, and the magnetosphere. Cosmological gravitation dynamics entirely conform to the First (FL) and Second (SL) Laws of Thermodynamics (FSLT), affirming nullities' technologies the ultra-longevity boundaries affect.

Each quantum flows directionality lengths' cycling energy, bound in the paths-of-passage lengths (PPLs), compiling the PPLLS entirely reliant on energy of the ultra-cycling and the ultra-conserving and the ultra-fluxing the Laws of Thermodynamics governed, led by the First and the Second Law. The PPLLS entirely reliant unique compiling inside boundaries yields atoms, Ions and Isotopes, which individual, joint and in common compiling of the ultra-longevity boundaries enjoin in one of the energy relativity structures and boundaries perfections of the magnetosphere.

Fundamental and Advanced Fluid Elements spawn mass energy highest conserving (MEHC), the MEHC, energy environment of the ultra-longcvity boundaries, boundaries perfections, which cycle the Universe conforming to the FSLT and cosmological gravitational dynamics, by cycling nullities' sums nullity. Super plant absolute technologies cycle the light fluids' energy dynamics to the nullities' sums nullity of the bulk power comprising the ultra-longevity boundaries sequent Regions 1-5 cluster cycling energy dynamics, with the ultra-fluxing, the ultra-cycling boundaries perfections of fundamental Fluid Elements, the Advanced Fluid Elements, Advanced Processors. Wherein, cycling energy dynamics affect thermal energy transfer back into Earth's epigene mass, and the nullities' sums nullity, Heat Rate 100% efficiency is a manifestation of one and the same.

Gravitational fields, gravitational sink grids and associating magnetic fields, concomitant energy sources and sinks cycling energy and radiations, with radiations wind pressures constitute individually, jointly and in common the ultra-conserving mass energy nexuses which embody the relativity energy, embodying Newton's universal gravitation proportional energy in the Universe, between any two and all mass energy quanta and mass energy nexuses, including Black Holes; in all instances, the quanta, the nexuses and Black Holes embrace boundaries perfections respective eternal longevities which start with atoms and electrons and ends with Galaxies mass and energy. The energy of displacements, displacement and volume change energy is unknown, unless elastic deformation and volume change plastic distortion are defined and structure or system boundaries are defined. In the Universe space time domain quantifying that energy is an impossibility; even for a simple structure, it is cumbersome. However, recognizing its presence is entirely sufficient. Einstein and Newton assume gravity fields' stable, rigid boundaries, which are outright blunders.

The prior art preferred methodology computes materials elastic range stresses, accounting indirectly for energy. Herein declaims the applied sciences energy technologies simplest account by omitting article ‘the’ in front of ‘energy of distortion and volume change’ as undefinable mass energy volume fluxes, until the ultra-longevity boundaries or boundaries perfections mass energy and volumes make that energy quantifiable; many occurrences in Nature vary continuously, such as, boundaries perfections, cycling directionalities, energy gradients, where mass energy, volume and pressure on fluid boundaries as interactions energy—the relativity energy—affect quantifiable displacements energy. The Universe energy structure balances itself precisely in that manner, by boundaries perfections energy cycling the nullities' sums nullity, Heat Rate 100% efficiency. At interfaced boundaries, design fluids balance the displacements energy by independent, calibrated energy sources balancing energies of the interactions energy to a minimum energy balancing, the minimum displacements energy. Herein, innovating structure technologies control the energy of displacements the ultra-transport system allows with the relativity energy a permitted magnitude.

In Regions 3, in-situ measurements account for each in situ construction deviation, which by itself is a very important advancement over the prior art. The minimum energy balancing and the minimal energy displacements is time domain present energy cycle that only shows up in situ spawned quantified indispensable presence, the ensuing further details. Likewise, the light fluids impurities fluxing such concentration deposited by energy forms merit no definitive article ‘the’.

The minimum energy balancing, the minimal energy displacements collective sums occur by happenstance to equal to Newton's universal gravitation proportional energy, or the universal gravitation proportional energy force between two celestial bodies, misconstrued as the universal gravitation attraction forces. In the Earth the super plant taken technologies analogy, think of the primary coolant loops as the troposphere, with the secondary coolant loops as the tropopause, the stratosphere, where the super plant absolute technologies, the magnetic field's cusps embody two safety valves and stratosphere plasmas a natural elastoplastic fluids facilitated elastoplastic creep.

Then, terminologies of the minimum energy balancing, the relativity energy pertain to the ultra-longevity boundaries and distinctive relativity energy domains boundaries perfections in the Advanced Processors, the super plant energy cycling, where the former is natural, the latter is the absolute technologies one and the same technologies respective plasma, molecular fluids cycling. Paragraphs may pertain to energy of one or both, disclosed by paragraph addressed technologies.

Two celestial bodies Universe and the super plant reveals terminology analogies. One or both of the two celestial bodies, which affects the relativity energy within boundaries perfections larger mass and energy, can comprise any number of celestial bodies embodying a common mass invariable disk plane angular momentum and an energy centroid. Primary and secondary coolant loops, high energy piping cycling the bulk power of the ultra-cycling light fluids' nullities spawn the interactions energy, the relativity energy, the minimum energy balancing, the minimal energy displacements, the ultra-transport system, cycling the light fluids and energy cycles in Regions 3.

The relativity energy is the interactions energy; it equals cumulative sums of the minimal energy displacements and the minimum energy balancing. Electromagnetic compositions design of embrace fluids, the electromagnetic fluids, has all of the Regions 3 elastoplastic displacements to embody concomitantly the minimum energy balancing and the minimal energy displacements. Said technologies analogy correlates the electromagnetic fluids, Earth's magnetic lines reconnect portions; the electromagnetic fluid, the electromagnetic fluids or simply the fluid is synonymous.

The relativity energy spawning energy field tridimensional space infinities of the interactions energy comprising interactions-lattice energy flowing plasmas and radiations and wind pressures energy spawns the relativity energy. An interactions lattice with an inter-reactions lattice relative energy actions, relative reactions relative inter-reactions affect everything levitating in space—the Universe energy cycling first and foremost engendering boundaries perfections in energy device.

In space, said nullities' sums nullity levitate everything that cycles energy and boundaries perfections initiated by atoms and molecules and continued in galaxies and galaxies cluster. The scientific community curving space time mechanisms in the tridimensional infinity's energy field of the relativity energy, the relativity energy field, cannot exist, especially at interfacing of and in specificities of boundaries perfections spawning continuous clustering of boundaries perfections.

Cosmological gravitational dynamics engenders energy relativity field comprising energy directionalities cycling the ultra-longevity boundaries and also boundaries perfections of celestial bodies, concomitantly affecting infinities upon infinities of concomitant energy algorithms which by ubiquitous plasmas flows palliate cycling energy peaks cycling relativity energy field energy. All such reveals Nature supreme energies, which comprise cosmological gravitational dynamics.

Here, the technologies analogy pertains to science and the absolute technologies to an MEHC absolute conserving of cosmological gravitational dynamics, the relativity energy field energy, in turn, likewise, to engender concomitantly boundaries perfections. Said Nature supreme energies, cosmological gravitational dynamics, concomitantly palliate a relativity energy peak in energy of gravitational sink to re-impose the MEHC absolute conserving in gravitational sink mass energy.

AGW energy abstracting the MEHC absolute conserving in Earth's gravitational field is most basic fundamental and root cause of global air warming; energy phenomena among many energy indications of deficient energy cycling thru Earth's gravitational sink, includes plasmas outflows; the energy indications exist. Since flaws in the prior science overlook existence of the Advanced Fluid Elements and the relativity energy; the prior sciences amiss the absolute technologies many facets and root causes of global air warming. Cycling energy minimizing relativity energy peaks in the relativity energy peaks which a gravity sink spawns by the MEHC absolute conserving, the MEHC, energy absolute conserving the prior art amiss, which the absolute technologies disclose.

Globally, corporate and scientific communities could not have selected less preferred devices than solar panels and wind turbines to combat global air warming. These devices block, obstruct cycling energy cycling inflowing into epigene surfaces mass and gravitational sink. In fact, such devices, by nigh entirely sapping cycling energy and converting it to electrical power, oppose the MEHC, the absolute conserving, and the gravitational sink cycling energy in environment, which magnify concomitantly insolation energy. An opposing of the MEHC or the absolute conserving of energy boosts the relativity energy, the relativity energy peak, comprising locally the relativity energy field energy, the relativity energy field a local peak and mass and energy a concentration.

Tridimensional infinities' energy field of the relativity energy field has energy spikes and vacuum voids and concomitantly spawning sources, sinks and Black Holes. The celestial planets gravitational sinks can affect the relativity energy spike rounded summit by cycling energy about respective gravitational sinks, as the tropopause does. Flowing energy flows, as fluid, away from such summits; and, that energy, the relativity energy portion, outflowing the Earth's gravitational sink, reveals global air warming, in spite of Earth's energy budget 5% to 6% radiation into space.

In time domain, days' durations lengthen, from 19 hr to 24 hr; likewise, the Moon continues to spin away from the Earth, comprising prima facie credibility that the Earth's gravitational field is weakening. In turn, Earth's slowing spin, decreasing energy, unavoidably weakens the magnetic field. In turn, the relativity energy and plasma fountains outflowing mass energy directionalities, which are orthogonal to those cycling inside the troposphere and the tropopause, spawn mass and energy cycling that saps energy from the energy directionalities effecting the gravitation sink. In turn, slowing cycling rate magnifies insolation energy, which, in turn, boosts global air warming.

The relativity energy field and the relativity energy shown in Milankovich cycles in early Pleistocene Epoch comprises the energy directionalities, consistently compiled energy quantified quanta, consistently break away from Earth's gravity sink in 41 ka periods. Energy cycling solely about Earth's gravitational sink free of outflowing plasma energy directionalities oppose the light fluids outflow and sustain a steady cycling rate. The troposphere, tropopause accruing insolation energy attenuates and impurities concentration drop, where, in turn, the next 41 ka cycle initiates. Milankovich cycles plasma fountains, Earth spins, Moon-Earth partings, light fluids cycling rates and soil structure deposits of impurities concentration discloses cosmological global gravitational dynamics; the relativity energy field MEHC and the nullities' sums nullity absolutely conserving energy balance shows the energy relativity structures, one energy field affects global air warming root cause. These reveal the theoretical Principal Theories perpetuates an utter and total disaster.

Energy evolution in gravity fields is each and all boundaries perfections eternal phenomenon, which appears and becomes only apparent at specific time periods. In the magnetosphere energy cycling the Earth's gravity field, Milankovich noticed its evolution regular cycling about seventy five years ago, which become apparent temperature cycling about 41 ka periods affecting climate changes. Earth's gravity field evolution takes such 41 ka cycling periods for nigh 2 million years.

Irrational, egotistical science community takes the Earth's gravity field evolution as a climate variations natural cycling and not as Earth's gravity field permanent changes, wherein the plasma fountains clearly show that is not the case. Wherein, Earth's energy budget clearly shows energy cycling the atmosphere, Air Cells energy cycles, are inefficient to balance solar insolation energy and global climate, no one can admit that the principal scientific Theories are profoundly flawed; rather, global community elite shifts blame game from the theoretical sciences to CO₂ emissions.

Curved space time must set forth and define a curved space displacement energy needs an energy balance minimum and parameters of choice. Curved space time must define and set forth energy of curvature slope sustaining trends in, across boundaries perfections and from atoms thru energy sinks which affect gravity fields and galaxy clusters and engender boundaries perfections.

Otherwise, curved space time is promulgated irrational, general theory of energy dynamic irrational fluxing by the prior sciences Principal Theories, a nonexistent energy theorized to exist in the one energy field of the energy relativity structures spawning the Universe energy structure. Global air warming prima facie credibility fundamental and applied sciences disclose a deep and profound flaws in the prior sciences and applied art. In the Earth's gravity field said sciences art, especially wind turbine and solar panel technologies cycling energy Heat Rate low efficiencies in the Universe energy structure and the one energy field unbalances the energy relativity structures of the Earth's gravity field; the prior sciences and art do not understand the severity of such flaw.

The MEHC absolute conserving governs the ultra-cycling, the ultra-conserving by embracing boundaries perfections, the relativity energy, and the absolute technologies. Regions 1 through 5 aspects of the MEHC embody ultimately shortest tridimensional loop lengths, the ultra-longevity boundaries, cycling the light fluids to a nullities' sums nigh nullity and ultimate energy transfers. The MEHC absolute conserving the Regions 1-5 engender with electrical and mechanical energy cycling cumulative maximum efficiencies bounded by boundaries perfections of the troposphere.

Electromagnetic fluid elastoplastic deforming engenders the relativity energy in the ultra-transport system of Regions 3, which bolsters Regions 3 integrity. Thereby, the relativity energy generated by the ultra-transport system entirely complies with the bulk power cycling maximized light fluids energy transferring efficiencies and concomitantly boost Regions 3 overalls integrity. Wherein, Regions 3 cycled concomitantly electrical and mechanical energy Heat Rate maximum efficiencies concomitantly cycles through Earth mantel thermal energy, which reverses direction in evolution energy from the Earth's core back to Earth's gravity sink away from the atmosphere.

The Regions 1 comprise the bulk power cycling the nullities nullity of the light fluids cycling coolant in primary loops. Regions 2 effectuate cycling the bulk power transfers from the primary coolant loops to turbine, condenser units' cycling the bulk power coolant within secondary loops. Regions 3 comprises the containment and the annex buildings an HVAC system circulating air to the light negative pressure. Celestial bodies exemplifying the Advanced Fluid Elements embody Earth's magnetosphere, the energy relativity structures of the atmosphere, and the ultra-longevity boundaries of the Advanced Fluid Elements and respective energy of the troposphere, tropopause and the stratosphere, which cosmological global gravitational dynamics do balance by levitation. Regions 1-5 cycling thermal energy through the mantle lightens thermal load of the troposphere.

The First Law states that in energy systems mass energy cannot be created or destroyed. Any system comprising boundaries perfections, the ultra-longevity boundaries yields a closed system. Technicians' referral to ‘renewable energy’ are deeply and profoundly flawed. Any definition of a ‘renewable energy’ systems boundary is undefined, since energy is not creatable, or renewable. Even in frictionless media voids, cosmological gravitational dynamics do cycle energy. Einstein, scientific community misallies the Second Law by ill-advised, granted such profound deep flaws.

It is certain that Einstein's Relativity Theories et al. and Newton's Gravitational Theory et al. violate the Laws of the Thermodynamics as these cosmological Kafkaesque mass energy theories mislay energy paths, sources and sinks diversity. Newton misplaces, Einstein misapplies, United Nations IPCC disregards and CERN project mislays, all amiss, the Second Law applied sciences.

Sir Arthur Stanley Eddington wrote “The law that entropy always increases holds, I think, the supreme position among the laws of Nature. If someone points out to you that your pet theory of the universe is in disagreement with Maxwell's equations—then so much the worse for Maxwell's equations. If it is found to be contradicted by observation—well, these experimentalists do bungle things sometimes. But if your theory is found to be against the second law of thermodynamics I can give you no hope; there is nothing for it but to collapse in deepest humiliation.” Unless said cosmological gravitational dynamics technology imposes absolute and ultra-maximal mechanical and thermal efficiencies to globally applied sciences, the collapse turns into extinction of species. Only Tesla's sciences breeds hope, as the Newton-Einstein Theories contaminates all associating the applied science technologies deep and profound absolute flaws do toward demise of sciences.

Einstein at al. curved space time theorizes a homogeneous, uniform system unitary Universe; otherwise mass energy circulations results from dense to less dense mass energy, from sources to sinks of mass energy that require counter balancing circulations. This application nexuses reveal mass and energy boundaries perfections and the ultra-longevity boundaries from atomic elements to the fundamental Fluid Elements, the Advanced, and the ultra-longevity boundaries of Systems and Galaxies balancing dispositions which absolutely conserve energy. The atomic elements, the Fluid Elements complete complement clusters cycle, flux, and balance the Universe mass energy nullities to sustain cosmological energy with enormously dynamic Universe levitating mass state.

The nullities of cycling mass energy dynamics cycled in boundaries perfections do interrelate and can accelerate, decelerate inside the ultra-longevity boundaries by pressure in the light fluids or plasma densities. Configuring cycling energy dynamics balance reposition, disposition fluxes interrelated boundaries perfections complete complement on both sides of boundary perfections. The prior Theories art, especially the theorized four dimensional coordinate system curved space time stunning and jaw dropping Kafkaesque fundamental envisioning cosmological gravitational dynamics disregard the applied sciences core kernels science of the Laws and Principal Theories.

The atomic elements and the Fluid Elements constituting the ultra-longevity boundaries show cycling dynamics unusual fluxing deformations enormous energy in light fluids boundaries. The Fluid Elements and boundaries perfections disclosing existence of the ultra-longevity boundaries engender cosmological gravitational dynamics profound sciences and quantum energy dynamics.

Dynamics of the light fluids, especially plasmas spawning the ultra-longevity boundaries and magnetic field boundaries, cycles in reactions to gravitational sinks energy in environment. And, cycling energy dynamics system in magnetic, cosmological gravitational field cycles energy flow analogous to flowing fluids as if by massless radiation means. In environment, energy dissipates as propagating fluids densities are dissipating; all of which the prior Theories and the art ignores.

Energy in environment superimposed dynamics (EESD), the EESD, in omnipresence utilizes relentlessly gravitational dynamics balancing mass of cosmological energy; likewise, embodying energy of vaporization, of sublimation and of freezing, melting, of condensation, deposition, and of ionization, recombination forces phases changing thermal-energy processes from solid state to plasma state. These processes affect buoyancy, combustion, erosion, friction, gas emissions, and stratifications, gradations processes may also spawn dissolutions of boundaries perfections in the Fluid Elements, the Advanced Processors. AGW, a novelty, belongs in a category of dissolution.

Cosmological gravitational dynamics comprise the energy relativity field, and the MEHC and the absolute conserving of mass energy at magnetosphere boundaries. Earth's gravitational field, sink, nowhere duplicated in the Universe, cycles the light fluids to rebalance itself and spawn the ultra-longevity boundaries of the magnetosphere boundaries, which, likewise, embodies reaction to insolation radiation energy penetrating the atmosphere and energy dynamics, which levitate its boundaries. The previous paragraph cites insolation energy reactions, which, likewise, embodies energy that in all respects spawn magnetosphere boundaries and environment energy—the EESD.

The prior sciences theorizing Milankovich cycles in the Pleistocene Epoch switching into present ecliptic primary frequency nigh 125 ka is flawed. In fact, switching primary frequency to 21 ka precession frequencies occurs. Since AGS emits enormous energy into environment, in the last centuries, cycling rates in the gravitational sink to force slow, sooner plasmas outflow. Now, magnetic field cups appear to persistently outflow plasma. All cycling comprises the MEHC, the absolute conserving of energy; energy cycling effect two dominant directionalities: within or out of Earth's gravitational sink. The letter is global air warming root cause effects of the root cause, and most, if not all energy emissions at least at emission points, impose the letter directionalities.

Wind power ‘renewable’ energy siphons cosmological global gravitational dynamics with the light fluids, the EESD that environment energy cycles. Slowing cycling coolants flowing rates in gravitation sink degrades environment natural self-cooling. The ultra-conserving of environment energy cosmological gravitational dynamics spawn cycling the nullities' sums nullity of the light fluids cycling; wherein, heat of condensation escaping to space thru thermal transparencies of the stratosphere, actually radiating heat of evaporation into space, effectively cools epigene surfaces.

Emission cuts in CO₂ is justified, indeed. Yet, solar panels electrical power generations stops radiations inflow into epigene gravitational sink, magnetic field core, which eternally drains both energy fields. Unless energy inflows epigene gravitational sink, the EESD a directionless energy saps the ultra-longevity boundaries of Earth's energy fields, also, Earth's boundaries perfections. Thus, AGW energy may oppose cycling fluids cycling energy innate directionalities into Earth's gravitational sink, in turn, generating the relativity energy peak in the energy relativity structures.

Disclosures of the light fluids engendering longevities of boundaries perfections confirms the MEHC innate self-sustaining genres and innate spawning of the ultra-longevity boundaries of the fundamental, the Advanced Fluid Elements. Only, the light fluids and plasmas affect boundaries perfections of fluids energy. Avoiding an atmosphere utilization as a gravitational sink is hugely important, where space time domain a limited opposition to cosmological gravitational dynamics can turn deadly. Wind turbine and solar panel technologies appear to take exactly such a chance.

It is disappointing and very disturbing that for seven decades profoundly flawed gravitational theories are touted by theoreticians in face of notable very fierce very valid opposition. Wherein, and clearly, solutions to the science of cosmological gravitation entirely depends on revelation of the fundamental, the Advanced Fluid Elements. Sciences climate change vitalities depend on the ultra-longevity boundaries of the light fluids. Disclosing sciences of the Fluid Elements resolves not only cosmological gravitation issues but, also, the applied sciences, the Theory of Uniformity and the applied science Theory of Everything, declaiming the climate change issues many facets.

The applied science Theory of Everything and Theory of Uniformity yield key to all theories. The fundamental and the Advanced Fluid Elements with Atomic Elements hold scientific keys to the Theory of Uniformity. While electron current flows as fluid, in atoms electron spin is eternal about the nuclei. Mass and energy eternally bounded everything yields boundaries perfections of atoms. The Universe cycles, reverberates and evolves mass and energy nullities deformation and volume changes energy, which embrace boundaries perfections with clustering of Fluid Elements and the Advanced Processors. None in the prior Theories, science or art is useful. By theorizing curved space-time, in general, assails the supreme laws of Nature, the First and the Second Law.

Claimed clean renewable energy generation in environment, in fact, utilizes cycling energy in environment, which is absolutely perfect in every respect and constitutes the MEHC proven Heat Rate of 100% efficiency through billions of years. That energy, in fact, is energy of cycling that balances energy of all nullities, the nullities, effecting the magnetosphere spawned global climate temperatures in environment. The compositions of the nullities cycling in environment normally comprises the light fluids in excess of 99% and CO₂ of 0.3% to 0.5% and other impurities, whose energy affects the EESD cycling globally the nullities' sums. Effects of cosmological and global gravitational dynamics effectuate causes and effects, which yield balances of the cycling nullities and their interactions show 0.01%-0.03% CO₂ concentration changes cannot embody such energy.

Collectively, technocratic dispositions take for granted the magnetosphere magnetic lines and epigene surfaces. Thus, generating the ‘clean renewable energy’ by wind turbines or solar panels takes for granted the EESD, the cycling energy by environment, which, in fact, consumes energy sustaining the cycling nullities and cosmological gravitational dynamics, which affect boundaries perfections of the atmosphere. Cycling nullity as such yields perfection, and all energy spawning energy sum in the cycling nullity should not deviate from nullity, as such may imperil boundaries perfections. In the magnetosphere, energy cycling said nullities nullity evolves moderate climate that affects and sustains life and is only known place in the Universe that can claim that paragon.

Testing ‘renewable’ against the First, Second Law reveals that the wind turbines, solar panels consume 100% efficient power committed to the ultra-fluxing the magnetosphere and cycling the nullities' sums. Such testing shows that the wind turbines, solar panels generate electrical energy from energy balancing the nullities' sums and boundaries perfections, which balance and sustain boundaries of magnetosphere magnetic lines and epigene surfaces. Stunningly instantaneous and unbelievably enormous displacements of boundaries constituting the magnetosphere disclose that energy in environment through stratified layers of the atmosphere enormously magnifies itself by quantum energy accuracies, especially and specifically evident at constraining boundaries. In the art of air conditioning, lowering cycling rates in closed environment are known to affect a slower cooling of that environment. Performance of the wind turbines, solar panels blocks all or almost all flowing energy directionalities conforming to the cycling nullities, thereby, causing the EESD environment generated flowing byproduct 100% nonconforming to energy cycling directionality.

All planets, with any type of atmosphere, exhibit energy cycling issues. Glaciation effects of each and every geological epoch, epigene surface features including the magnetic field's shifting its disposition, point to the EESD, cosmological gravitational dynamics energy cycling spawning violent. effects associated with unbalances in energy cycling. Very discouraging, disappointing is the wind turbines, solar panels selections to oppose global air warming when their Heat Rates are moderate to poor, while opposing instead of facilitating energy cycling which cools environment.

By billion-year proven longevity, the magnetosphere fauna and flora spawn chain upon chain cycling nullity upon nullity perfection nullities cycling mass energy. The prior art renewable and clean energy claims is deeply, very profoundly technocratic, wherein consuming absolutely clean natural processes environment cycling energy dedicated to maintain life and climate perfection is instead to produce electricity. Stunningly, all of that the First and Second Law clearly denounce.

Physical and chemical exoergic, exothermic and endothermic actions and reactions which evolve, occur and subside and cycle in and out of existence, including winds and wind pressures, radiations and radiation pressures the EESD in environment effectuates. Whereby, cosmological gravitational dynamics, gravitational sink, and magnetic field environment self-conserving yields ultra-conserving genres of the MEHC; the light fluids engender the ultra-longevity boundaries of boundaries perfections, wherein infinity upon infinity of diversities constitute cycling nullities of PPLLS least sums that affect cycling nullities sum that is the PPLLS nullity sum of the Universe.

The USD engenders the energy reactions in genres of boundaries perfections to spawn, also, evolve entelechy of the ultra-longevity boundaries reverberating cycling actions, reactions chains affecting a sequent of boundaries perfections of the atoms, the molecules, the Fluid Elements and the Advanced Processors. Physical and chemical parameters and genres associating with actions and reactions exposed by the Earth's glaciation geology and the gravitational and magnetic fields magnetosphere fluxing confirms solution to the Uniformity Theory, known as uniformitarianism, the uniformitarianism in inorganic and organic domains, with the Theory of Everything solutions to boundaries perfections, the ultra-longevity boundaries and the absolute technologies. Claims in the applied sciences comprise declarations in cosmological principles which embraces Earth's light fluids cycling in boundaries perfections and within three gravitational sinks: the Earth's, the Sun's and the Galaxy's. The Earth losses of the light fluids endangers life on Earth. Undertaken research believes that a forth of Earth's water, more than one atmosphere volume is lost to space.

In mass energy bound sources and sinks, balancing boundaries perfections infinite diversities by quantum mass energy PP, in and from sources into and in mass energy sinks, affects a sum of the PPLLS quantal masses quanta transport from sources to sinks to ultra-conserve mass and energy. Regions 4 and 5 cycle, flux the light fluids, the PP quantal mass energy nullity, the MEHC of the PPLLS entire length, the ultra-longevities boundaries, and boundaries perfections, portions of the ultra-transport system, the PP cycling the nullities. In the super plant comprised Regions 1-2 the inline piping hot legs embodies into the ultra-transport system wind cones self-alignment effects, where electromagnetic fluid displacement a creep, a stiffness responses to electrical power inputs engenders electromagnetic fluid creep and stiffness inside an electromagnetic transducer, and the minimum energy balancing, the relativity energy, affecting the ultra-longevity of the super plant;

The displacement response to electrical power, wherein a displacement total displacement yields a minimum energy balancing of the relativity energy, by the stiffness in confined electromagnetic fluid and nigh infinitesimal creep, which also affects the ultra-longevity of the super plant, the ultra-transport system by affecting dynamic loads damping.

Strengths of material technologies set forth interactions by elastic, shear and bulk moduli, comprising the minimum energy balancing and the relativity energy sustained low static stresses, spawn interactions among loads, stresses, strains, and displacements, where the minimum energy balancing, the relativity energy low static stresses dampen or entirely suppress dynamic loads by electromagnetic fluid stiffness and creep, which grants the ultra-longevity of Regions 3 structure;

Applied science theoretical mechanics energy of displacements with volume change technologies sets forth strains and deformations. The prior art uses ultimate load and/or working stress design of structures. Here, displacements and strains measured entelechy, as it occurs, reveal and affect the super plant very simplicity. Controlled temperature, pressure and stress energy ranges, creep and deformation energy of distortion and volume change, in the super plant, comprise equipment minimum stresses in environment, energy of distortion and volume change a steady state, and the light fluids cycling the nullities' sums mechanical, electrical highest Heat Rates efficiency, while slight negative pressures spawn the ultra-longevity, the ultra-conserving of Regions 3. Structural stresses spawn the minimum energy balancing invaluable interaction stresses cycling energy flux that elastic displacement change in volume of the containment, the annex buildings embodies the ultra-longevity of buildings cluster. Calibrated electrical power inputs into electrical transducers convert into electromagnetic fluid stiffness, creep and volume change energy, where the minimal energy displacements spawns the minimum energy balancing of the ultra-transport system for the electromagnetic fluids retained energy and the ultra-conserving, the ultra-longevity of Regions 3.

The minimum energy balancing Regions 3 constitute the ultra-transport system, the buildings cluster interactions balance by electromagnetic transducers affecting and fluxing electrical power electromagnetic fluid inputs, which engender the ultra-fluxing and the ultra-cycling and the ultra-longevity Regions 3 boundaries change of the ultra-transport system. The electromagnetic fluids varying stiffness restricts the minimum energy balancing in the ultra-transport system, Regions 3 to nigh 0.10% of yield stress nigh an order of magnitude less than in the prior art; backstops limit entirety of electromagnetic fluids' displacement and volume change; the fluxing power input, the electromagnetic fluids optimal stiffness relative yield strength dampens all cyclical stresses to the minimum energy balancing that effects the ultra-conserving, the ultra-longevity of the Regions 3.

The Earth and aforesaid super plant technologies analogy engender, utilize elastoplasticity of gravity field energy cycled cosmological global gravitational dynamics affecting the atmosphere, especially the ionosphere. General, symmetrical aerodynamics of globose spherical shape boosts Heat Rate efficiency in the gravity field cycling energy dynamics. Therein, elastoplasticity in the gravity field cushions the Sun's radiations, wind with wind pressures battering by the atmosphere and especially the ionosphere elastoplastic displacements with deformations of atmosphere shape changes. The Earth's atmosphere and ionosphere enormous elastoplastic volumes in comparison to all of the other planets explain the Earth's temperate climates lasting through billions of years.

The atmosphere and especially the ionosphere spawned elastoplastic through billions of years concomitantly spawns sustained moderate climate and longevity in the gravity field's boundaries perfections. All of which result from energies' cycling dynamics Heat Rate maximum efficiency of energy cycled in the atmosphere, where the cycling energies are mainly those of the Air Cells.

The electromagnetic fluids engender precisely same, crucial analogy functions in the absolute technologies of the super plant—comprises Heat Rate maximum efficiencies of the ultra-transport system, Regions 1-5 ultra-longevity boundaries the ultra-fluxing ultra-conserving the bulk power the mega bulk power sustaining boundaries perfections, the magnetosphere mega bulk power and Regions 4 portions mega bulk power portion the ultimate longevity for the ultra-transport system total energy of displacements. Herein, the calibrated electrical power inputs into electromagnetic fluid stiffness, creep energy of volume change yield the minimum energy balancing, the minimal energy displacements of the ultra-transport system by the electromagnetic fluids retained energy.

The calibrated electrical power inputs into electromagnetic fluid balance energy imbalance of displacements energy total, to ultra-conserves Regions 3 and maintain boundaries perfections the ultra-longevity. All such reveal the absolute technologies the super plant key technologies which spawn boundaries perfections for energy device structures cycling energy dynamics to Heat Rate maximum efficiencies affecting the ultimate longevity of energy cycling dynamics. The absolute technologies do affect science technologies criteria for energy devices cosmological gravitational dynamics do to affect gravitational field energy dynamics cycling technologies eternal longevity.

First step copying said celestial bodies' inbred technologies accommodates the prior ultimate load and/or working stress of the prior structure technologies from the Maximum Principal Stress theory (Rankine theory) to analyzed structures failure to theory of the Maximum Principal Strain. This step contrary to belief in the prior art enormously facilitates the construction of super plants.

Second steps copying the inbred technologies of celestial bodies embody the electromagnetic transducers at primary structures exigent boundaries permitted displacements, which lower static compressive stresses to 10% to 20% of allowed stress the Rankine theory allowed and to dampen largely peaks of cycling stresses; said allowed stress engenders super plant's millennia longevity.

Third step copying the inbred technologies of celestial bodies let the absolute technologies of the ultra-transport system incorporate free displacements of the ultra-transport system, except for compressive stresses said 10% to 20% of permitted stress, which assure integrities of the primary structures assemblies analogous to tridimensional compression depression in the Universe energy structure spin, orbit and precession of celestial bodies, all of which the prior applications explain. The third step spawns that analogy into the absolute technologies of the ultra-cycling light fluids.

The forth step provides backstops to said free displacements, which preclude said exigent boundaries permitted displacements, which exceed said compressive stresses said 10% to 20% of permitted stress at any one locality; this step employs cameras and measuring devices continuous monitoring the exigent boundaries, where the absolute technologies the compressive stresses said 10% to 20% of permitted stress assures integrity of the ultra-transport system and the super plant. In an event, these features affect and spawn much higher structure integrity than the prior art can.

The fifth step incorporates steps 1-4 in boundaries perfections of the Fluid Elements, wherein the electromagnetic transducers granted said displacements spawn said compressive stresses said 10% to 20% of permitted stress at any one locality, and the minimum energy balancing, the ultra-transport system affected the minimal energy displacements. Energy parameters cycling the bulk power cycling energy Regions 2 and Regions 3 portions embody the light negative pressures, the relativity energy, the EESD, inbred boundaries perfections of the primary containment, the annex building, which these applications define and set forth in sui generis boundaries perfections, also.

Whereby, Regions 2, Regions 3 portions, the ultra-transport system inbred structures cycling energy dynamics of the light fluids engender the minimum energy balancing, the minimal energy displacements, and the EESD cycling energies environment, which match, conform to the energy parameters the mega bulk power cycling energy dynamics space environment engenders. All the energy parameters pertains to engendered inbred structures of Regions 2, Regions 3 portions said ultra-transport system, which engenders energy device structures to parameters of cycling energy dynamics, where these energy devices cycle to Heat Rates nigh 100% efficiencies thru millennia.

These applications disclose precise energy device structures with cycling energy dynamics in environment of the EESD. Mass and energy conservation the Laws of Thermodynamics innately cycle in energy dynamics having boundaries perfections of the Fluid Elements and the Advanced Fluid Elements, engendering Heat Rates nigh 100% efficiencies, which is precisely cosmological gravitational dynamics, cosmological global gravitational dynamics spawned space environment.

The applications ADS, CIP chains, steps 6, 7, 8, and 9 claim the fundamental Fluid Elements, their clustering and the Advanced Fluid Elements, the Advanced Processors and structures of the Fluid Elements cycling energy dynamics innately affected the sui-generis boundaries perfections. Steps 10 and 11 disclose respectively that the Theories of Relativity, the Newtonian gravitational attractions promulgate deep, profound, common, inbred, theoretical sciences' fundamental flaws.

Step 12 discloses energy criteria for constructions of energy devices cycling energy dynamics of the Fluid Elements spawning energy device structures cycling Heat Rate maximum efficiency.

Step 13 claims energy dynamics criteria for energy device structures cycling the flight fluids.

Step 14, Steps 1-14, show correct applied science facts lead advances in theoretical sciences.

Step 15, Steps 1-15, criteria for energy devices structure show, the USPTO relegates a device performance to evaluated structure appearance rather than intelligence that affects assigned tasks.

Step 16, Steps 1-16, show no USPTO criteria to examine critically in energy device structure crucial energy cycling dynamics, which the 21-century crucial environment undeniably warrants.

Step 17 in Steps 1-17 presents incontrovertible, prima facie, physical evidence various stages of evolution in gravity fields shown effects surficial effects of the five planets closest to the Sun, present inconvertible, prima facie facts the applied science technologies lead theoretical sciences.

Step 18 sets forth structure criteria for the energy forms three types cycling energy dynamics.

Steps 1-18 should conform to the Laws of Thermodynamics, especially the Second Law. All of which these applications set forth. Wherein, the theoretical sciences in the theoretical sciences applied art claiming benefits, which empower self-promotion, in fact, place potentially enormous liabilities onto human race existence by missing entirely the Second Law. All of which becomes irrational technologies science the ADS CIP applications detail explaining curved space time and gravitation attraction—flaws in Relativity Theories, Newtonian gravitation prior art, respectively.

The USPTO examinations of energy device structures cycling energy dynamics misconstrues the Second Law interpreting by 37 CFR Rules performance criteria. A misplaced Second Law in that performance criteria empowers critically legal profession and the prior theoretical science to do each of the two by itself could not do—govern, overrule applied science superior technologies. Liabilities to public shift from legal profession and the prior theoretical science back onto public. Paris Climate Change Treaty failure to yield an agreement shows that may no longer be possible.

The applied science technologies and energy device these ADS CIP applications disclose and claim prove global air warming climate changes are not CO₂ in air concentration but evolution of energy phenomenon in Earth's gravitational field. Concomitant, deep, and profound flows in the Theories of Relativity and the Newtonian gravitation these applications prove incontrovertibly to realities hard to believe. Therein, concomitant profound climate change liabilities proposed Paris Climate Change Treaty stipulated agreement shifts back from the public mainly US citizens back to where the liabilities potentially originate—elites which construct and authorize energy devices.

Liabilities shift back to flows the Principal Theories and the scientific communities, which in the past and in the present condone these Theories. The onus falls on elite legal professional, the legislator that enacts, the technology professional that constructs, the performance criteria inbred conformances to 37 CFR set forth performance criteria or another country set forth energy device comparable criteria. The prior Application claims such energy design criteria, which do conform to 37 CFR set forth performance criteria, wherein the USPTO interpretations of 37 CFR based on structure appearance set forth performance criteria with cited prior cannot do to needed certainty.

In the chain of the prior two application, nonconformance of NOTICES to 37 CFR Rules and missing energy criteria for structures documents filed bring into cognizance of the Commissioner for Patents. In this application, a space in each of electromagnetic transducer devices embodies a space for the electromagnetic fluid, which is not enumerated, since National or Military Standard for nuclear plants is not available and performance onus falls on the electromagnetic fluid having flawless performances of the electromagnetic fluid in the electromagnetic fluid each device. The vendor(s) warranting electromagnetic fluid performance of the electromagnetic fluid each device is assigned sole responsibility to enumerate and designate the electromagnetic fluid a mandatory volume and space in each device having the electromagnetic fluid. Therein, the electromagnetic fluid trip out disconnect nuclear plant from electrical grid, therein, therefore, is not unacceptable.

The prior Application explains that the Earth's gravitational field huge ionosphere affecting huge electromagnetic field comprising outermost magnetic lines. There, the outermost magnetic lines a trip-out disconnect completes one cycle of Milankovich cycles of changing climate. The prior applications explain Milankovich cycles and origin of global air warming phenomenon that traces through energy evolution Earth's gravity field said cycles detail for over 2.2 million years.

Profound and deep fundamental truths of absolute sciences makes it extremely important that absolute truths become transparent. These applications make it apparent that global elite seventy five years ago wrestles global sciences leadership from Tesla science and bestows that leadership upon the Relativity Theory flawed sciences on behave of global elite professions shared interests.

Thus, the absolute truths place onus on the present day global elite continuous misconstruing absolute truth sciences to assign blame to CO₂ in air concentrations for phenomenon of global air warming; rather, global elite must correct deeply flawed promulgated theoretical sciences, which reap benefits for global elite and shifts liabilities from global elite professions to global citizenry.

Earth's evolving gravitational field cycling energy dynamics evolving climate changes in the last 2.2 million years Milankovich cycles detail. Applying the Theory of Uniformitarianism and established known facts of that Theory to all of the gravitational fields of the Solar System make it—for certain—at least the five planets closest to the Sun affect cycling energy dynamics climate changes. The known status of these planets epigene surfaces show—for certain—such is the case.

These planets epigene surfaces and gravitational fields' inbred, enormous differences prove—for certain—the root cause of climate changing is energy dynamics changing cycles with changed energy evolving dynamics cycling rate that spawns boundaries perfections of gravitational fields.

And, that is precisely what the absolute technologies do in and to structure of energy devices.

Whereas, the five planets closest to the Sun spawned present statuses of epigene surfaces and climates prove, global air warming, “global warming” phenomenon, said respective gravitational fields, specifically evolving said cycling energy dynamics in the Earth's gravitational field affect. Whereby, gravitational fields of the Solar System concomitantly continuously evolve boundaries perfections respective boundaries. Whereby, Milankovich cycles each cycle completion includes the plasma fountains energy outflows. The plasma fountains affect over fifty outflows in the last 2.2 years. Global scientific elite, global elite in general for above stated reason does ignore it all.

The previous paragraphs explains and confirms Tesla's points of views and arguments at that time. He vehemently, correctly states that absolute truths leadership in all resides in technologies of sciences the Law of Thermodynamics mandate and not in flawed Theories of Relativity which violate the Thermodynamics First and Second Laws. For a time being, Tesla's points of view are still losing after seventy five years; wherein, each elite profession continues to claim that specific interest of specific profession claims a legal, shared interest, if not outright ownership of absolute truths' residence. In the meantime, the human race, the life on Earth proceeds toward extinction.

The previous paragraphs point out indispensable enormous value of the absolute technologies and energy devices these applications disclose and claim. First and foremost and in general these applications disclose the absolute truths of everything and anything and the absolute technologies of energy devices and these technologies a value, these applications disclose and also claim. The absolute truths of everything and anything origins reside in cosmological gravitational dynamics, gravitational field effects—for certain—not in the flawed Theories of Gravitation and Relativities.

Anything and everything absolute truths—for certain—must not reside in 37 CFR Regulations of legal professionals, where energy devices performance criteria is missing for century, relies on flawed irrational theorizing like Gravitation, Relativity Theories, Einstein and Newton theorizing does. No one may do perfections of energy devices like cosmological gravitational dynamics do; cosmological gravitational dynamics do it to a set of Laws—the Laws of Thermodynamics. From sciences advent, global elite relegates the Second Law, thus, most Laws of the Thermodynamics.

Global elite persist on imposing specific interests, self-benefits, even when these self-benefits drive human extinction, ignoring said Laws. These applications do turnaround. The applications apply strict conformances to the Laws of Thermodynamics, cosmological gravitational dynamics eternally affect, impose, demand; in order to engender eternal structure specific eternal properties of energy devices, demands the absolute technologies cycling energy cosmological dynamics do. These applications, for over a decade, try to license claims to, therein, various versions of the absolute technologies. General, many rejections of the absolute technologies may be summed up into flawed methodology, contrary to the USPTO Procedures licensing energy devices' structure.

Incontrovertible, prima facie evidence respectfully submits this, these CIP applications stated perfections in parameters, properties and structures, affecting the absolute technologies, claiming perfections are valid and true. The absolute technologies show licensing Procedures spawn deep, profound flaws. Wherein, Examiner substituting his intelligence for that of Einstein and Newton may claim make validity of flaws in the Relativity Theories or Gravitational Theory, matters not.

Superior intelligence of cosmological gravitational dynamics affirmed potential, eventual and eternal longevities of cycling energy dynamics in boundaries perfections the electrons, the atoms, the molecular structures own, cycle in boundaries perfections of structures cycling energy. Once boundaries perfections and energy device structure is established, therein structure appearance of cycling energy structure and its intelligence coincide and represent one or the same phenomenon.

This CIP application, these CIP applications copy, trace, and duplicate parameters, properties and structures utilizing the electrons, the atoms, the molecular structures and, therein, boundaries perfections of energy structures to embody the clustering Fluid Elements which engender cycling energies inbred dynamics in boundaries perfections and/or the sui generis boundaries perfections.

The copy, trace and duplicate parameters, properties and structures utilizing the electrons, the atoms, the molecular structures, stated energy criteria for constructions of energy devices energy dynamics cycling boundaries perfections, or the sui generis boundaries perfections. Said criteria conforms to parameters of energy criteria dynamics cycling energy form three energy types. The prior application claims that energy cycling criteria, which these applications apply. That criteria are precisely the same cycling energy dynamics criteria the Laws of Thermodynamics set forth in or by cosmological gravitational dynamics cycling energy dynamics impose in energy structures.

The absolute technologies in this application mainly claim Heat Rate maximum efficiency or, also, efficiencies or maximum efficiencies, also, referred to in industry and sciences as an energy budget of an energy structure or energy system taken boundaries. Maximum energy conductance and the PPLLSL respective parameters which said energy criteria cites pertain, also, especially in Regions 4. Each parameter in energy system structure yields same Heat Rate efficiency method.

For decades, the science community seeks GODPARTICES existence, proves not to exist by the claimed theoretical claim. Science unproven theoretical claims arise from previous centuries unproved gravitational mass attraction genre and nigh century similarly unproven a curved space time science similar nonexistence of theoretical sciences overarching claims respective Theories; these applications explain, trace these physical appearances of space phenomena to cosmological gravitational dynamics, which the scientific community ignores in postulating irrational sciences.

For years, these applications claim the absolute technologies, Heat Rate maximum efficiency quantum energy dynamics and recent applications added energy conductance property. All three comprise three forms of cycling energy dynamics and a version of Heat Rate efficiencies, each of which traces and copies eternal energy cycling dynamics of cosmological gravitational dynamics cycling Heat Rate 100% efficiency. In space, gravitational fields affect energy cycling dynamics in progressively larger boundaries perfections sequence from atoms to and in Universe structure.

These applications disclose manmade the sui generis boundaries comprising structures of the Fluid Elements similar to the Advanced Fluid Elements configured volume cycled plasma energy dynamics cycled cosmological gravitational dynamics Heat Rate 100% efficiencies. Wherein, the Advanced Fluid Elements cycle plasmas and spawn boundaries perfections of plasma ingredients ordinary Fluid Elements, the fundamental Fluid Elements, mainly cycle water and water impurity ingredients in manmade structure of construction material. Professions in technologies advanced energy fields construct and valuate energy devices based on cycling energy Heat Rate efficiency.

Each time an application resubmits cycling energy dynamics based on Heat Rate efficiencies, each time an energy structure is evaluated solely based on appearance of energy device structure; each time the Offices of the USPTO conduct examination based on an energy device appearance.

The prior two filed applications make it clear, these applications advance theoretical sciences by exposing deep, profound, irrational flaws in the Relativity and gravitational sciences Principal Theories. Disclosure of the flaws in the Principal Theories provides incontrovertible, prima facie evidence that an energy structure appearance and that energy structure intelligence as one and the same parameter set forth property is incontrovertibly, deeply, profoundly and irrationally flawed.

Human intelligence has a rating Intelligence Quotient (IQ) based on ability to process tasks at hand cycling neurons energy through brain structure cells, where each cell is grated displacement of a live body limited in space to that of its skull. The IQ, not brain appearance rates brainpower.

Analogously to IQ information processing, energy dynamics cycling rate rates intelligence of an energy device rates processing energy structure intelligence to processes cycling energy tasks. An appearance of an energy device structure cannot and does not do that. The USPTO Examiner examination of an energy device structure do that. Concomitantly, the Universe energy structure examines infinity upon infinity in time space infinities all of energy device structures comprising boundaries perfections of cycling energy dynamics, whereas an Examiner does not even consider energy device structure static loads and relies primarily on appearance an energy structure shown in the prior art. Thus, a prior art review only rationalizes a potential duplicate appearance energy device structures the prior art may show. Little of these examinations has to do with intelligence.

Intelligence of the Universe energy device goes further and promptly valuates cycling energy dynamics Heat Rate efficiency in each of boundaries perfections from each electron through said sequence from atoms to and in the Universe structure created primarily boundaries perfections of light fluids plasma. Each of boundaries perfections engender energy barriers, which yield energy cycling dynamics must cycling Heat Rate 100% efficiency inside each of boundaries perfections.

If cycling energy dynamics accelerate above Heat Rate 100% efficiency volume mass in each of such boundaries perfections forces higher cycling energy dynamics a spin, and/or an orbit, and or precession retaining Heat Rate 100% in each of such boundaries. Wherein, energy required to escape from such boundaries demands high energy. Less than Heat Rate 100% efficiency cycled energy affects low rates inside such boundaries perfections. Energy outflowing from inside these boundaries demands low energy. Science communities by very rare acclamation agree that all of cycling energy dynamics in the Universe energy structure the Laws of Thermodynamics governs.

All energy structures constituting boundaries perfections through time domain must engender cycling energy dynamics Heat Rate 100% efficiency, including the Universe energy structure. In fact, the First and the Second Law conservation of mass and energy cycling energy within, inside an energy system, an energy structure, and a gravity field respective boundaries. Concomitantly, ubiquitously cycling energy dynamics in infinities upon infinities of Heat Rate 100% efficiencies in boundaries perfections may only occur when the Universe energy structures grants boundaries perfections energy free displacements in space time domain. The Universe energy structure does that granting by cycling energy dynamics cycling energy rates in infinities upon infinities of Heat Rate 100% efficiencies in infinities upon infinities of boundaries perfections. Curved space time does not exist at all; curved space time sets forth irrational invention of the Theories of Relativity to rule supreme over global physical, sciences and derails energy technologies for nigh a century.

The prior paragraphs explain curved space time is one of Einstein's misrepresentations of the Universe energy structure superintelligence. It substitutes his intelligence for absolute enormous superintelligence of the Universe energy structure that can affect energy free displacement space, where in a spin or a spin and an orbit cycling rate, which include a precession, contract or distend boundaries perfections volume of an energy field. Wherein, a frictionless medium contraction in response to cycling energy dynamics spawns the energy free displacement space, space volume a portion of boundaries perfections, which buffers a cycling energy potential for outflowing. Thus, each energy field, each gravitational field, respective volume boundaries perfections includes the energy free displacement space which opposes an energy transport across such energy barrier. In addition to centripetal forces of each gravitational field, a spin, an orbit in common energy action spawn individual said energy barriers portions, individually as portions of boundaries perfections proper in common action, assist gravitation fields in common energy actions, to keep structure of the Universe energy structure a whole, while it spins, orbits, precessions and or tumbles in space.

Enormous intelligence of the Universe energy structure enormous ingenuity the Solar System epitomizes, where one solar nebula cloud, one gravity field boundaries perfections, evolves Solar System of planets each affects own cycling energy dynamics and sustains boundaries perfections of the solar nebula cloud. hi each instance, boundaries perfections of evolving gravitational field evolves its energy barriers, also. Ingenuity of evolving energy barrier affects independent energy cycling inside each boundaries perfections and concomitantly grants each boundaries perfections volume to distend or contract inside the Universe energy structure. It is pure inventive brilliance.

Beauty and also a curse of said pure inventive brilliance requires each boundaries perfections volume to cycle energy dynamics Heat Rate 100% efficiency or eventually cease to exist, first by distending such boundaries and then outflowing an energy portion that slows overall cycling rate inside within such boundaries. Described energy cycling process repeats till cycling energy Heat Rate 100% efficiency in an acceptable range. Said superintelligence invention of the energy free displacements the First and Second Law conservation of mass and energy laws governs. When a cycling energy inside boundaries perfections cannot conform to Heat Rate 100% efficiency, such boundaries perfections must transfer a portion of that cycling energy to conform or cease to exist.

The prior paragraph explains Milankovich cycles root causes and effects of a changing global climate. Present, each boundaries perfections volume and the energy relativity structures volume and in common volume comprises Earth's magnetosphere fully distended volumes, which cannot extend no more or very little in a given present time period. Recent ionosphere plasma fountains outflowing unusually infrequent affects very small no convincing, notable global climate change.

Nevertheless, a creeping global air warming engenders an eventual global climate change not because Earth's epigene surface and AWG emits CO₂ but because Heat Rate efficiency of the Air Cells cycled efficiency creeps downwards and accelerates that downward creep, especially in the last fifty years. The magnetosphere boundaries perfections full volume distention poses perilous, unacceptable magnifying potential of the Solar System to syphon the light fluids from the Earth's gravity field. Cosmological gravitational dynamics superintelligence ingenuity affects, embodies affinity for cycling energy dynamics Heat Rate 100% efficiency in the Universe energy structure, boundaries perfections infinity upon infinity of gravitational fields. Wherein, volume of the light fluids cycled energy plasma dynamics may breach boundaries perfections and the energy barriers which retain energy cycling dynamics and inside sequences of successive boundaries perfections.

The Universe energy structure discloses the energy barriers super intelligent construction that avoids potential for a progressive failure that collapses the Advanced Processors energy structure in space. Wherein, magnetic field cusps, the plasma fountains act as relief valves which function as relief valves in space time domain emergency or highly unusual energy dynamics. The energy harriers disclose energy mechanisms which vary volumes of gravitational fields to spawn cycling energy concomitant Heat Rate 100% efficiencies in progressive, successive infinity upon infinity conglomerate bound energy in boundaries perfections constituting the Universe energy structure.

Prior paragraphs present incontrovertible, prima facie evidence that cycling energy dynamics Heat Rate 100% efficiencies in conglomerates of boundaries perfections provide residence to the roots of the Laws of Thermodynamics, where these roots and the Laws of Nature are one and the same phenomena. The energy device criteria for energy devices construction disclosed, claimed in the two prior applications evaluate and rate energy structure against enormous intelligence the Universe energy structure demands, where a human device Heat Rate 100% efficiency is a rarity.

The absolute technologies affect in the super plant unbelievable, jaw dropping, potential Heat Rate efficiencies—achieve what does seem impossible—attain Heat Rate efficiencies above 100% justified in the following manner. First of all, a general construction of the absolute technologies copies, trances superintelligence of the Universe energy structure and tries to account in quantum for energy quanta, whenever and wherever possible spawning the mega bulk power cycles inside and through progressively, successively larger boundaries perfections. Wherein, a selective very large boundaries perfections possess long longevities. For an electric motor the prior application claims, we may select fifty year longevities of selected energy power cycling quanta such energy device structure should cycle for that long time period. For super plant structures, we may select its cycling energy power to cycle quanta longevity in excess of millennium. In man construction of energy devices and longevities, we refer to the sui generis boundaries perfections. Boundaries perfections Nature affects, which man made constructions may affect, must account for longevity by thousands of millennia cycling the Air Cells, the Jet streams mega bulk power cycling energy.

Milankovich cycles disclose troposphere, tropopause spawned boundaries perfections, which we may utilize to duplicate sciences and technologies to embody and duplicate superintelligence sciences and technologies cosmological gravitational dynamics impose. Energy structures in the Universe must cycle energy Heat Rate 100% efficiency or cease and decease all functions and/or intelligence an energy device may claim in space time domain; that is precisely technologies and sciences the absolute technologies implement, as the super plant absolute technologies, herewith.

The absolute technologies continue in part FEIIPMII technologies and prior CIP applications and, wherein, the absolute technologies embody each element and components in any element in boundaries perfections cycled energy dynamics by the sui generis boundaries spawned highest or maximum or absolute highest Heat Rate efficiency. Wherein, the sui generis boundaries account for each components quantum and cycling energy dynamics quanta yielding a range of attainable Heat Rate efficiency an energy device structure specific constructions may attain cycling energy. Therein, the absolute technologies successive, progressing boundaries perfections affect smallest to largest volume boundaries perfections or the sui generis structures of energy device structures.

The absolute technologies affecting the sui generis boundaries provide magnifications of any structure boundaries down to quantum energy sensitive resolutions of any cycling energy cycling quanta in boundaries perfections or the sui generis boundaries. The energy device criteria, which the prior two applications claim correctly set forth the light fluids three different forms of cycling energy type, where one, or more than one of light fluids, plasmas, or electrons may cycle energy.

Photons quanta through space show nigh insignificant mass, disclosed in lensing phenomena, cycling quite different and enormously larger boundaries perfections quanta than Earth's gravity field eternalized energy mass spin, orbit and precession. Einstein, theoretical science community claims to fame by existence of curved space time violate separation of boundaries perfections the Universe energy structure set forth cycling energy dynamics eternal Heat Rate 100% efficiencies in largest, down to smallest of progressive and successive cycling energy boundaries perfections. The absolute technologies, the Laws of Thermodynamics, the Universe energy cycling dynamics each and all three and the Industry and the Academia stipulate energy structures, energy systems, and boundaries perfcctions must set forth, define strictly boundaries of cycling energy dynamics.

When it comes down to energy device structures, and the Universe energy structure is clearly energy structure, wherein no consensus in agreement exists on phenomenon of curved space time theoretical sciences stand-alone in energy fields of the above stated technologies. Computational mathematical derivation proof of existences of curved space time misapply energy systems based on an irrational number resulting from irrational comparisons of incompatible parameters cycling two enormously diverse bodies of energy and eternalized energy mass constituents; incompatible sets of progressive and successive boundaries perfections in the two compared energy systems or structures respective boundaries and between two different energy forms—energy and eternalized energy mass—cannot be taken by an equation as cycling energy dynamics one and the same type.

Forms of energy type, the energy type cycled dynamics, and directionalities vary enormously throughout space and time, each comprising enormously varied, enormously complex parameters of infinitely diverse energy vectors, which are not comparable by totality of distances in space or a time period. Cycling energy dynamics in path vector must be determined in each of successive and progressively enormously increased volume of boundaries perfections, where cycling energy in each of boundaries perfections may enormously vary. Simply, put in another way, theoretical sciences possess no information to do and means to apply such computing. The prior theoretical sciences do not possess a model of the Universe energy structure to make such computing viable.

Most plainly stated, these applications, the text, herein, owns model of the Universe structure affecting cycling energy dynamics successively and progressively enormously larger volumes of boundaries perfections concomitant sequences and real—not a theoretical—model of the Universe energy structure. Continuing in part the FEIIPMII technologies yields the absolute technologies.

The absolute technologies, the Universe energy structure is one and the same forms of energy taken boundaries perfections when the Laws of Thermodynamics and the Fluid Elements and the Advanced Fluid Elements, the Advanced Processors engender delineations of energy fields in the Universe energy structure. Such claimed delineations by the absolute technologies, the Universe energy structure are one and the same successively and progressively enormously larger volumes of boundaries perfections concomitant sequences in space time domain, wherein, the Laws of the Thermodynamics and the Laws of Nature are one and the same laws, which concomitantly affect ultimate mass and energy conservation Heat Rate 100% efficiency by all concomitant sequences.

The energy device criteria for structure of an energy device disclosed, claimed by each of the prior applications provide crucial integrity confirmation and validity of energy device sciences in structure the absolute technologies affect. The absolute technologies compute performance of an energy device structure boundaries perfections in environment cycled energy dynamics by one of the three procedures that the energy device criteria sets forth for computing Heat Rate efficiency.

Space boundaries perfections computed Heat Rate 100% efficiency, according to the Laws of the Thermodynamics, confirms no cycling energy dynamics energy leaves and no cycling energy comes into boundaries perfections, and most importantly affirms the absolute technologies where the Laws of Thermodynamics correctly, incontrovertibly hold to energy mass quantum accuracy; the absolute technologies copy all cycling energy dynamics governing cosmological gravitational dynamics yielding one and the same boundaries perfections of predominantly eternal longevities.

The absolute technologies and cosmological gravitational dynamics, by the Thermodynamics one and the same Laws, cycle energy dynamics spawning boundaries perfections in environment affect primarily Heat Rate 100% efficiencies; all and each occur concomitantly. Established one of the above establishes existences of all of the above. Thus, energy boundaries perfections in an energy device show structure of energy device. The Laws of the Thermodynamics in boundaries perfections yield cycling energy parameters; wherein, most important of these is Heat Rate 100% efficiency. Boundaries perfections engender all energy devices structure parameters, wherein the Laws of the Thermodynamics yield Heat Rate 100% efficiency, conservation of mass and energy the Laws of Nature cosmological gravitational dynamics effectuate one and the same parameters.

The absolute technologies engender Heat Rate 100% efficiency or cosmological gravitational dynamics conservation of mass and energy—either of said two taken as the Laws of Nature affect the same parameters. Thus, energy structures in space embrace boundaries perfections of perfect structures, enforced by cycling energy dynamics of cycling cosmological gravitational dynamics.

Important technologies of the applied sciences advance the sciences by applying the Laws of Thermodynamics, which affect the same sets of laws of the Laws of Nature cycling cosmological gravitational dynamics enforce. Most important technologies of the applied sciences, therein, the art intellectual property intelligence deserves the rating against perfect devices, the energy device criteria these applications set forth—rate a device compliance with the Universe energy structure; the fundamental Fluid Elements, the clustering Fluid Elements embody perfect energy structures.

Structures of the sui generis boundaries perfections force changes in cycled energy dynamics preferred flow directionalities, which incur flow frictional losses at structure boundaries and flow energy transfer into structures which affect flow directionalities change. Said criteria for energy device sets forth the PPLSLS which is bound by a linear length no less than that of laminar flow.

Cycling energy dynamics of celestial bodies which embody perfect structures of the Universe energy structure, which cycle the PPLSLS into eternity of paths-of-passage infinite length, where a cycling path length repeats itself infinite times. A genesis of celestial body affects such cycling energy dynamics existence in frictionless and no cohesion medium cycling energy dynamics into eternity. A gravity field one cycle total path distance a sum of all the PPLSLS must yield nullity; the Laws of the Thermodynamics, the Laws of Nature conservation of mass and energy affects it.

The absolute technologies applied sciences start with theoretical sciences a configuration of a perfect structure that spawns preferred directionalities and cycling energy ideal conditions, which ideally, may engender 100% efficiency for any one of the three types of cycling energy dynamics the energy device criteria sets forth for the energy device structure. The absolute technologies do theoretical sciences adaptation maximum compliance with enormous intelligence of the Universe energy structure, where the first step adopts energy device, structure and/or system boundaries to such boundaries of boundaries perfections the Universe structure affects. We know—for certain—such boundaries conditions the Universe energy structure effectuates cycling energy dynamics to eternity to mass and energy conservation and the Laws of Thermodynamics predicated Heat Rate 100% efficiency in such boundaries. The applied sciences, the absolute technologies duplicate it.

The applied sciences, the absolute technologies especially, implement boundaries perfections the Universe energy structure enormous intelligence implements them back in space time domain of energy cycling dynamics, where nebula dust cloud comprises the Universe. The Solar System nebula is part of that nebula dust cloud. Boundaries perfections of the Solar System evolve from that nebula energy dynamics cycling cosmological gravitational dynamics, which spawn celestial bodies into energy much similar boundaries perfections. Compacting the solar nebula dust cloud into bodies of the Solar System spawns a free energy displacement space which separates cycling energy structures of energy dynamics energy fields. Space of the free energy displacement space takes up vastly more than the Solar System energy fields combined volumes, where the Universe volume of energy structure is mostly the energy free displacement space that may create vacuum.

None of dust particles comprising the solar nebula travels the speed of light; if it does it must escape from the solar nebula. Conversely, no dust particles has mass nullity or it would not yield mass. Wherein, none of the dust particles may be at rest. Nuclear reactions are the Solar System first emission sources of photons from respective eyes of tridimensional compression hydrostatic depression each gravity field and the Universe energy structure impose cycling energy dynamics. Successive, progressive boundaries perfections imposes concomitantly smallest into much larger boundaries of energy volume in sequences of the successive, progressive boundaries perfections.

Mass and energy are not manifestations of one and the same, which the theoretical physicists, the prior science Principal. Theories claim. The previous Application disclosing existences of the tridimensional compression hydrostatic depression, the Fluid Elements shows mass and energy is not of one and the same genre manifestations. In gravity fields, tridimensional depression energy dynamics binds plasmas energy in boundaries perfections of the Fluid Elements or the Advanced Fluid Elements of atoms, electrons and molecular masses respective boundaries perfections bind.

Herein, mass manifests tridimensional hydrostatic compression depression eternalized energy in lapping phenomenon of gravitational fields in space time domain, generally of at least two and three gravity fields. Therefore, energy and eternalized energy, mass, do not manifest one and the same forms of energy. The Laws of Thermodynamics, especially the Second Law tracing energy path in space time domain, discloses incontrovertibly prima facie evidence of that scientific fact.

The previous Application does exactly that, whereas the Theories of Relativity do not, and, in fact, discard the Second Law altogether. Einstein's takes completely irrational lapping of at least four, likely lapping more than four gravity fields, as one and the same gravity field, the Universe, computes an irrational equation result and claims it as a valid proof that curved space time exists.

Said irrational structures taken irrational computing dismisses the Second Law, which loses a cycling energy dynamics crucial portions the Universe energy structure affects. Irrational energy structures irrationally substituting space time scalars discard vectors of cycling energy dynamics; substituted scalars for vectors irrationally deduce a static model of the Universe energy structure. The Universe energy structure is enormously dynamic model which the prior Application details.

The theoretical physics science computing of energy dynamics between two gravity fields claims existences of gravitational mass attraction, which discards the other portions the Universe energy structure cycling energy dynamics affect. Therein, the theoretical physics scientists misplace the Universe energy structure cycling energy dynamics in entirely. The prior application corrects all most irrational science conversion of the Universe highly dynamic energy structure to essentially static energy structure that unavoidably, completely overlooks evolution of Earth's gravity field.

GODPARTICLE failed experiments to prove boson existence disprove the premise that mass and energy manifest as one or as the other of the two. The failed experiments within the scope of the applied sciences confirm the opposite—mass and energy are not one and the same other of the two and evolutions in energy cycles are reversible in relatively short periods and much less likely to reverse long period cycles, where 200 years is a small fraction of Earth's 4.5 billion evolution age. GODPARTICLE experiments support the prior Applications details of the Universe energy structure enormously dynamic model and model of Earth's gravity field also extremely dynamic.

Eighty years ago Tesla was right. Mass and energy is not one and the same matter substance manifesting itself as mass or energy or both. In energy evolutions, the Universe energy structure transforms energy into mass energy transformation processes explained in the prior Applications, mandated by the Laws of Thermodynamic, and not on the premise that mass and energy manifest one and the same the Theories of Relativity takes it. Evolving cycling energy dynamics evolving Earth's gravity field goes under radar in glorified theories. Again, Tesla's vision is the right one.

Within a broad scope of the applied sciences, GODPARTICLE failed experiment affirms and reaffirms that applied sciences communicate absolute technologies absolute truths, or otherwise a failure of an energy structure does occur, where any structure is an energy structure. The applied sciences point out that motivation of the other elite professions differs; each profession competes for the absolute truths. None of them may beat the absolute truths, the absolute technologies, the Universe energy structure, cycling energy dynamics and cosmological gravitation dynamics tells. The Universe energy structure, the absolute technologies, applying the Laws of Thermodynamics embrace the absolute truths which are the applied sciences set forth by the absolute technologies.

Eighty years ago, theoretical physicists' claim to advancing future technologies beyond those of the absolute technologies results in bitter Tesla, Einstein confrontations. Einstein prevails not because he is right. Tesla's each confronting argument on each matter of dispute is undisputable.

Elite professions presented a chance to unseat the applied sciences as king of global influence and prestige elite professions, under leadership of theoretical scientists see and pursue interests to advance their respective elite professional pursuits. Theoretical physicist profession relegates the applied sciences from top of elite profession list; theoretical physicist usurp leadership, legal elite relegates applied science and political, mass media elite impose powers over the applied sciences absolute technologies. The identified above elites discards the Second Law of Thermodynamics.

Mass gravitational attraction stays, curved space time exits, Faraday's experiments stumbling on magnetic property get credit for magnetism discovery, legal profession licenses technology of energy devices, disregarding the Laws of Thermodynamics. Whereby, the absolute technologies the Universe energy structure spawns. Milankovich cycles in the Pleistocene and early Holocene Epochs disclose the absolute technologies stunning action the Universe energy structure imposes.

Very little of the above paragraph may be true; most of the paragraph, which elite professions expound for decades, Tesla's opposition notwithstanding, leads towards life extinctions on Earth. The prior Application, the Laws of Thermodynamics discloses energy structure taken irrationally derives imaginary irrational number; theoretical physics bungled computing cannot be assigned a real number and as such proves nothing and may serve to confirm curve space time nonexistence and as a proof E≠mc². Eight decades after Tesla's passing, we know—for certain—Tesla is right on every one of his points that critics the Theories of Relativity. After eight decades—for certain, after GODPARTICLE dramatic experiments, no elite profession says—Einstein is proven wrong.

Theoretical science proven wrong is like nothing happened. Yet, after eight decades we must utilize Tesla's advancements in technologies' sciences and utilize broadly the applied sciences to boost cycling energy dynamics in the Earth's gravity field. Opposing smartly innate evolution of cycling energy dynamics in energy cycling the Earth's gravity field is enormous task. Start point must be recognitions that Tesla is genius founder in electromagnetism technologies and sciences.

If we need to find GODPARTICLE, and we do; then, GODPARTICLE Tesla discovers eight decades ago, and it is an electric generator cycling electrons energy actions coupled to an electric motor cycling electrons energy reactions. Said two energy devices electrons cycling must spawn the absolute technologies Heat Rate maximum efficiency; the absolute technologies reversing the light fluids circulating energy flows in evolving Earth's gravity field opposes warming global air.

The absolute technologies embrace tools to embody perfections technologies quantum energy flows in the light fluids boundaries perfections spawning the Fluid Elements, the Advanced Fluid Elements, and the sui generis boundaries perfections of energy device structures. Methodologies of the absolute technologies discern energy paths of the light fluids, energy form types, including electrons, where cosmological gravitational dynamics also cycle plasmas energy. In all instances of cycling one or more of said fluids, energy structure intelligence Heat Rate efficiencies discern.

The Laws of Thermodynamics embody key methods for determining Heat Rate efficiency an energy device or a device portion. Energy devices only highest intelligence by highest Heat Rate efficiencies cycling one or more of the light fluids energy forms types set forth these applications scope. One energy forms type should guide the bulk power, the mega bulk power cycling energy dynamics guided directions in boundaries perfections successively larger boundaries perfections.

The prior Application discloses crucial improvements in electromagnetic technologies within the scope of Earth's gravity field evolution, wherein Tesla's inventions of electric generators and motors affect cycling electrons energy very close to Heat Rate 100% efficiencies; these electrons energy guiding guided directionalities guide the bulk power, thereby, guide the mega bulk power cycled Heat Rate efficiencies by guiding directionality of the bulk power. In turn, the mega bulk power boosts guiding electrons energy theoretical cycle above Heat Rate 100% efficiency. Thus, energy guiding electrons cycling Heat Rate 100% efficiency further boost the bulk power energy, the mega bulk power energy Heat Rate efficiency, by opposing global air warming phenomenon.

Tesla's inventions cycling energy of electrons affect Tesla's electrons energy cycling, which, in turn, spawn Tesla's electromagnetic technologies, including the transducers in this application. The Tesla's electromagnetic technologies electrons energy dynamics guides displacement energy in the ultra-transport system and electromagnetic fluids creep and stiffness, where the bulk power ultra-cycling the light fluids bounded in successively, progressively larger boundaries perfections merges into cosmological global gravitational dynamics cycling the PPLSLS conforming energy.

The Tesla's electromagnetic technologies guiding the bulk power cycling modifies cycling of the mega bulk power, thus, modifying directionalities and precipitation periods the light fluids do insulation bulk energy cycle the Air Cells cycle in the Earth's gravity field. The light fluids flow directionalities decreasing path lengths, increasing precipitation periods cycling rates opposes the insolation bulk energy eroding boundaries perfections of epigene surface and the magnetosphere.

The decreasing the light fluids flow directionalities path lengths which increases precipitation periods cycling rates boosts the light fluids, Earth's gravity field cycling energy cycling the mega bulk power and, also, Earth's gravity field cycling cosmological global dynamics energy cycling, the Air Cells energy cycling. Cycling precipitation periods rate boosts, and the Air Cells cycling energy boost shortens precipitation periods and heat of condensation thermal radiation emissions to space cool the atmosphere. The light fluids uniform and frequent precipitations radiate global air warming heat to space and evaporating underground aqueduct outflow cools epigene surface.

Wherein, more frequent and shorter precipitation periods boost time domain steadiness of the light fluids cycling rates in the troposphere; Earth's thermal energy to space radiation and mantle thermal energy dissipation reduce cycling energy dynamics thermal energy load the troposphere, the tropopause with the magnetosphere must balance, or global air warming evolving the Earth's gravity field occurs. Wherein, the Tesla's electromagnetic technologies provide incontrovertible and crucial applied science technologies to oppose Earth's gravity evolution, global air warming.

The entire prior technologies, art and the entire prior sciences do not conceive Earth's gravity field energy cosmological evolution and global gravitational dynamics global air warming reality possible. These Applications detail, including outright blunders of the theoretic sciences, and the elites do in the last three centuries. Aforesaid explain. The Earth's life existence depends on the Tesla's electromagnetic technologies; whereby, electrons cycle electrical energy Heat Rate 100% efficiency, transferring mechanical energy to electrical energy, or electrical energy to mechanical energy, or guide thermal dissipating energy throughout the Earth's crust, mantle and troposphere, guiding the bulk power cycles and slightly modifying the mega bulk power energy directionality.

Cycling electrons energy Heat Rate 100% efficiency engenders, guides and slightly modifies directionalities the light fluids, the Earth's gravity field, and cosmological global gravitational do cycling energies. The light fluids cycling rates of periods and directionalities dissipating thermal energy cycles the mega bulk energy Heat Rate efficiencies within energy boundaries perfections. As the prior explains, increasing the cycling rates with short paths of passages, engender the light fluids precipitations. The absolute technologies and the Tesla's electromagnetic technologies by cycling Heat Rate 100% efficiency claim the planet Earth lifesaving electron GODPARTICLES! GODPARTICLES Heat Rate 100% efficiency henceforth defines the Heat Rate 100% efficiency. Eight decades later, Tesla technologies advancing sciences of Thermodynamics, at last, do shine!

These Applications prove incontrovertibly mass and energy are not manifestations of one and the same. Mass is solid structure substance a physical presence space and time domain defined a static appearance. Energy is a substance form that flows like a perfect fluid that spawns invisible boundaries perfections highly dynamic boundaries. As such mass and energy differ enormously.

An energy device static mass appearance has its intelligence dumb portion that specifications describe and drawings illustrate. Solid structures mass distinguishing appearance can disclose no more than the dumb portion of its intelligence cycling energy dynamics which reveal intelligence of that structure in entirety. Set forth the dumb part by the entire prior sciences, technologies and art, are human intelligence defect, except for Tesla's work, that threatens life on Earth extinction.

All of such officially recognized in the prior sciences, technologies and art is impregnated by deep profound flows relying on belief that what you get is what you see. Nothing is further from the absolute truth than such science, technology, and especially art. Real intellectual values of an energy device reside in cycling energy dynamics a structure affects inside its solid structure; and, especially outside its structure, an energy device accepts the successive boundaries perfections of energy, since energy flows as fluid that to a degree does penetrate most of solids mass structures.

Intelligence of the super plant and that intelligence influence extend over a range of electrical and thermal energy gradients cycling energy dynamics successive energy boundaries perfections, effectuating cycling energy preferred directionalities in environment. Said intelligence, gradients and maximum volume in the successive boundaries perfections take on preferred directionalities, which embody, comprise the absolute technologies Heat Rate maximum efficiencies of the ultra-transport system. With Heat Rate 100% efficiency, the absolute technologies impose the Tesla's electromagnetic technologies electrical energy distributions, dissipated thermal energy influences largest volume, largest boundaries perfections, in this instance 100% efficient energy utilizations.

Wherein, electrical energy generation thermal energy emission moderately deep underground aqueducts steadily distributed through Earth's crust and mantle effectuates 100% efficient, useful energy cycling. Global civilization surviving energy evolution in Earth's gravity field that cycles 100% efficient energy dynamics needs energy devices that affect cycling energy 100% efficiency that concomitantly effectuates cycling energy dynamics in environment preferred directionalities.

Such are precisely energy cycling dynamics a maximum volume in environment the absolute technologies, the Tesla's electromagnetic technologies, optimal Heat Rate 100% efficiency does, wherein all of generated, emitted energy serving the human race is useful energy; thermal energy dissipating into Earth's crust, mantle and into air engenders energy cycling directionalities which oppose cycling energy in environment directionalities affecting evolution of Earth's gravity field.

For the last two decades, all of these applications do preferred directionalities in environment cycling energy dynamics claiming energy devices Heat Rate maximum efficiency. The drawings meet the USPTO licensing criteria, but not the specifications and none of the claims, specifically, where the Laws of Thermodynamics, applied science no energy devices criteria exists, other than the one these applications claim. For centuries, the USPTO, Procedures licensing energy devices substitute appearance for intelligence as if one and the same, in a malfeasance insubordination of USPTO Regulations, which processing of these applications by technologies practitioner reveals.

Intelligence of the super plant engages the largest volume, largest boundaries perfections that affects the Earth's gravity field a small portion of the troposphere and the magnetosphere a much lesser portion. Nevertheless that volume represents gigantic volume compared to volumes which structures of the super plant occupy. It raises interesting questions—what volume technologies in space and time domain a structure occupies and influences in the USPTO licensed energy device.

The other two application chains alongside the applications of this chain affect and exemplify the absolute technologies with the Tesla's electromagnetic technologies cycling electrical energy electrons cycling Heat Rates night 100% efficiency. Said two applications chains energy devices show the absolute technologies subdivide the PPLLS into energy quantum of fluids quanta which cycles conforming to Heat Rate efficiency criteria for energy device the prior application claims.

The super plant the bulk power, energy cycling the Regions 1-3 said Tesla's electromagnetic technologies transfers into electrical energy by the absolute technologies and the electromagnetic transducer devices guiding the light fluids cycling directionalities. The other portion of said bulk energy main portions, primary coolant loops piping Regions 1, radial inline hot legs from the SG to turbines and condenser units transfer through said cooling water cycling gravitational sink, the hydrosphere, mega bulk power of the Air Cells, the Jet streams cycling energy in the atmosphere.

No energy waste or energy byproduct results from the ultra-transport system electrical power generations, since the absolute technologies, Tesla electromagnetic technologies affects the ultra-transport system Heat Rate very nigh the Heat Rate 100% efficiency. Small remaining portion of the Heat Rate 100% efficiency cycling thermal energy the containment, annex structures, heating air conditioning systems transfer to the cooling water cycling, which overall cools the Regions 4.

Visionary aspect seeing analogies of energy, plasma dissipating flows links electrons, plasma energy gradients flow and their dissipation. Plasmas, electrons energy in space cycled Heat Rate 100% efficiency confirms the Tesla electromagnetic technologies potential cycling the Heat Rate 100% efficiency in Earth's gravity field, provided environment dissipated temperatures stay cool and avoids thermal energy warming the troposphere. All such are precisely what the Super Plant and the ultra-transport system, cycling energy dynamics do. All affirm the Tesla electromagnetic technologies motor generator construction the previous Application claims. And, all validate the absolute technologies, the Super Plant technologies that oppose evolution in Earth's gravity field.

The underground aqueducts, maximum conducive thermal energy conductance dissipates and transfers all thermal energy into mantle and crust of the Earth's gravitational sink, where thermal energy conductance diametrically reverses thermal energy directionality of Earth's evolution and gravitational sink, lasting billions of years. Reversed thermal energy directionalities which boost evolution of the Earth's gravity field and global air warming phenomenon engender technologies and sciences unique construction to oppose Earth's gravity field evolution by global air warming.

Tesla electromagnetic technologies science, the absolute technologies affect incontrovertible, ideal technologies science implemented energy device unique constructions, to optimally reverse Earth's gravity field evolution by thermal energy flow directionality; therein, global air warming energy unbalancing Earth's magnetosphere thermal energy flow reversed directionality balances.

The absolute technologies electrical energy unique devices Tesla science construction affects means for rebalancing Earth's magnetosphere rebalances. The super plant and the ultra-transport system generating electrical power and thermal energy to replace all other energy devices useful, generated beneficial energy may affect life on Earth survival. Whereby, all the super plants with ultra-transport system generated all of energy and power life on Earth needs; wherein, byproduct thermal energy from electrical energy power generations opposes Earth's gravity field evolution.

The applied sciences and the absolute technologies in these applications document absolutely incontrovertible prima facie evidence that Earth's gravity field evolution and global air warming are one and the same phenomenon. Whereby, the super plant, the ultra-transport system cycling the Heat Rate 100% efficiency energy cycles matches cosmological gravitational dynamics Heat Rate 100% efficiency; the absolute technologies' science the Tesla electromagnetic technologies and said electrical energy devices unique construction should generate, cycle, or transfer any and all forms of energy, but primarily electrical energy power cycling the Heat Rate 100% efficiency.

Earth's energy budget cycles the atmosphere, the magnetosphere energy Heat Rate efficiency in low to mid 90% range. That Heat Rate efficiency range is an enormous issue, since the rest of the Universe energy cycles the Heat Rate 100% efficiency. Affecting the magnetosphere balance engendering very nigh the Heat Rate 100% efficiency in bounded energy systems or structures is temperature and cycling medium velocity relationship set forth by the Laws of Thermodynamics.

The Second Law sets forth technologies which divulge energy flow paths, account for energy and identify, therein, examine intelligence a bound energy system or a structure may possess; the absolute technologies within applied sciences broadest scopes do it by quantum energy precision. The absolute technologies, in these applications, divulge boundaries perfections of energy device structures claim the Fluid Elements and the Advanced Fluid Elements respective celestial bodies.

These applications said absolute technologies in space time domain account for energy flows, identify and, therein, examine, trace origins a bounded energy system or a structure may possess. Energy tracing origins of Earth's atmosphere and magnetosphere from the dust cloud of the solar nebula to present existence status in the Universe energy structure disclose no curved space time.

The applied sciences, the Laws of Thermodynamics, especially the Second Law, concomitant and the absolute technologies in-unison affirm—no mass attraction exists among celestial bodies. What exist and disproves the Theories of Relativity and curved space time theorizing are cycling energy cosmological gravitational dynamics lapping in general three or more gravitational fields. Said cosmological gravitational dynamics lapping, also, disproves Newton's gravitational theory, to, in turn, disprove the prior science claims that global air warming AGW CO₂ emissions spawn.

According to the applied sciences, the Laws of Thermodynamics, especially the Second Law, this application text explains and corrects profound, deep flaws in the prior sciences and the prior technologies. Wherein, mutually conforming agreements affirms the unique Earth's gravity field among gravitational fields and cycling cosmological gravitational dynamics, the Universe energy Structure affirms the absolute technologies. Thus, vice versa—the absolute technologies affirm—gravitational fields cycling energy dynamics and the Universe energy structure real, valid model.

Whereby, the fundamental Fluid Elements comprise boundaries perfections finite elements of the Universe energy structure. Therein, boundaries perfections of the energy relativity structures and the Advanced Fluid Elements spawn successive enormously larger boundaries perfections of gravitational fields, solar systems, galaxies, the Universe energy structure, where the Super Plant bounds the Fluid Elements clustering, where the Universe energy structure evolves substructures.

Wherein, Milankovich cycles disclose lapping plasmas of the light fluids among gravitational fields in the Solar System, where global air warming and innate cooling of the Earth's mantle are cycling energy dynamics and cosmological gravitation gravitational dynamics forcing evolutions of Earth's gravity field. Said evolutions refers to evolution possible divers paths, where the prior sciences and art appear to prefer one of the worst possible paths—toward life on Earth extinction.

Boundaries perfections of the substructures evolving the Universe energy structures discloses deeply and profoundly flawed prior sciences and art, where Tesla's criticism of the prior sciences could not have been more correct, where global elite professional disciplines could not have been less wrong. The Second Law rules the Universe, where Heat Rate 100% efficiency, conservation of mass and energy, the Second Law is energy dynamics manifestation of one and the same Law. Whereby, Heat Rate efficiency, energy device intelligence is the same intelligence manifestation.

The prior art, especially licensing the prior art, could not have been more wrong not licensing the technologies, the art, of the Fluid Elements, the Super Plant, repeatedly claimed in the last ten years. Therein, technologies and art of the Universe energy structure is being denied intelligence.

Milankovich cycles show methodically precise substructures of the Universe energy structure engendering boundaries perfections, the energy relativity structures, the Earth's epigene surfaces, and epigene surfaces in celestial bodies, the Advanced Fluid Elements. The methodically precise boundaries perfections in epigene surfaces of the celestial bodies and the Earth affirm universally the Laws of Thermodynamics and affirm the absolute technologies and the absolute technologies science(s) and, herewith, said technologies science(s) the model of the Universe energy structure.

In space time domain, Universe energy structure science absolute enormous superintelligence declassifies the prior science, the prior art and especially the licensing the prior art. Especially in utilizing the Thermodynamics Second Law of Law, the Universe energy structure shows off such super intelligence. The Heat Rate 100% efficiency mass energy universal conservations the prior sciences misconstrue into curved space time and gravity mass attraction phenomena. Despite the cited Sir Eddington quote, the prior sciences and art honor the Principal Theories flawed science.

The Universe energy structure innately engenders potential for generating GODPARTICLES creating a theoretical Heat Rate above Heat Rate 100% efficiency, where such Heat Rate cycling energy rate reverses a gravy field evolution, which threatens existing life, and is the Earth's case. In Earth's gravity field, the successive boundaries perfections main boundaries engender epigene surfaces and in the magnetic field, the magnetosphere boundaries the energy relativity structures. Wherein, the energy cycling rate of the Air Cells may potentially reverse evolution of the Earth's gravity field. All such affect cosmological gravitational superintelligence of the Universe energy structure, wherein cycled energy dynamics stunning energy actions, energy reactions do balance.

Milankovich cycles show energy dynamics precise graphs of energy actions, energy reactions cycling boundaries perfections a stunning, instant, humongous deforming Earth's magnetic field, the magnetosphere does. Said precise graphs data reveal cycling dynamics the Air Cells with the Jet Streams try over 50 attempts, to balance deforming magnetosphere boundaries cycling energy actions, energy reactions. In the last 2.2 billion years, each failed try affects plasmas outflowing.

One gravity field of Solar System planets light fluids plasma cycling energy dynamics lap; in present time, Earth's gravity field outflows plasma. Outflowing plasma fountains occur, because Earth's gravity field energy reactions and Earth's isolation energy actions exceeds tridimensional compression depression the Universe energy structure engenders in boundaries perfections of the magnetosphere. A periodic quanta of the energy reactions exceeding tridimensional compression depression the Universe energy structure evolve into cycling Earth's gravity field climate change by energy evolution cycles cycling space time from the event of the Earth's gravity field genesis.

Said energy reactions periodic quanta and the evolution energy cycles Earth's climate change the Universe energy structure solar insolation affects. Earth's climate change, with the evolution energy, cycles in the troposphere Milankovich cycles discloses for the last 2.2 million years. The evolution energy, the troposphere energy cycling dynamics erodes and transports the constituents in soil deposit which the deep core borings sampled. The troposphere cycles transport energy the constituents consume to effect the deposits, which Milankovich cycles do record in time domain.

The absolute technologies quantum energy accuracy can discern all constituents, whereas the PPLSLS cycling energy dynamics by an energy transport on a finite scale may bind into a device structure. Troposphere boundaries perfections cycle mass and energy conservation must balance to the Heat Rate 100% efficiency energy cycling or otherwise the evolution energy cycling cycle appears. We know—for certain—such is the case. And,—for certain—plasma fountains outflows occur. And, boundaries perfections total imbalances energy quantifies into the evolution energy.

Whereas, the Universe energy structure and cosmological global gravitation dynamics, amply mandate the energy parameters cycling in the troposphere boundaries perfections, which disclose the evolution energy and the energy parameters energy differences. The differences reveals total deleterious effect AGW cycling energy dynamics do, and sets forth the total deleterious effect on environment—the AGW does. The constituents transport consumed energies Milankovich cycles records as the energy reactions cycling energy dynamics a total energy during Pleistocene Epoch.

The energy reactions, disclosing cycling energy dynamics a total energy, discloses stunningly repetitious the total energy a high, a low totals in the energy reactions respective totals reoccur to reconfirm the total energy of the reactions energy, as the Pleistocene Epoch repeats energy cycle. Said total energy of the reaction energy repeating approximates a Heat Rate efficiency of the Air Cells' cycling energy dynamics vary from 90% to nigh 100%, but not attaining 100% efficiency.

The Heat Rate 100% efficiency in any one cycle never occurs, because a trend to higher or to a lower temperatures reverses beforehand; and, reverses because and only, because a temperature trend reverses. Said temperature trend reverses, because conservation of mass and energy within the troposphere boundaries perfections forces a magnetic cusp plasmas outflowing, which affects a slight pressure drop that reverses a temperature trend from rising to lowering temperature. The Heat Rate 100% efficiency also never occurs, where the troposphere boundaries perfections does accrue in time domain the evolution energy a total that reverses trend toward lower temperatures.

Each water vapor molecule is independent system structure of boundaries perfections cycling Heat Rate 100% efficiency in the atmosphere that cycles Heat Rate 92% to 95% efficiency. This percentage range accounts for Heat Rate efficiency of Earth's atmosphere current energy budget. The prior science assigns 5% to 8% drop from the Heat Rate 100% efficiency to AGW emissions of CO₂ gases. Whereas, Milankovich cycles graph magnetosphere imbalances cycling respective climate changes cycling energy dynamics of glacial, interglacial periods. At all, no evidence that Earth's magnetosphere cycling energy dynamics are being balanced for the last 2.2 million years.

The evolution energy evolves the Earth's gravity field, if the Air Cells, the Jet Streams spawn energy cycles Heat Rate efficiency less than one-hundred percent; therefore, Earth's gravity field most likely continues evolving from the time of its genesis. Global air warming evolves with the evolution energy rise. Air Cells, Jet Streams cycled energy and Heat Rate efficiency drop boosts the evolution energy; air CO₂ concentrations warn, but are not global air warming the root cause.

Whereby, conservation of mass and energy and Heat Rate efficiency are manifestation of one and the same Law of Nature, where three dimensional space time domain boundaries perfections engenders physical relationship equivalence between the two. Each two of these three comprises manifestations of same energy cycling dynamics, where the three and each one of these three are the same energy cycling dynamics in boundaries perfections. In common, said all three comprise longevity of an energy structure, which all of the three spawn. The Heat Rate 100% efficiency in space time and domain, effectuate cycling energy dynamics in boundaries perfections and energy structure with eternal longevity of the three. Globose spherical shape engenders preferred energy structure of the three in common, with gravity field, the Universe energy structure cycling energy dynamics deform structure of said shape, to explain appearance of the Universe energy structure.

What we see of cycling energy dynamics in the Universe energy structure are celestial bodies highly stable, if not eternal, configuration shapes. Few celestial bodies evolving structures shape in the Universe energy structure are other than the globose spherical shape discloses the Universe energy structure engenders the Laws of the Thermodynamics cycling energy dynamics additional Laws, the Laws of Structure Longevities. Whereby, the Laws of Structure Longevities spawning gravitational energy dynamics cycling the Heat Rate 100% efficiency and boundaries perfections in space time domain yields an energy structure eternal longevity, concomitant with the Universe energy structure cyclin energy dynamics, which, in turn, assure conservation of mass and energy.

The Laws of Structure Longevities and cycling cosmological gravitational dynamics affected universal conservation of mass and energy—for certain—spawn a boundaries perfections eventual demise should cycling energy dynamics inside boundaries perfections sustain space time domain Heat Rate less than 100% efficiency. Also, we know—for certain—that the light fluids molecular forms cycling within boundaries perfections, do not, cannot cycle the Heat Rate 100% efficiency.

Thus, we know—for certain—the troposphere and the tropopause engender unstable structures cycling energy dynamics. Whereby, we know—for certain—mechanisms which affect the demise of boundaries perfections cycling the light fluids molecular forms. Thus, we know—for certain—the troposphere, the tropopause is dated structure, because we know—for certain—Earth's energy budget cycles mid to low 90% Heat Rate efficiencies. Also, we know—for certain—technologies, sciences and art in these applications are correct beyond approach. Water vapors mass demise in Venus, Mercury and Mars gravity fields affirms Milankovich cycles cycling the evolution energy in the troposphere for the past 2.2 million years; all which affirms global air warming root cause.

The Laws of Structure Longevities, the Laws of Thermodynamics mutually comply; wherein, the Laws of Thermodynamics conforming to the Laws of Structures Longevities engender, affect boundaries perfections cycling energy dynamics within gravitational fields of celestial bodies the Universe energy structure spawns. Thus, theoretical science truths reside in the applied sciences, and the absolute truths and the absolute technologies, which cosmological gravitational dynamics the Universe energy structure imposes and affects; all which is absolutely, ultimately transparent.

Universe energy structure a potential to generate reversals of GODPARTICLES technologies the Tesla electromagnetic technologies of motors and generators invention affects cycling energy electrons reversing directionalities. The absolute technologies disclose GODPARTICLES which the Super Plant breeds cycling electrons directionalities bounded in boundaries perfections which epigene surface embodies. The Laws of Thermodynamics complying with the Laws of Structure Longevities electron GODPARTICLES cycling the Heat Rate 100% efficiency yields boundaries perfections of energy a system or a structure, in this case the Super Plant epigene surfaces bound.

Whereby, a complete reversal of cycling energy directionalities engenders reversal of cycling energy processes in boundaries perfections an energy structure or a system engenders. In cycling energy, reversed directionalities in motors/generators show feasibility of energy cycling reversal. Whereas, the light fluids troposphere and tropopause history of energy cycling engenders glacial, interglacial periods' climate change, where changing energy cycling dynamics is not diametrical.

Glacial, interglacial periods' climate change shows the Heat Rate 100% efficiency embodies crucial parameters which breed and generate GODPARTICLES, where—for certain—parameters which spawn energy cycling directionalities with boundaries perfections are crucial. Interglacial periods' climate changing shows sufficient numbers of particles cycling energy dynamics at and nigh the Heat Rate 100% efficiency, at least, temporarily may affect significant climate changes. And, conversely, energy dynamics not cycling at and nigh the Heat Rate 100% efficiency affects global air warming and is precisely what profound analyses of cycling Milankovich cycles show.

The prior art motors, generators do not come close to cycling the Heat Rate 100% efficiency. Whereas, troposphere, tropopause energy cycling above Heat Rate 90% efficiency never spawns the Heat Rate 100% efficiency to embrace boundaries perfections of the magnetosphere. Energy actions cycling, in part, comprising insulation energy and energy evolution, continually exceeded Milankovich cycles energy reactions last 2.2 million years document. Energy actions, the energy reactions cycling continual imbalances in the tropopause, tropopause spawns global air warming.

Overheating is electrical motors and generators one of primary causes of failure. The Earth's gravity overheats. Milankovich cycles show it, where Earth's energy budget—for certain—cycles the light fluids unbalanced energy actions, energy reactions; wherein—for certain—the light fluids atomic and ions cycling must overheat. The energy relativity structures and the ionosphere make ups consist of respective atomic/molecular fluids and plasmas. We know—for certain—air atomic and molecular fluids do not do, space and ionosphere plasmas do the Heat Rate 100% efficiency, respectively. The Air Cells, the Jet Streams cycling energy dynamics warm continuously the air, till boundaries perfections of the troposphere, tropopause incur a structural failure, to redistribute accrued energy of the evolution energy, global air warming—the prior science “global warming”.

The evolution energy build up inside boundaries perfections of the energy relativity structures boosts the troposphere, tropopause, until accruing cycling energy actions of the evolution energy exceed energy strengths of boundaries perfections of the troposphere-tropopause, the ionosphere, and the magnetosphere. Wherein, the evolution energy originates in the troposphere, tropopause, by distending boundaries perfections of the tropopause a distended portion of molecular forms in the distended portion reverts back the light fluids to ionic forms of the ionosphere. In boundaries perfections of the ionosphere, the magnetosphere, thus, a distended portion becomes unbalanced.

The prior application explains gravitational force is a composite of centrifugal forces of three or more lapping gravitational fields, in the case of the planets in the Solar System by at least four gravitational fields. Thus, the planets, the Moons originate from one solar nebula, subdivided by the Universe energy structure cycling energy dynamics and cosmological gravitational dynamics.

The lapping of gravitational fields in space time domain separates planets gravitational fields in the Solar System and not in domain of cycling energy dynamics. The Earth's relativity energy relative separations from Moon, Venus and Mars in each instance may be nullity but may also be the case for Moon and Mars and/or Venus. Moon, Mars, Venus, and Mercury lack of light fluids plasmas make the Saturn Rings closest recipients of the Earth's gravity field plasmas outflowing.

Existences of boundaries perfections explain Earth's gravity field being the only planet in the Solar System known to engender epigene surfaces water, where the light fluids currently in water budget of Earth's gravity field balance boundaries perfections of at least five gravity fields of the planets which are close to the Sun. Epigene surfaces of Mercury, Venus, Moon, Mars, and Earth reveals that in that order these planets gravity fields rebalance boundaries perfections, outflowing the light fluids plasmas in such order, which may be the blessing that preserves the Earth's water.

In the late Holocene Epoch, the magnetic cusps' lee sides start plasmas ponding, rather than a plasma fountains squirting, the Jean' fountains reoccurrences on 41 ka intervals in the Pleistocene Epoch. Such outflow plasmas create a potential for the light fluids plasmas a gravitational field's blowout; NASA video of a blowout event is incontrovertible prima facie evidence that a blowout of the light fluids plasmas does occur. Mars geophysical surface appearance fosters evidences of catastrophic fluid events eroded surface appearance features. Such catastrophic fluid events may have been blowout(s) of the light fluids plasmas in the Mars' gravitational field as the root cause.

Said ponding primes Earth's magnetic field configuration of plasmas and molecular fluids by bottled ionosphere and magnetosphere boundaries perfections affecting a potential for syphoning the light fluids plasmas also syphoning the light molecular fluids in a blowout the Earth's gravity field may experience. The light fluids of Ions and molecular fluids within boundaries perfections a bottled configuration of the ionosphere and magnetosphere, in the past a blessing that preserves the light fluids of molecular ions, engenders liability for Earth's gravity field a potential blowout.

The Solar System accrues concomitantly solar insulation in each of the gravity fields in form of the evolution energy. The evolution energy in Mercury, Venus, Mars and Moon gravity fields disposes nigh entirely of the light fluids three respective phases. Evolving Saturn Rings show ice phase, disclosing the Solar System observed planets beyond Saturn have frozen epigene surfaces.

The evolution energy in a sublimation process may alter a gravity field and its frozen epigene surface engendering insolation energy dynamics a blow-away, unless an atmosphere is present to capture the light fluids. Boundaries perfections of the light fluids cycling energy dynamics must, also, be present to preclude the blow-away of the light fluids. Said cycling energy dynamics also must cycle overall the Heat Rate 100% efficiency; where lesser Heat Rate efficiency itself affects the evolution energy; wherein the cycling energy dynamics of the light fluids, themselves, accrue the evolution energy in a time domain interval to break boundaries perfections of the light fluids.

The brief prior paragraph summarizes 2.2 million years of cycling the evolution energy in the Earth's gravity field, which Milankovich cycles graphically document. Enormous difference the text of these applications states from the prior technologies sciences, technologies and art resides in the Second Law tracing energy cycling dynamics the Universe energy does. The prior science takes AGW, CO₂ concentration in air is “global warming” root cause, relating such concentration and air temperature, where the evolution energy is the root cause in the text of these applications.

The prior sciences do not go back, prior to AGW period to affirm cycling Milankovich cycles root cause. Best explanation the prior sciences provide for cycling period glacial and interglacial climate changes, global air temperature variations cycling changes, and cycling energy dynamics temperature dynamics transporting concomitantly, even handedly constituents found in deep core borings soil deposits, assigns changing Earth's orbiting dynamics as the root cause. Milankovich cycles change cycles varying period durations of glacial and inter glacial climate changes, during late Pleistocene and Holocene Epochs and temperature dynamics transported concomitantly even handed distributions of constituents found in the deep core borings rules out such an explanation.

Newton's mass attraction “invention” misconstrues tridimensional compression forces which the Universe energy structure affects cycling energy of cosmological gravitational dynamics through space time domains; the “invention”, a misconception persist for three centuries. Electric motors and generators invention temporarily redirects global interests to the applied sciences. Then, the prior theoretical sciences, in turn, come up with two “inventions”—curved space time and E=mc² “inventions”, are these applications shown to be deeply flawed lapping misapplication of gravity fields, which cycling energy structures in lapping energy systems bind by boundaries perfections.

In turn, these applications affect the absolute technologies of the applied sciences, embedding the absolute truths, where the theoretical sciences seek, yet miss environment energies cycling by GODPARTICLES. The light fluids a constituent atom or a molecule in a fundamental form may be GODPARTICLE, should its boundaries perfections fundamental form do the Heat Rate 100% efficiency in boundaries perfections of the troposphere. The light fluids a constituent boundaries perfections is GODPARTICLE depending on its energies cycling the Heat Rate 100% efficiency.

Water vapors exist in Earth's boundaries engendering boundaries perfections, only, and cycle heat of evaporation, heat of condensation equivalence in boundaries perfections reversing energy directionality cycles naturally reversing temperature ranges, spawning the troposphere candidates GODPARTICLES potential. Electron GODPARTICLES may do boundaries perfections cycling energy reversing directionalities, but cycling electrons reversing directionality has manly thermal energy potential motor and generator equivalences same directionalities. Energy devices cycling electrons energy must cycle the Heat Rate 100% efficiency, or otherwise be coupled to an energy device that reverses the evolution energy, the gravity field thermal energy directionalities spawn.

In boundaries perfections of the Super Plant, numerous mechanical devices, electrical motors and generators release thermal energy the slight negative pressures in Regions 2 portion, Regions 3, the HVAC system transfers to the underground aqueducts cooling fluid cycling thermal energy directionalities reversal, in respect to Earth's gravity field thermal energy natural directionalities. Wherein, thermal energy directionalities reversal is radially inward into Earth's mantle; whereas, natural thermal energy directionalities are radially outward into troposphere. Thus, in boundaries perfections in the Super Plant all thermal energy cycles at or nigh the Heat Rate 100% efficiency.

Electrons energy cycling Earth's epigene surface restricts; wherein, energy conduction cycles thermal energy transfer the Super Plant restricts to its boundaries perfections and, also, inside the epigene surface boundaries perfections subsequent effects. Regions along aqueduct underground lengths preferably situated 50 feet below grade and at least ten degrees lower temperature than at ground surface. The aqueduct underground lengths may engender a plume of cylindrical thermal energy with at least 10 dcgrees gradient temperature shortest distance of said 50 feet with a much greater distance of thermal energy gradients into subgrade than the 50 feet said distance to grade.

Additionally, a surface of said plume resists thermal energy conductance transferring thermal energy into air and acts as energy conductance insulator, where the Earth's surface is a barrier to thermal energy conductance. Earth's surface any such surface higher temperatures, due partly to solar insolation, boosts Earth's surface radiations and re-radiations, cooling Earth's gravity field.

The aqueduct underground lengths affect thermal energy conduction reversed directionalities cycling the light fluids of the troposphere in boundaries perfections, sui generis boundaries of the First Fluid Element a thermal energy transfer into Earth's crust. Said thermal energy conduction reversed directionalities transfer after the light fluids inflowing, in subsequent outflowing, and in convection thermal energy exchange with the light fluids the Air Cells cycle; said thermal energy conduction and convection First Fluid Element sui generis boundaries perfections affect reverses thermal energy directionalities which Earth's gravity field cycles. The aqueduct lengths reversed directionalities reverses effects of Earth's gravity cycling the evolution energy by Earth's gravity field cycling Heat Rate inefficiencies which spawn global air warming and Earth's crust cooling.

According to the Second Law, conservation of mass and energy by boundaries perfections of gravitational fields, energies' portions embody cycling Heat Rates less than 100% efficiencies by such energies' portions cycled thermal energy as the evolution energy. Milankovich cycles show the evolution energy thermal energy alters energy cycling boundaries perfections to balance such boundaries perfections alter such boundaries perfections to affect the Heat Rate 100% efficiency. To affect the Heat Rate 100% efficiency energy cycling Earth's gravity field in Pleistocene, early Holocene Epochs, light fluids cycling unbalances outflow energy portions on 41 ka intervals, as if these are evolution energy portions—and, only to fail each time, in an interglacial changing into a glacial climate altering Earth's surface to more stable boundaries perfections. Each cycle spawns the evolution energy same insolation energy in boundaries perfections and energy balancing each cycling cycle subsequent energies cycling spawns further unbalances by the Earth's gravity field.

Crucial parameters balance in boundaries perfections the light fluids of a gravity field cycling energy dynamics consists of parameters which spawn such boundaries perfections and Heat Rate cycling energy dynamics of the light fluids, which engender boundaries perfections. Said further unbalances by the Earth's gravity field dooms all energy devices which do not cycle energy Heat Rate efficiency above 90° A. Whereby, troposphere energy cycling the light fluids in low nineties percent range Heat Rate efficiencies has boundaries perfections of the troposphere at doom point

To save the troposphere and Air Cells cycled energy, all of energy devices of the prior art are useless by spawning Heat Rates unacceptable efficiencies. The prior sciences, the prior art offers no hope. From its advent, the prior sciences affects aversion antipathies towards the Second Law and, thus, misconstrues the gravity mass attraction phenomena, the model of the Universe energy structure and the root causes of Milankovich cycles and global air warming phenomena; the prior sciences is hopelessly useless science, unaware the evolution energy affects Earth's gravity field.

The prior art also ignores the Second Law and ignores the applied sciences crucial Heat Rate efficiencies rating of energy devices and ignores the absolute technologies. The prior art ignores the prior sciences deep and profound flaws and omissions, which the prior paragraph and the text of these applications document. Thus, shackled by said deep and profound flaws omissions stops advance of the prior sciences and the art. Said deep and profound flaws and omissions obfuscate existence of the absolute technologies entire field of crucial sciences and technologies, which the texts of these application disclose and claim, including disclosed and claimed GODPARTICLES.

Wherein, the prior art ignores cycled energy dynamics to examine mainly an energy structure appearance substituted for intelligence, and vice versa, which, at best may be taken as examining Procedures irrational insubordination of 37 CFR Rules and Regulations and the applied sciences. Said deep flaws and omissions start three centuries ago to be reinforced eight decades ago, where lifetime of original philosophies which license an energy device structure stays very much intact. All of which perpetuate and impose same said deep flaws and omissions same blunders the prior sciences do. An energy device intelligence its structure cycling energy dynamics detail, wherein the absolute technologies crucial sciences and technologies entire fields these applications claim.

Energy devices cycling Heat Rate efficiency above 90% warrant special consideration; where energy devices cycling a Heat Rate efficiency below 90% spawn rather than curtail the evolution energy that generates phenomenon of global air warming in the Earth's gravity field. The energy devices cycling Hcat Rate efficiency above 90% may possess a potential to boost that Heat Rate.

The prior application claims the Super Plant electrical motors and generators and mechanical equipment in common cycling the light fluids' types emit thermal energy confined to boundaries perfections of the Super Plant. The HVAC system transfers excess of the emitted thermal energy to the underground aqueducts, where reversing directionalities conduction stagnates, slows down and reduces thermal energy transferring from inside Earth's epigene surface into the troposphere.

Earth's gravity field much more significant in space time domain is effect of the underground aqueducts thermal energy conduction reversing directionalities delay thermal energy loading and slowing energy cycling dynamics the Air Cells spawn. Such delay in transferring thermal energy loading delays distributing from inside boundaries perfections of epigene surface into boundaries perfections a portion of the evolution energy in the troposphere that eventually outflows to space.

This application heads applications chain that epitomizes the absolute technologies utilization as a tool that affects the Super Plant highest Heat Rate efficiencies electrical power generation, to disclose, claim the Earth's gravity field GODPARTICLES cycling. Wherein, GODPARTICLES sole, unique genres may effectuate unique chance to balance and preserve boundaries perfections of the troposphere, thus, to preclude the light fluids energy escapes from the Earth's gravity field.

These applications co-pending three chains embody and correlate an energy device Heat Rate maximum efficiency and boundaries perfections stable energy dynamics GODPARTICLES may need, especially when coupled to High Rate efficiency energy cycling the super plant does. Said third chain meets energy criteria, which rates energy devices intelligence, rather than appearance. Said energy device very high Heat Rate efficiency precludes participation by any of the prior art.

The three chains of applications comprise the one chain of applications, where an application a continuation in part follows the prior application, from any such two applications co-pendency. The applications three chains disclose cosmological global gravitational dynamics, cosmological gravitational dynamics and Earth's gravity field lapping in space time domains comprising a new sciences field and cycles energy dynamics true model of the Universe energy structure. The new sciences field, and vice versa, discloses new technologies, sciences and art, in turn, to advance all prior technologies, sciences and art. The new science field, and vice versa, utilize absolute truths in technologies science and art comprising a tool that discloses and yields boundaries perfections in environment cycling energy dynamics, Heat Rates high efficiencies, and the Second Law rated intelligence the Universe energy structure, an energy device, or an energy device structure yields.

The absolute technologies is the tool that embodies respective energy forms of the light fluids into cycling energy dynamics within boundaries perfections, affecting positively the Second Law and conservation of mass and energy the First Law, wherein highest Heat Rate efficiency cycling energy dynamics ultimately preserve mass, energy, and boundaries perfections cycling longevity. The absolute technologies is the tool of the applied sciences which unravels the new science field and is the tool entirely missing in technologies of the prior art and the prior sciences. Each chain of said three application chains advances the prior sciences and art by specific structure example.

The Universe energy structure evolves gravity fields and celestial bodies with magnetosphere structures, where energy cycling dynamics affect the energy forms and energy phases of the light fluids to delineate light fluids boundaries of boundaries perfections. Such light fluids delineating boundaries perfections discloses true model of the Universe energy structure, in strong difference to the prior sciences. Each of the three chains of applications depicts, details, and claims specific energy forms energy phases by any energy device structure cycling Heat Rate highest efficiency.

There is no doubt that the Universe energy structure cycling the specific energy forms energy phases of the light fluids in space and time domains evolves precisely energy device structures in the Universe cycling the Heat Rate 100% efficiency. Stated accurately, the applied technologies, the absolute truths in technologies science, embrace precisely technologies, science and art of the Universe energy structure and specifics of the energy forms, the energy phases of the light fluids.

Said true model of the Universe energy structure engenders cosmological global gravitational dynamics set forth the energy forms, the energy phases cycling specifics, the light fluids set forth the sui generis boundaries perfections, and boundaries perfections, and the absolute technologies. Conservation of mass and energy sets forth the Heat Rate maximum efficiency, sets fort the Heat Rate 100% efficiency which the light fluids lapping boundaries perfections of gravity fields must affect. Or, energy structures of lapping gravitational fields redistribute cycling of the light fluids.

The troposphere, the energy relativity structures, the magnetosphere embody energy devices cosmological wind pressures and radiations deforming, where, otherwise, cycling the light fluids would, and/or effectuate concentric structures of respective energy fields in a concentric lapping. The tropopause yields the light fluids and air imₚurities concentration an energy device structure, where deep core soil samples set forth Milankovich cycles data set forth energy parameters, also.

One source of global mass energy uniformity exists that can dissipate, disperse, and transport soil and water vapors into eventual soil deposits and the Earth's gravitational field predominantly deposits soil and ice deep deposits. Thus, Air Cells mass cycling energy which magnifies, as the later enumerates, and insolation energy quantum dynamics, which affect global air temperatures. Wherein, the energy parameters are precisely those of troposphere and temperature variations are precisely those that spawn global climate interglacial, glacial periods in the last 2.2 million years.

In the early Pleistocene, Milankovich cycles recycle the temperature variations with stunning similarities; soil samples in the deep core borings confirm it, while in the late Pleistocene and the Holocene the stunning similarities among cycling periods start to vary. In over fifty cycles, 41 ka duration periods relate highest and lowest CO₂ concentrations and highest lowest temperatures in each cycle the troposphere cycles. Crucial issue arises—which of the two spawns energy actions.

Each of the over fifty cycles evolves aforesaid energy parameters, with a climate changing an interglacial to a glacial period, and vice versa over fifty cycles of climate changes. Cosmological gravitational dynamics and the Universe energy structure cycle specifics of the energy forms, the energy phases, the light fluids embody the energy parameters in boundaries perfections, whereby the troposphere, the magnetosphere successive boundaries perfections do successful rebalancing.

For certain—we know, cosmological gravitation dynamics with global gravitational dynamics affect cycling energy dynamics cosmological global gravitational dynamics Heat Rate efficiency cycling the light fluids cycling the energy relativity structures of the troposphere, tropopause, the ionosphere, in turn, the magnetosphere respective boundaries perfections, which alter said energy parameters. In the last 2.2 billion years, over fifty climate cycles spawn, from an interglacial to a glacial back to next interglacial period—where all boundaries perfections rebalance continuously.

Certain cosmological gravitational dynamics for cycle the Heat Rate 100% efficiency in nigh infinitely steady time space domains, whereas Milankovich cycles reveal changing climates. The ionosphere cycling plasmas cycle the Heat Rate 100% efficiency, also, very much like the energy the Universe energy structure cycles. Thus, only, energies in the Earth's magnetic field magnetic lines keep the ionosphere cycling, in common, with Earth's gravity field and as one gravity field.

Whereas, molecular fluids cycle pronounced seasonal and climate changing temperatures, the plasma fluids ignores. Thus, the energy parameters cycling the evolution energy climate changes cycle in the troposphere and the tropopause cycles and do not cycle in the ionosphere; the Earth's gravity field cycles the energy reactions to balance energy actions with Air Cells, the Jet Streams cycling energy dynamics, where energy cycling Jet Streams also balance tropopause, ionosphere boundaries force the energy phases of molecular fluids to plasmas energy cycling and vice versa. Whereas, the Air Cells affect cycling energy dynamics restricted to weather and climate changes.

The prior paragraphs culminate incontrovertible scientific evidence; affirmed by the absolute technologies, the applied sciences, especially the Laws of Thermodynamics and the Second Law, herewith, validate incontrovertibly quantum energy advanced sciences and vice versa. Aforesaid energy origins tracing of Earth's atmosphere and magnetosphere from the dust cloud of the solar nebula to existing present status in the Universe energy structure disclose nonexistence of curved space time in the light fluids cycled energy dynamics in solar nebula genesis or in the dust cloud. The absolute technologies shows Second Fluid Element volume in the Universe energy structure balances energy fields to quantum energy accuracy and where curved space time cannot coexist.

The Universe energy structure distributes concomitantly the energy parameters, the evolution energy, where lapping gravity fields with cycling cosmological gravitational dynamics spawn the successive boundaries perfections. The prior paragraphs identify, detail and separate said energy parameters disclosed, distinguished energy actions cycled energy in boundaries perfections of the troposphere, which cosmological gravitational dynamics and the Universe energy structure affect in total. The energy parameters, henceforth, refer to the energy parameters or the energy actions, as one and the same, which cycled energy dynamics of the evolution energy evolve in boundaries perfections of the troposphere. Since the solar insulation stays essentially unchanged, the energy parameters, said energy actions, remain essentially unchanged, where said energy reactions must balance energy in boundaries perfections of the troposphere to impose mass energy conservation.

Said energy parameters cycling the Heat Rate 100% efficiency cycle the tropopause, whereas the energy parameters, the evolution energy, in common, spawning climate changes cycling Heat Rate less than 100% efficiency cycle the troposphere, affecting respective boundaries perfections supra explain. Said energy parameters, the evolution energy, in common, cycles a Heat Rate less than 100% efficiency that affects the troposphere cycling energy dynamics increased imbalances.

Said increased imbalances, in time domain, eventually disconnect the troposphere boundaries perfections, subsequently the tropopause, the ionosphere, the magnetosphere cycling perfections, and/or affect magnetic field lines, the magnetic cusps, the plasma fountains plasma fluid outflow. The absolute technologies disclosed the absolute truth sciences disclose new field sciences of the energy forms and the energy phases in diverse energy structures explain Milankovich cycles, and vice versa. The absolute technologies, likewise, sciences disclose global air warming root causes arise incontrovertibly with the same root causes which spawn the interglacial and glacial periods.

Energy dynamics cycling varies Heat Rate efficiency, continually evolves energy boundaries, in space time, where the energy parameters with boundaries perfections of the troposphere spawn constituents of the soil samples found in the deep core borings. Energy in environment spawning deposit constituents present in the soil samples of the deep core borings corresponds to global air temperature, at time of the deposits, and cycling energy dynamics which deposit the constituents.

The energy parameters cycling the evolution energy changing climate cycle differently in the troposphere and the tropopause respective boundaries perfections as previous states. The energy parameters which spawns the evolution energy cycles climate changing cycle in the troposphere. The tropopause, the Jet Streams cycles energy that integrates the troposphere and the ionosphere, where the Air Cells cycling energy dynamics engender energy reactions, which oppose global air warming. Cosmological global gravitational dynamics cycling successive boundaries perfections are the Universe energy structure stunning energy actions, energy reactions balancing to the Heat Rate 100% efficiency, and super intelligent technologies show for all to see gravity fields joggle.

In cosmological global gravitational dynamics, from phase being vapor to a point being a surface water/vapor, molecules transfer heat energy by heat of evaporation and condensation, where said two affect same magnitude. Heat of evaporation cools epigene surface, and heat of condensation radiates into space; phase changing short time periods high cycling rates reduce the Air Cells, the Jet Streams thermal load, which is the underground aqueducts and the super plant assigned tasks.

Cycling the light fluids through the underground aqueducts reverses also recycles cycling Earth's gravity field. Thermal energy reversed cycling directionalities slows thermal energy transfer into atmosphere, and in time domain Earth's gravity sink present evolution rate, which boosts thermal radiation emissions of Earth's epigene, and especially the light fluids cycling atmosphere energy.

In the early Pleistocene Epoch, Earth is energy device that spins, orbits, precessions and supports life at Heat Rate 98% efficiency that repeatedly resets the light fluids energy cycling dynamics to attain the magical 100% efficiency. Currently, that Heat Rate efficiency is down to 92% to 96%.

In the last decade, CO₂ concentration spikes in air, from previous highs of 300 ppm to new highs of over 400 ppm. Clearly, the prior sciences, technologies and art are not working to achieve the desired stable climate. In turn, global air warming changed climate points incontrovertibly to the prior art, technologies and sciences deep and profound flows; these applications does it, in detail.

Gravity field air CO₂ concentration spikes is the evolution energy evolving presence telltale sign, which warns gravity field is evolving. Scientific community scapegoats CO₂ presence in air, and obfuscates unforgiving misdeeds in the past. Milankovich cycles leaves no doubt about it—at all.

The energy devices these applications disclose are to globally participate preferably sooner rather than later in the Universe energy structure space time continual said joggle. Earth's gravity field energy conservation by boundaries perfections cycling the light fluids Heat Rate 100% efficiency the Universe energy structure cycles, the troposphere, tropopause must do, also, or cease to exist.

The absolute technologies, cosmological global gravitational dynamics, and said super intelligent technologies cycling the light fluids Heat Rate maximum efficiency in boundaries perfections are one and the same cycling energy technologies which comply with the Laws of Thermodynamics; said technologies one or all precludes the priors science, technologies, and art a participating role in said super intelligent technologies, troposphere, tropopause boundaries perfections said juggle.

We know—for certain—science, academia accepts a structure performance by the applied science rational and said energy utilization efficiency—Heat Rate efficiency. The Rules and Regulations cannot disqualify submitted applications that claim intellectual property by Heat Rate efficiency, to quantify intelligence of an energy structure. And, the submitted applications do precisely that.

The inventions and innovations in this application affirm science, the Laws of Thermodynamics, the applied science, and academia rational to evaluate a structure intelligence based on Heat Rate efficiency, where the Laws of Thermodynamics for small and very large structures may make the structure intelligence precisely calculated. A precise calculating of structure intelligence evolves calculating PPLLS, where fluid given minimum data, calculating the PPLLS engender perfection of fluid structure boundaries and structure sui generis boundaries perfections which cycle energy.

Finite Elements computing algorithms adjust incrementally the boundaries perfections computed PPLLS boundaries perfections, which, thus, reveal, establish boundaries perfections of structure. The PMII technologies, cosmological gravitation dynamics, boundaries perfection yield maximal longevities of everything and conserve mass energy of the light fluids including electrons energy. Parameters of the flowing fluids defining the structure is fully consistent with design of electrical conduits, circuits, circuit boards, where flow is current pressure and voltage two forms of energy.

Science of the cosmological balances comprises: longevities of the flowing fluids and boundaries perfection of the conforming quanta, MEHC embodying genus everything genera everything and infinite clustering of the Advanced and fundamental Fluid Elements, and cosmological nullity of the PPLLS balancing of the boundaries perfection to the Thermodynamics Second and First Law. This application for each claimed energy device structure, drawings illustrated, claims Heat Rate maximum efficiency—highest intelligent device; whereby, each celestial body is a perfect device.

Said inventions and innovations, also, comprise: longevities of the flowing fluids and boundaries perfection of the conforming quanta, MEHC embodying genus everything genera everything and infinite clustering of the Advanced and fundamental and Fluid Elements, cosmological nullity of the PPLLS balancing of the boundaries perfection to the Thermodynamics Second and First Law.

Said inventions and innovations in this application engender Heat Rate efficiency and the PPLLS equivalency, where the PPLLS also reveals perfection boundaries of cycling energy that, as such, affect highest intelligence energy devices. The PPLLS yields boundaries perfections structure by quantum energy precision may makes drawings unnecessary, or requiring a minimal explanation.

Earth has nothing to lose, but eternal longevity to gain by these energy devices global utilization. The super intelligence energy dynamics joggle the light fluids cycling boundaries perfections the troposphere, tropopause cycles threatening the life existence on Earth. The absolute technologies energy devices, art technologies and sciences in these applications explain. None of the prior art sciences, technologies, art, and the existing life is useful, since proven to be acting detrimentally.

“Means” in claim 1 means, “to design, intend, or destine for a certain purpose or end”, in present instance to utilize technologies and sciences for intended purpose or end, where technologies and sciences in pertinent parts respective application details, above paragraph briefly summarized. In further most brief summary, the applications claim technologies and sciences is one and the same technologies, sciences said super intelligence cycling cosmological global gravitational dynamics energy cycled also joggled the light fluids boundaries perfections of the troposphere, tropopause. Each of the two applications comprising the third chain claims energy criteria for energy devices.

Newton at al., based on appearances of gravitational mass attraction force presence gets it wrong. Einstein at al., based on appearances of the Universe energy structure confuse real and imaginary in the mathematical computing result, claim the Theory of Relativity sciences, and gets it wrong. Higgs at al., an apparent mathematical computing error taken for GODPARTICLE gets it wrong. Scientific community at al., model troposphere-tropopause global air warming that gets it wrong.

These applications correct sciences, technologies and drawings cannot license one energy device, for two decades, where the filed applications cannot not meet the USPTO criteria in two decades. It turns out after two decades, the USPTO licenses an energy device based on appearance and not on sciences, technologies or energy criteria for energy devices. And, there, there is twenty years, six more decades, since Tesla told vociferously the world you got it wrong, and nothing happens.

Now, global warming happens; these applications explain it, therein, the living world depends on the nuclear super plant, specifically the underground aqueducts technologies to incubate the light fluids cycling energy dynamics with GODPARTICLES and concomitant Tesla's electromagnetic electron GODPARTICLES to save the day. The evolution energy cycles cycling the atmosphere comprises a cycled thermal energy portion. Whereby, the Air Cells, Jet Streams reactions energy balancing the light fluids cycling thermal energy balances the evolution energy inside boundaries perfections of the troposphere, tropopause balancing the evolution energy cycling Earth's gravity field, balancing boundaries perfections of the magnetosphere; no known other “means” can do it.

The intent of the underground aqueducts are to serve as a depository of cycling thermal energy of the light fluids cycling, washing out from Earth's gravity field troposphere tropopause impurities concentration concomitant removals from the light fluids cycling and epigene surfaces deposited. Cosmological global gravitational dynamics energy cycling the light fluids does it free of charge, wherefrom, most thermal energy dissipates throughout the mantle reversing the mantle evolution or radiates into space out of Earth's gravity field sink; there it is, global air warming the solution.

The underground aqueducts, the absolute technologies of the First Fluid Element said sui generis boundaries construction disposition, length and cross-section must spawn complete complements of troposphere-tropopause, epigene surface, situ environments and the light fluids cycling energy genres. Complete complements matching epigene-mantle said genres thermal energy maximum cycling rates has merged thermal energy maximum conductance Heat Rate maximum efficiency.

Said maximum conductance Heat Rate maximum efficiency connects the underground aqueducts and Air Cells and Jet Streams thermal energy cycling, since the maximum conductance embodies least resistance paths of thermal energy, the PPLSLS, engenders the power grid of a power plant. Cosmological global gravitational energy field cycling dynamics is the power plant; the Air Cells Jet Streams, and the underground aqueducts is the power grid that cycles the light fluids, thermal energy cycles. Opposing global air warming engenders maximum conductance, comprising long term average respective thermal energy conductance in epigene-mantle, troposphere-tropopause, where the power plant and the power grid cools Earth, at Heat Rate from 92% to 96% efficiency.

Temperatures of the light fluids cycling the underground aqueducts at inflow and epigene surface outflow; the super plant inflow, outflow; the Earth's epigene, mantle abilities to dissipate thermal energy; flowing velocity and quanta of the light fluids spawned temperature gradients effectuates thermal energy conductance. All which is conducive to the Laws of Thermodynamics prediction based on in situ conditions including epigene surface multiple outflows spacing achieves thermal energy maximum conductance on inside of gravity sink epigene surfaces, boundaries perfections.

Thermal energy maximum conductance of thermal energy the light fluids cycle already at 92% to 96% Heat Rate efficiency has potential to exceed 100%, based on dispositions of the super plant, underground aqueducts with epigene surface multiple outflows and an outflow basin, comprising respective configuration in ultimate disposition. The ultimate disposition engenders the Laws of Thermodynamics climatologic data, yielding optimal cycling rates no precipitation short periods, and fluid GODPARTICLE yields thermal energy cycle the Heat Rate 100%, or higher efficiency.

Fluid GODPARTICLE embodies higher than the Heat Rate 100% efficiency where such particle does do a time shorter time interval than required to affect said Heat Rate for GODPARTICLES. Of course, GODPARTICLES exist in the atmosphere, but there is not enough of them. Wherein, ultimately configured, dispositioned complete compliments matching the underground aqueducts cycling the light fluids, with Air Cells-Jet Streams cycling, serve to engender GODPARTICLES.

The prior sciences, technologies, art and global energy devices licensing profound deep fallacies solutions to global air warming underscore. The prior solutions to global air warming ignorantly utilize the prior sciences, technologies and licensed, which drastically reduce GODPARTICLES numbers cycling the atmosphere; the last decade boost in air CO2 concentration confirms all of it.

A very rough estimate estimates about one hundred twenty of the super plants, with about twenty five of maintenance and refueling centers for each to service about five of the super plants, in the United States; to control global air warming, about one thousand of the super plants is necessary.

The applied sciences, the Laws of Thermodynamics, especially the Second Law, the absolute technologies affirm unanimously mass and energy is not a manifestation of one and the same and affirm incontrovertibly—the prior science misconstrues the above; the appearance, intelligence of an energy device structure is not one and the same thing. Energy device intelligence does, meets energy criteria based on its energy cycling Heat Rate efficiency, while energy device appearance has its drawings criteria which illustrates, explains. Energy device intelligence in space and time domain may manifest itself by diverse energy forms. At the most, a structure appearance may be a dumb portion of a structure intelligence. All or most of which are misconstrued in the prior art;

The applied sciences, the Laws of Thermodynamics, especially the Second Law, the absolute technologies divulge that the prior science and art misapply space dispositions time chronologies of energy device structures, also. All of the above is misconstrued for sake of pet procedures, pet theories, respectively; then, thus, and there life extinctions occur by leadership of the global elite.

Most of the theoretical physics, legal, political and mass media elite discards the Second Law binding centuries of blunders the previous several paragraphs cite, into life on Earth mother of all extinctions. Elite professions commonly discarding the Second Law reassures each profession's irrational exuberance that it may hold the absolute truth inside profession to empower work of its profession, thereby, relegating the absolute truths which the applied sciences warrants absolutely.

The irrational exuberance of the elite professions shows irresistible temptation for discarding the Second Law, which relegates the absolute truths needed versus the applied sciences requiring the absolute truths. Elite professions relegating the applied sciences by the irrational exuberance engenders precisely wrong solutions to Earth's gravity field evolution forced global air warming.

Finally, after eight decades, the absolute technologies disclose incontrovertible evidences that the applied sciences best reveal the absolute truths to lead advancing science, duly competing for the absolute truths, which will of global exuberant, influential, global science happens to violate.

Said 200 years potentially exist due to full recognition of energy evolution momentum in the Earth's gravity field, which these Applications disclose. All energy devices rapid construction in all of the Earth's continents offer life on Earth said 200 years potential grace period an extension; an energy device structures compete against enormous intelligence the Universe energy structure demands which is Heat Rate maximum efficiency ultimately the Heat Rate 100% energy cycling.

Electromagnetic fluids stiffness, creeping and volume change retains the relativity energy, where Regions 3 comprises displacement energy above the minimum energy balancing and the minimal energy displacements, where the calibrated electrical power inputs balance the two energy forms, a steady electrical power inputs portion affects the electromagnetic fluids stiffness, creeping, and volume change, while fluxing electrical power inputs dampens fluxing energies cycling balances.

In Regions 3, the relativity energy, the minimum energy balancing, the bulk power cycling inside the ultra-conserving and the ultra-longevity of the sui generis boundaries perfections and also the mega bulk power Regions 5 transferring power, electrical energy in the ultra-longevity, the ultra-conserving Earth's gravity field balances energy in boundaries perfections of the magnetosphere.

Said MENC, absolute conserving, ultra-conserving and self-conserving denoted mass energy always refers to the ultra-longevity boundaries or boundaries perfections of atoms and molecules and the fundamental, the Advanced Fluid Elements. The Fluid Elements, entirely missing in the prior sciences, thus, the art reveals fatal flaws in both, which further aggravated by disregards of the First, Second Law, threaten global civilization an absolute, stunning and merciless extinction.

Supreme laws of Nature engender, declaim are the applied sciences, the relativity energy, and the Fluid Elements fundamental sciences, where sciences and technologies oppose global air warming—cosmological gravitational dynamics phenomenon. The absolute technologies impose entelechy from the prior art ultimate loads or allowable stress designs of structure to technologies by boundaries perfections and cosmological global gravitational dynamics, the EESD, the energy relativity structures cycled environment energy, the minimal energy displacements, the minimum energy balancing, which the relativity energy bounds. Wherein, all these show the prior sciences and technologies profound flows, declaim fundamental sciences in Milankovich cycles, and yield structure technologies entelechy, in environment of the EESD, which oppose global air warming.

The self-alignment of the ultra-transport system by energy, wherein wind cone effects embody a self-alignment by the ultra-transport system to absolutely maximum energy conserving and engender cycling energy absolutely Heat Rate maximum efficiencies that cycle in Regions 3.

The super plant absolute technologies reveals boundaries perfections of the Advanced Processors clustering the Fluid Elements and principles, methodologies, inventions, and innovations (PMII), the PMII and the Fluid Elements, Ions and Isotopes (FEIIPMII) applied science PMII, FEIIPMII technologies affecting cosmological gravitational dynamics, the MEHC absolute conserving, and the nullities' sums of the light fluids, engenders the minimal energy displacements, the minimum energy balancing, the ultra-longevity boundaries, boundaries perfections by the relativity energy.

Thus, the Universe energy structure is one structure of infinity upon infinity complex by energies cycling in boundaries perfections comprising deformations and volume changes energy, identical to solid mass structures. Yet, different, because conservation of mass and energy does not let go, nothing may get lost. Eventually, by the light fluids boundaries perfections cycling reconfigures.

The super plant absolute technologies, wherein the ultra-cycling of the light fluids, cosmological global gravitational dynamics by energy of conforming nullities total energy displacements yielding electromagnetic fluids creep stiffness, the energy relativity structures, the relativity energy, the minimum energy balancing, the minimal energy displacements by the ultra-conserving, the ultra-longevity boundaries in the ultra-fluxing, successive boundaries perfections effectuate: the PMII, FEIIPMII technologies and inbred means which oppose global air warming.

The minimal energy displacements, the minimum energy balancing of the relativity energy of the light fluids cycling respective energy in boundaries perfections in Regions 3, the PMII and FEIIPMII technologies quantify. Boundaries perfections of Earth's land masses fluids and solids spawn ocean tides, volcanic eruptions and tectonic movements and soil erosions and depositions. Sustained successive boundaries perfections of the troposphere, tropopause, and the stratosphere, the magnetosphere the light fluids respective cycling concomitant bulge, along with the tides and plasma outflow, are individual common effects. All of which flux the Universe energy dynamics make up, as ultimate fluid flowing from peaks of the relativity energy into gravitational sinks and planets as potential peaks with stars as the peaks. The relativity energy in all shows Earth's light fluids ineffectively cycling insolation and AGW emissions energy into Earth's gravitational sink.

Henceforth, ‘greenhouse effect’ refers to Magnification, Magnification factors insolation energy as heat energy that accrues, magnifies, in the tropopause, troposphere volumes, measured rising temperatures, due to the light fluids inadequate cycling heat transfers into epigene surfaces of gravitational sink. Again, very variable energy, omitting ‘the’, and capitalizing the lead letter.

In the late Pleistocene Epoch, with glaciers retreating, insolation Magnification intensify, and in the last three centuries AGW energy emission multiplies, activating Milankovich cycles at 21 ka dominant frequency, rather than scientific community theorized 125 ka frequencies. In fact, presently, leaking plasma sporadic outflowing thru the North Pole cusp places the Earth in a peril of losing the light fluids and water, which Mars epigene has suffered. Energy outflowing reveals the relativity energy least affectively cycling the light fluids is first to distribute the light fluids of boundaries perfections into boundaries perfections effectuating larger boundaries of gravitational sinks. In time domain, such show Earth's gravitational sink light fluids gained from Mars's loss.

The PMII technologies affect fundamentals of atoms, molecules and the Advanced Processor fluxing, which engender boundaries perfections. Earth's mass energy phenomenon bounding the troposphere, tropopause mass and energy boundaries perfections cluster of the fundamental Fluid Elements in boundaries perfections PMII and FEIIPMII absolute technologies also, referred to as the absolute technologies, affect complete compliments entirely matched energies balance, where the ultra-transport system and the MEHC absolute conserving, with the PMII, FEIIPMII absolute technologies cycle the light fluids of gravity field by cosmological global gravitational dynamics.

Wherein, the super plant joins the wheel of Nature at no charge for cycling the generated energy. The light fluids energy cycling gravity field overall same directionality that the electrical energy cycles strengthens gravity field energies cycling, opposes plasma outflows, and climate changes.

The PMII, the FEIIPMII absolute technologies embrace the light fluids ultimate balances and cosmological global gravitational dynamics with boundaries perfections and the energy relativity structures effectuate the nullities' sums cycling rates, which, yield, affect boundaries perfections. The PMII technologies condone the light fluids highest cycling rates which engender boundaries perfections affecting highest efficiency Heat Rates binding boundaries perfections of the epigene surfaces, which concomitantly effectuate the PMII, the FEIIPMII technologies within boundaries perfections of the troposphere, troposphere which make up 99% of the light fluids by volume. In the EESD is energy cycling the light fluids by which all fluids cycles, including CO₂, AGW mass energy emission, comprising all fluids at large cycling mass energy by cycling phases of the light fluids. The PMII, FEIIPMII technologies genuinely oppose insolation energy global air warming by ultimately maximizing energy transfers of air fluids cycling energy into the gravitational sink.

The PMII, FEIIPMII technologies show the prior art, besides carrying on profound flows in the prior sciences, yields energy misdirection global air warming, very unacceptable Heat Rate efficiencies, high allowable structures stress, stress corrosion cracking, short life span longevities and needed frequent and regular tensioning of bolts, all effect global air warming. All such show energy emitting, accumulating in environment and global air warming are one or the same issues.

In time domain, the EESD cycling energy dynamics fluxing the ultra-longevity boundaries of the Regions 4 and boundaries perfections of the magnetosphere, where mass, energy, and volume change relative displacements, interacts mass volume and energy balancing by fluxing respective boundaries. Cosmological global gravitational dynamics and the MEHC absolute conserving, by cycling the nullities' sums spawn, bind and sustain the ultra-longevity boundaries and boundaries perfections to the gravitational, magnetic fields bound mass energy balanced relative imbalances. The minimum energy balancing balances the relativity energy imbalances by spawning the ultra-longevity boundaries cycling orientations, rotations, flux and displacement, and effect the MEHC absolute conserving. The PMII, the FEIIPMII absolute technologies closed systems clustering in the ultra-longevity boundaries embodies the minimum energy balancing and the relativity energy relative fluxing effected by the electromagnetic fluids stiffness, creep, and volume change energy affecting optimally least stresses, strains Regions 3 structures and the ultra-longevity boundaries.

In the super plant Regions 3, boundaries perfections of concrete construction, the high energy piping loops interfacing effects the electromagnetic fluids creeping and stiffness, which comprise displacements finite energy interactions yielding the energy of displacements and volume change the electrical power input entirely controls. The interactions energy spawns the minimum energy balancing and the minimal energy displacements engendering the relativity energy which spawns boundaries perfections or the ultra-longevity boundaries Regions 3 environment, engendered low strains and stresses energy parameters. The interactions energy constituting the minimum energy balancing reaffirm the ultra-longevity boundaries of the ultra-transport system and the Regions 3.

Instruments, gages including extensometers and cameras, monitor energy in environment and cncrgy effecting overall displacements and volume change, the interactions energy, which spawn the interactions energy balancing Regions 3. Instruments, gages measurement and cameras data, software programs and computer memory banks concomitantly balance Regions 3 energy cycles, which, of course, includes operation of the super plant associated with numerous energy devices.

The PP constitute least resistance paths in transporting plasma that affect the light fluids self-conservations genres that in presence of gravitational sink and magnetic field constitute the ultra-longevity boundaries of the Earth's magnetosphere. The super plant technologies effect, embody energy of distortion and volume change in the electromagnetic fluids displacements creeping and stiffness to configure energy of elastic displacement volume change that is occurring in the ultra-transport system extended into high pressure turbines. The calibrated electrical power inputs into the electromagnetic transducers, the transducers, effect, grant the electromagnetic fluids creeping volume change and stiffness granted displacement of the interactions energy, the minimal energy displacements, which, in turn, spawn the ultra-longevity boundaries of the ultra-transport system, yielding the minimal energy displacements, maximal longevity of the ultra-longevity boundaries. Of course, atomic boundaries omnipresent electrons cycling displacement exemplifies most of it.

The minimal energy displacements, the ultra-longevity boundaries ultimate integrity embrace boundaries perfections ultimate longevi lies comprising the calibrated electrical power inputs into the electromagnetic transducers, the electromagnetic fluids, which dampens energy cycling flows from exigent localities and the interactions energy, potential displacements eventual deformation.

The electromagnetic transducers effect the electromagnetic fluids embodying pressures in control over granted stiffness and creeping, which affect the minimal energy displacements in Regions 3.

The calibrated electrical power inputs into the electromagnetic magnetic fluids a power signal, the electromagnetic fluids, a substance, of the electromagnetic transducers embody the signal and the substance, to comprise electromagnetic transducers, the transducers, which convert the power signal into the substance concomitant shear and elastic moduli displacement stiffness and only as needed plastic creeping deformation, embodying the minimum energy balancing and the minimal energy displacement. Said transducers ultimately dampen structural vibrations within Regions 3. Electromagnetic coil construction, the electromagnetic fluids make-up compositions or magneto-rheological fluids trade names construction are known in the art and also widely used in industry.

The electromagnetic transducers preclude plastic and sap dynamic displacements comprising ultra-transport system proper all plastic, most elastic strains with energy stresses of the minimum energy balancing of the relativity energy and the ultra-longevity boundaries, Regions 3, integrity, where said transducers, the transducers or electromagnetic transducers refers to the same devices.

The minimal energy displacements preclude stresses concentrations which combine axial and transvers hoop stresses, the hoop stresses, wherein, a potential high energy piping pipe break due to high or even moderate axial stresses cannot occur; wherein the creeping of the electromagnetic fluids plastic deformations attenuate even moderate axial stresses including a small portion of the hoop stresses. The transducers also attenuate continually the minimal energy displacements flux, engendering the ultra-transport system continual configuring an ultimate configuration. Wherein the transducers spawn vastly superior means for structures attenuating random energy stresses, in walls of the high energy piping specifically, when compared to the prior art mechanical spring or hydraulic devices known as snubbers. The transducers indisputable advantages dampen the axial and the hoop stresses flowing in structures, by electrical power, which pressurizes and or spawns the electromagnetic fluids plasticity and or to solidify, stiffen or plasticize and or lower viscosity.

The transducers, the electromagnetic fluids deformations dampen the interactions energy and yield ultimate configuration of the minimal energy displacements of the ultra-transport system to the minimum energy balancing comprising the ultra-transport system, Regions 3 integrity which, in turn, spawns the ultra-longevity and the ultra-conserving of Regions 3 boundaries perfections; the ultra-transport system cycling energy ultimate transfers by the electrical power inputs into the transducers affect the minimum energy balancing, the minimal energy displacements in the ultra-transport system engendering the light fluids highest rate cycling Heat Rate maximum efficiency, affecting equal opposite reaction least energy flow from the transducers into Regions 3 structure. Heat Rate energy input vs. work output as high as 100% and higher Heat Rate efficiency ensues.

Said 100% Heat Rate excludes distortions, stress corrosion cracking and volume change by flaws in parts not in the ultra-transport system. The FEIIPMI, the PMII technologies embody the ultra-transport system absolute maximum conservation, the MEHC, of light fluids energy, which, thus, effects cycles and amplitudes displacement energy volume changes and stress corrosion cracking least sum stresses in structural members, all of which effect the ultra-longevity of the super plant.

Gravitational sink, epigene surfaces spawn the super plant energy boundary energy cycles by precipitated fluids useful thermal energy transferring from atmosphere into that energy sink or an in situ water prior and subsequent to passing the condenser units to cool the secondary coolant the super plant cycles; condenser units flow thru water, secondary coolant temperature difference yield generated electrical power Heat Rate efficiency. Aqueduct length flows prior, after passing the condenser units, gravitational sink, epigene surfaces or groundwater lowers flow temperature, comprising Heat Rate efficiency within energy boundaries of gravitational sink epigene surfaces.

Energy boundary of the gravitational sink epigene surfaces, the atmosphere effects difference by outflowing, inflowing in situ water temperatures, comprising Heat Rate efficiency heat energy transfer by in situ groundwater which effectuates in situ paths-of-passage lengths within and thru gravitational sink and groundwater natural in situ ambient temperature nigh 55 degrees. Therein below grade construction, aqueducts length comprises thermal energy transfers ultimate transfer.

In situ water cycling positive difference in inflowing and outflowing temperatures necessitate tracing energy paths thermal energy transfer inside perfections of the magnetosphere boundaries, in addition to convection, conduction and radiation energy transfers by said aqueducts length, the light fluids phase changing spawned thermal energy transfers comprise the EESD in environment energy, spawning cosmological global gravitational dynamics. Unique synergies in sciences and technologies and geological, astronomical sciences, supplemented by deep ice cores data, affirm, disclose energy transferring by prevailing energy events. No way can CO₂ concentration present in the ice cores embody global energy dominant events root cause. In no way, CO₂ concentration can embody convection, conduction, radiation, and/or phase changing energy events concomitant occurrence. Opposite is true. Prevailing global events energy transfers provoke energy transfers which cycle global nullity CO₂ concentration; and, yes, CO₂ emissions effect energy transferring.

The aqueduct lengths absolutely conserve water coolant mass energy in the aqueduct lengths inside epigene surfaces spawning optimal time duration, radiation heat energy ultimate transfers, which effect optimal heat energy transferring portion from the super plant into subsoil and inside epigene surfaces boundary. The aqueduct lengths' water outflowing onto epigene surfaces emits vapors' heat energy which innately balances in situ energy present by heat energy of evaporation which, in turn, cools surface of in situ water liquid phase, comprising epigene surfaces elevation.

The EESD energy, comprising environment temperatures, spawns heat energy of evaporation of an in situ water paths length along epigene surface. Mass and temperature of liquid and vapor phases and which imposes environment in situ path lengths regulatory agencies entirely regulate. Air masses and water vapors energy transfers affect Ferrel or Hadley cells cycling the light fluids between north and south 60 degree latitudes as well as cycling Subtropical and Polar Jet Streams.

Absolutely, radiations energy transfer from the aqueducts length to saturated, partly saturated subsoil and retained by the epigene surface constitute energy retained within liquids and solids of the gravitational sink, magnetic fields boundaries mass energy, which entirely sustains respective fields energy. The aqueduct lengths thermal energy transfer into subsoil embodies global climate energy, Heat Rate useful work. The aqueduct lengths outflowing water temperature equal or less than inflowing temperature comprises Heat Rate respective efficiencies 100% or greater. It is, of course, exceeding 100%, 10% of time by the energy directionalities thermal radiations directions reversal within epigene boundaries during periods of refueling and low electrical energy demand.

Heat Rate above 100%, really? Yes, by opposing global air warming environment, effecting quantum energy absolute balancing technologies, which engender sums cycling nullities of mass and energy sums within boundaries perfections, wherein the magnetosphere boundaries engender such boundaries in supporting life on Earth. Aqueduct lengths water temperatures, at outflowing less than its inflowing temperature, comprises mass and energy balancing by heat of evaporation, which relegates the epigene boundaries mass and energy balancing and shifts balancing quantum mass and energy inside the magnetosphere boundaries, which must affect boundaries perfections.

The aqueduct lengths water temperature radiates heat energy into underground soil. Its liquid phase heat of evaporation cools epigene surface. Its heat of condensation tries nigh balancing the atmosphere energy budget by cycling the super plant at nigh 100% efficient Heat Rate within the magnetosphere boundaries. In sciences prestigious literature and various publications consensus, the atmosphere unavoidably spawns radiations energy budget unbalances of 5% to 6%, which, of course, the magnetosphere plasmas—Jean's—fountains rebalances. All such, in turn, enormously fluxes dispositions of the magnetosphere boundaries and imposes atmosphere's energy means for dispensing the light fluids among cosmological mass and energy sinks. About 10% of time, thru refueling outages, aqueducts length radiations balance a portion of the energy budget unbalances.

The super plant utilizes gravitational field force to effectuate the epigene, the magnetosphere boundaries respective Heat Rate 100% efficiency, by rebalancing portion of 5% to 6% unbalance in the atmosphere energy budget, steadying boundaries perfections in taken dispositions. Energy balances make the Universe, the Advanced and fundamental Fluids Elements, the magnetosphere taken boundaries perfections, in complete conformance to the Uniformity Theory—Unitarianism.

All in consensus condone atmosphere is Earth's gravitational sink inseparable integral whole, wherein energy devices byproduct energy emitting, especially ‘clean’ energy emitting is ignored. Epigene surfaces solar irradiations is way overestimated, ‘clean’ energy emitting disregarded and the unbalance 5% or 6% of total energy budget way underestimated. None of that or such effects the FEIIPMII, PMII technologies, the PPLLS absolute technologies Heat Rate 100% efficiencies.

The FEIIPMII, PMII technologies embrace boundaries perfections, the PPLLS sums absolute technologies to spawn mass energy absolute cycles Heat Rate 100% efficiency, transferring mass energy in and cycled across boundaries perfections of the magnetosphere boundaries and epigene surfaces. Milankovich cycles, cycled energy in the early Pleistocene Epoch, undeniably show it. The three aforesaid gravity fields and cosmological global gravitational dynamics with the EESD cycle with flux the troposphere, tropopause. The MEHC, the minimum energy balancing cycling the ultra-conserving of boundaries perfections generically affect a global air warming root cause.

Milankovich cycles set forth the Solar System relative time and space mechanism shown cycling mass and energy of the Sun and its planets, comprising respective celestial bodies' orbital planes, in invariable plane respective orbital dispositions directionality and periods, while spinning about respective axis and orbiting the Sun. Each celestial body mass and energy occupies specific time and space dispositions. Celestial bodies and presence of the light fluids cycles the nullities' sums balanced environment to absolute quantum energy accuracy mass energy sums of nullities which cycle such sums to evolve boundaries perfections. The magnetosphere boundaries by boundaries perfections cycle cosmological global gravitational dynamics effectuate energies of life on Earth.

Global scientific community, IPCC sets time domain historical records of global temperature and carbon gases concentration obtained from the deep ice cores. All that data stunningly shows geological time cyclical global air temperatures and cycling compositions of gaseous and organic concentrations stunning correlation unanimous agreement that identifies causal effects in systems environment energy. The IPCC at al., claims CO₂ energy possess that energy. Yet, cosmological global gravitational dynamics, the relativity energy and the ultra-fluxing by energy in boundaries perfections of the magnetosphere raise the nullities' sums CO₂ concentration cycled time periods. Conversely, low magnetosphere energy lowers its CO₂ content in the nullities' sums high cycling rates, which concomitantly bolster cycling the nullities' sums and the energy relativity structures.

A steady unavoidable globally non-uniform inflowing of small to insignificant concentrations of various substances into the atmosphere above the continents, specifically at any historical time period prior to AGW, invariably raise global air average temperatures. Milankovich cycles time-temperature correlations from concentrations of various gases and organic substances presence in deep cores taken in ice and sediment show peaks and lows stunning pattern particular similarities among gases and δ¹⁸O oxygen isotope concentration, vs average global temperatures and vs time.

The prior global technologies' sciences “global warming”, literally, global air warming, links said stunning pattern particular similarities to causes of global air warming, to small insignificant concentrations of various substances, which undeniably is deeply, profoundly flawed conclusion. The small unavoidable concentrations, prior to AGW time, are those under 350 ppm and pertains to the atmosphere CO2 concentration specifically considered as impurities, herewith. In the deep cores, such impurities and concentration of various gases and δ¹⁸O oxygen isotope, relative peaks and lows cycling pattern stunning similarities, especially global temperatures precipitous cycling drops offsetting 100,000-years global temperatures rise, points to global air warming root cause.

Starting from widely accepted, absolute sciences, “global warming”, global air warming, root causal effects arise from ineffective water vapors heat of condensation radiated thermal radiation energy into space, thereby, balancing the Sun's, the Earth's thermal energy radiation, irradiation, within boundaries perfections of the magnetosphere and of epigene boundaries. All these change ice, water, and vapor phases and air to the light fluids mass energy to effect mass energy to space losses causal effects whose changing phases generate adequate water vapor mass energy volume.

The FMIIPMII, the PMII technologies yield boundaries perfections of the light fluids and the fundamental, the Advanced Fluid Elements and the PPLLS nullities nullity sums with the MEHC and the atmosphere mass energy cycling critical parameters. That cycling effects the MEHC and the PPLLS sums cycling quantum energy clusters clustering the nullities nullity sums, to embody or keep boundaries perfections of the magnetosphere boundaries. The North, South hemispheres yield Hadley, Ferrel and Polar Cells and Subtropical and Polar Jet Streams and, likewise, in turn, embrace nearly stagnant or stagnant air masses that, nevertheless, spawn the MEHC, the nullities nullity sums which embody and sustain boundaries perfections of the magnetosphere boundaries.

Cosmological global gravitational dynamics spin the Earth about its axis orbiting the Sun and the Sun spinning about its axis and orbiting about Black Hole of the Milky Way Galaxy to spawn enormous mass energy dynamics, engender almost all of the EESD in environment, including the Hadley, Ferrel and Polar Cells and the Jct Streams mass and energy. Thinned CO₂ concentration energy proximate Jet Streams altitude is much too low to be mistaken for energy of cosmological global gravitational dynamics, the EESD in environment of the atmosphere. Solar radiation, CO₂ concentration global air warming effects, within the Hadley, Ferrel and Polar Cells, engender the tropical belt, the Polar Regions temperature greater temperature differentials. The rising globally air temperatures evaporate, condensate water vapors larger mass, especially with melting glaciers and polar ice caps increasing surface water increasing exposure to sunlight. Wherein, the MEHC innately yields air masses effective rates of cycling and water vapor condensations optimal mass.

Most crucial genre of cosmological gravitational dynamics allows the MEHC to superimpose energy in environment, the EESD, which balances changing phases energy temperature changes' thermal gradients, including ionization and recombination and mass buoyancy stratifications and gradations density gradients; wherein, gravitational and cycling energy of erosion and deposition and combustion, friction and outflowing gases, and the Solar, cosmological radiation presence in the atmosphere embracing energies of the mega bulk power engender magnetosphere boundaries.

The nullities' sums cycling boundaries perfections by interfacing epigene surfaces engenders boundaries perfections of the atmosphere, causing mass energy epigene responses which balance that boundary and effectuate the magnetosphere boundary. And, everything balances to quantum energy resolution accuracies. Milankovich cycles embodies the Earth's orbital eccentricity, axial tilt, axial and apsidal precession and orbital inclination relative to the Solar system, the invariable plane that constitute the Solar system angular momentum plane. Cosmological and Solar System gravitational masses and energy and radiations and wind pressures affect energy dynamics inside the atmospheric boundaries. The Earth's gravitational field epigene boundaries then spawn, emit energy responses by radiation evaporation, and convection, and the EESD in environment spawn superimposed energy εums of epigene boundaries energy responses and Cosmological with Solar System mass energy inputs, while sustaining the MEHC of the atmosphere. The EESD mass and energy superimposing sums deform epigene surfaces and violently flux boundaries perfections of the magnetosphere dispositions which radiation and hydrogen ions do penetrate easily. Magnetic field cusps, magnetic lines disconnecting effects mass energy densities balancing magnetosphere fluxing boundaries dispositions spawning ions of oxygen, nitrogen and helium escape into space.

The troposphere, tropopause cycles fluids energy, air impurities concentration, and radiations energy, associated with Earth's gravitational sink epigene boundaries, except for hydrogen atoms and ions which escape into space. The gravitational, magnetic fields holds the stratosphere mass that buoyancy force lifts above the tropopause. The stratosphere cycles about itself, with density stratified layers that disclose Holes in the Ozone Layer above North, South Poles, which disclose Ozone to space escapes and the Earth's mass continuous energy emissions into the Solar System.

The Milky Way Galaxy and Black Hole cycle nullities' sums mass energy fluxing boundaries perfections the nullities' sums comprised the invariable plane angular momentum and boundaries perfections of the Solar System; the troposphere, tropopause and the stratosphere, in concomitant cycling mass energy nullities respective sums, effectuate mass and energy boundaries perfections spawning the nullities' sums of the magnetosphere boundaries. Wherein, the Milky Way Galaxy comprises its invariable plane, angular momentum mass energy with nullities' sums, which, also, embody, balance the Solar System cycling the nullities' sums, comprising boundaries perfections and the ultra-longevity boundaries of the magnetosphere boundaries effecting the nullities' sums.

The nullities' sums declaim applied and fundamental sciences, which disclose the Universe is effecting mass energy absolute conserving in the MEHC infinity upon infinity of concomitant do while loops mass energy infinity-loops comprising boundaries perfections and the nullities' sums algorithms fluxing boundaries perfections, by cycling a smaller mass energy in larger boundaries perfections of a larger mass energy. Concomitantly, boundaries perfections of the nullities' sums evolves sequences of boundaries perfections bounded largest mass energy affecting the Galaxies, the Universe and the light fluids smallest mass energy that yields molecules, atoms and electrons.

The gravitational sink fluxing mass of the light fluids cycling energy, inside typically globose spherical mass, comprises the Advanced Processor energy portion. Molten core of the Advanced Processor generates a magnetic field. The light fluids in the Advanced Processor's dormant state comprise frozen epigene mass. The minimum balancing energy and the relativity energy and the energy relativity structures associates with the Advanced Processor effecting the MEHC absolute conserving the light fluids do cycling fluxing energy in boundaries perfections relative longevity.

The Universe comprises galactic Advanced Processors invariable disk planes and boundaries perfections of galactic boundaries and the nullities' sums of mass energy galactic centroid, Black Hole, with invariable disk planes angular momentum. The Universe embodies three dimensional space infinites galactic centroids grid flux in the Advanced Processors mutual interactions lattice, the interactions lattice, in time domain. The interactions lattice interlaces the Newton's universal gravitation proportional energy force, including angular momentum, of any two of any Advanced Processors. At the galactic boundaries surface, slip faults effectuate and the universal gravitation proportional energy force transfers among Advanced Processors Sets in the interactions lattice; at the slip faults, boundaries perfections provide the galactic boundaries even where facing vacuum.

The Universe fundamental structures do consist of boundaries perfections comprising smaller mass energy cycling, fluxing inside boundaries perfections of larger mass energy, which initiates with eternal boundaries affecting boundaries perfections of the electrons and the atomic elements and ends with the ultra-longevity boundaries of galaxies in the Universe space time infinity. The minimum energy balancing, the relativity energy comprises the energy relativity structures which yield the ultra-longevity boundaries within boundaries perfections of respective magnetic field or gravitational sink. The energy relativity structures observed in space are taken as evidence of the curved space time, which, of course, violates the First and Second Law and is profoundly flawed.

In particular, violations of the First, Second Law assails the Universe fundamental structures, especially the energy relativity structures which embody the troposphere, tropopause yielding the ultra-longevity boundaries. Therein, especially, the wind turbines and solar panels producing the “renewable” and “clean” electrical energy” actually squander the minimum energy balancing and the relativity energy, which balances and prolongs integrity of the ultra-longevity boundaries and the energy relativity structures constituting the troposphere, tropopause. Violent and rare climate events, unusual variances arise in the relativity energy, in the minimum energy balancing uneven balancing, which warrants the wind turbines and solar panels removal from electrical power grid.

A forbidden mechanism event cycles energy which cycles the nullities' sums nullity, in chain reactions up and/or down sequence of forbidden mechanisms, requiting boundaries perfections of the Advanced Processors spawning the MEHC, the EESL) and environment boundaries of energy and mass. Of course, troposphere, tropopause cycling the nullities nullity forbidden mechanisms affect insignificant requiting energy responding feedback from Solar System cycling the nullities nullity. However, glacial age cycles climate changes do impose the troposphere, tropopause, and the stratosphere boundaries perfections affect the magnetosphere boundaries concomitant cycling respective nullities that in the atmosphere is equalizing energy of the EESD inside all boundaries perfections epigene, also, magnetosphcrc dispositions. Atmospheric fluids mass energy mixtures spawning mass volume, density, temperature variations and pressures within varying range of the atmospheric pressure spawn the tropopause as boundary between stratified, unstratified densities.

Several researchers propose, Milankovich declares, that the obliquity of the ecliptic (tilting of the Earth's axis of spin toward the Sun as it orbits the Sun) constitutes the dominant frequency of glacial periods. Orbital eccentricity (orbital shapes), precession (gyroscopic motion), and apsidal precession (inclination of Earth's orbit that drifts up and down relative to its present orbit) spawn the Earth orbiting frequencies. The scientific communities' consensus claims orbital eccentricity as setting dominant frequency of glaciation periods, and that is profoundly and decidedly flawed.

That consensus suggests profoundly flawed conclusion that thru millennia CO₂ concentration drives global climate system changes. In fact, the obliquity of the ecliptic does that, wherein and not surprisingly, the scientific community is profoundly misled by the prior scientific Theories of cosmological and global gravitation. In the last two million years, interglacial period's global air warming “global warming” invariably follows thirty one (31) glacial periods, which undoubtedly repeat without any AGW. Geological ramifications of the Theory of Uniformitarianism imposes in immediate future a glacial period. Global average temperatures and CO₂ concentrations effect concomitant rising, expected to rise unavoidably, since CO₂ AGW energy emission is increasing.

In 1955, a first record of ice ages dating provided temperatures based on δ¹⁸O oxygen isotope in microscopic shells of ocean plankton serving as a proxy thermometer, which also discloses the dominant cycle 41 ka (1,000 years=1 ka) glaciation periods, dozens rather than four ice ages. An assuming consensus is that 41,000-year variation in sunlight is much too short to spawn ice ages.

To explain CO₂ concentration driving global warming climate changes, scientific community statistical analysis, thus, very recently, switches from obliquity dominant 41 ka climate cycling to 100 ka eccentricity cycling period's relative variation matching to the invariable plane. However, additional validation of such cycling spawns inconsistencies in northern hemisphere's insolation.

Numerous issues surface with 100 ka cycles, since eccentricity variations yield a significantly lesser solar insolation global climate Milankovich Theory impact to effect a dominant frequency, rather than obliquity or precession spawns. Then, there is the cycling frequencies transition issue switching periods in early 2-1 Million (Ma) and late (1 Ma to recent) Pleistocene Epochs, as well as, imprecise 41 ka periods of ice ages with various researchers claiming inconsistencies; wherein theoretical climate forcing is smaller than in obliquity and precession frequencies putative effects which precede the transition issue during the Pleistocene Epoch that reveals dominant root cause.

Cosmological global gravitational dynamics and the EESD spawn global air warming cycling energy which include radiations, irradiations; magnified said energies breach the magnetosphere on a frequency interval of 41 ka dominant frequency, in Earth's frequencies of cycling dynamics. Atmospheric insolation naturally magnifies the EESD, in environment energy, wherein the three gravitational sinks, here, the intermediary gravitation sinks, flux cycling atmospheric energy, the nullities' sums and embody Magnification-One water vapor and CO₂ concentration as impurities.

Magnification-Two in liquid phases mass portions PP densities comprise epigene watersheds drainage conforming exclusively to gravitational field PP cycling directionalities, which embody ultimately short cycling time durations conforming to epigene elevation gradients, entirely those of gravitational field liquid phases and conforming to boundaries perfections of epigene surfaces.

The gravitational fields influence and restriction on liquids, gases in the epigene, atmosphere cycling nullities embody the MEHC optimal directionalities of liquids, gases, respectively. Such directionalities in gravitational field inside epigene boundaries engender the liquids inflowing the tropical belt regions in ultimately short time durations spawning oceans currents which neutralize all inequalities. Atmospheric precipitations also affect liquid phases' ultimately short duration in cycling surface runoffs. Conversely, the intermediary gravitational sinks, energy fields spawning atmosphere cycling the light fluids and all impurities (such as CO₂ concentration) associates with the light fluids cycling the nullities sums. As evapotranspiration, photosynthesis diurnal oxygen, CO₂ concentration PP reversed directionalities, the cycling nullities yield ultimately long relative durations. Epigene fluids' cycling nullities, PP sum portions, in environment and the atmosphere embodies ultimately long, short relativity exposures to gravitational sink, solar insolation relative cooling and warming mode. All such effect environment energy insolation Magnification-Three.

Magnification-Four embodies watersheds drainage longest transports predominant duration's to tropical-bell, continually shortened durations, bolstering inflowing impurities into air currents.

Spurious directionalities transport of air impurities (water vapors, CO2 concentration, etc.) in mass energy PP lengths cycling nullities magnifies maximally the Hadley, Ferrel, and Polar Cells optimally long cycle relative time durations, which maximizes insolation global air warming and the troposphcrc, tropopause engendering Magnification-Five maximal air warming temperatures.

Magnification-Six affects inactive, dormant and stagnant pockets, bulbs, domes of air masses which by gaining altitude avoid precipitations and trap impurities, while rising, in turn, warm-up.

Magnification-Seven floats stagnant volume air mass pockets, bulbs and domes toward poles, which, thereby, merge into bulging doming air mass that rises and stratifies, then, presses against densities of stratosphere, therein, comprising levitating domes of air mass under the stratosphere.

Feedback-One affects Magnification-Eight wherein rising environment temperature increases the tropical belt, the polar ice caps separation distance, thereby, increasing the PP lengths cycling exposure to Solar, cosmological radiations and wind pressures, which, thus, effectuate impurities even more disproportionate durations relative cycling thru the atmosphere, the gravitational sink.

Feedback-Two affects Magnification-Nine wherein environment rising temperature increases the troposphere, tropopause in volume, which traps more radiations energy and slows air cycling.

Feedback-Three, Magnification-Ten rising temperature in environment, in turn, affects larger impurities concentration, especially water vapors in troposphere, further raising air temperatures.

Feedback-Four, Magnification-Eleven comprises higher impurities concentration which slow air streams cycling rates, maximizing troposphere environment global warming temperature rise.

Feedback-Five, Magnification-Twelve slow cycling rates yield pockets, bulbs of stagnant air, magnifying the troposphere, tropopause heating rate that boosts epigene fluids' mass outflowing.

More than needed insolation in the bulk energy evolves stunning modifications in boundaries perfections of the magnetosphere and epigene surfaces to the First and Second Law and, also, the intermediary gravitational sinks which affect the EESD of Magnification-Thirteen and insolation energy Magnification effecting Magnification One thru Thirteen superimposed insolation energy.

The Pleistocene and Holocene Epochs glacier shrinkages, in time domain, evolve boundaries perfections epigene surfaces, which steadily boosts insolation Magnification. Frozen planet crust insolation Magnification and its evolving of its crust are near nullity. However, in geologic time, the Earth has past that stage. It emits the light fluids to lower pressures, the relativity energy and the minimum energy balancing causing insolation Magnification drop by plasma outflow energy.

A boundary low energy balancing ultimate volume boost longevities; a closed boundaries total energy yield energy balance. The super plant, the PMII, the FEIIPMII technologies address total energy balance, first. The IPCC miss geologic epoch climate changes energy, atmosphere's cycling energy, the minimum energy balancing, and the relativity energy—each miss a fatal flow.

Insolation Magnification additional numerous fine details exist in geology documentations to affirm glaciation periods, tectonic and volcanic activities, magnetic fields shifting and shifting of continents spawning the EESD superimposing energy. All energy is comprising cycling nullities of relative lengths portions to PP sums cycling rates which affect global air warming. Respective deep core-borings continual samples date CO₂, methane and 8¹⁸0 concentration, whose graphical concomitant atmospheric temperatures verses time plots confirms the Milankovich cycles similar cycling structures. The core borings with Milankovich cycles are atmospheric energy record that must include the plasma fountains energy outflows as the troposphere, tropopause energy record.

The stratosphere's mass energy cycles about itself, except for energy associating with plasma fountains. Thus, it affects the troposphere, tropopause an elastoplastic shield covering, only. By all measures of life sustainability on Earth, troposphere-tropopause is perilously, stunningly thin.

Recent research estimates that a quarter of Earth's water mass is lost into space. Tracing oxygen mass associating derivatives yields a stunning, enormous one atmosphere's mass energy loss into space, and Earth's, Moon's cycling light fluids lost mass yielding continuous separating in space.

The deep cores taken continuous sampling yields prima facie data that discloses the obliquity yields the dominant frequency of the Milankovich cycles cycling environment energy, the EESD.

cosmological gravitational dynamics cycling energy yields precise synchronous and concomitant lowest temperature, CO₂, δ¹⁸O oxygen isotope and methane impurities relative concentration and glacial periods start with ensuing temperatures air impurities concentration respective rises; all of which yield concomitantly the EESD environment energy in relative time and concomitant rising into sharp peaks relative levels of the prior and next peaks in interglacial periods. All such peaks precipitously and concomitantly attenuate into glacial periods' lowest temperature relative levels, Milankovich cycles shown typical structure. But, continually persistent temperature increases in a glacial period show even lowest CO₂ concentration is mostly an effect not a cause of global air warming. Flawed science technologies of IPCC sciences Milankovich cycles reaffirms 50 times.

During entire Pleistocene Epoch aforesaid is the case; Milankovich cycles engender obliquity 41 ka frequency processes dominant structure that repeats, till nigh 1.2 million years ago one beat skip, doubling its period to nigh 83ka, while during the late Pleistocene and the Holocene Epoch, one or two beats skip in obliquity frequency, as if 125 ka occurs. During each cycle, three effects which emit the atmosphere's thermal energy are following: condensation radiation into space and convection, conduction, and radiation into the mantle's mass by the light fluids cycling mass and emitting the light fluids, plasma fountains' plasma, by the troposphere, tropopause cycling fluids.

The obliquity dominant frequency, thru late Pleistocene Epoch and Holocene Epoch, appears to skip beats which occur due to the Magnification of insolation, associated with processes of the polar ice caps, glaciers retreating, Hadley and Ferrel Cells expanding, Polar Cells shrinking with Earth's gravitational, magnetic fields' weakening and the eccentricity and precession frequencies participating. Plasma fountains outflow plasmas relieve any excess pressure in stagnant, bulging air domes into the stratosphere and, in turn, into the ionosphere which, in turn, outflows plasmas.

Feedback-Five, Magnification-Twelve, first part, briefly states causes of enlarging air domes. The plasma fountains, a plasma outflowing threshold occurs several millennia prior to an ensuing obliquity frequency peak. Plasma outflowing spawns the troposphere, tropopause a slow cycling rates pick-up, but not appreciably showing indiscriminate fluxes in temperature and in CO₂, δ¹⁸O oxygen isotope and methane relative concentrations, give illusion of dominant frequency change.

Prior paragraph describes plasma outflowing and buildup pressure release in tempered loss of accrued insolation energy in slow cycling, dormant, stagnant, warm and doming air mass bulging the stratosphere, which, then, in turn, bulges into ionosphere, which erupts in plasma outflowing. An energetic threshold comprising plasma outflowing minor outflowing can explode into plasma outflowing explosive event, which syphons the troposphere, tropopause doming air mass into the stratosphere, which, in turn, reinstates slowly the tropopause, troposphere, the light fluids cycling ultimate rates. In time, all that concomitantly yields impurities concentration lowest prior levels.

A plasma tempered outflowing that releases insolation thermal energy buildup which accrues thru millennia is not an apropos scenario, due to potentially losing the North Pole ice cap crucial, absolutely necessary component in the troposphere, tropopause cycling the light fluids absolutely highest rates. The deep core borings point to persistent flux continual rises in CO₂, Methane, and δ¹⁸O oxygen isotope relative concentration. Plasma cycling, explosive eruptions, thru the Earth's entire glaciation, engender also global temperature concomitant precipitous, rapid, relative drops.

Identical repeated relative magnitudes of precipitous, concomitant, rapid drops disclose each cycle repeated concomitant identical processes to impurities relative concentration return to prior lowest levels conformance to the obliquity dominant frequency cycling concomitantly disclosing Milankovich computed illumination cycles. The concomitant identical processes thru millions of years, where relative energy actions engender the Earth's energy relative reactions and impurities relative concentration return to lowest levels conforming to cycling frequencies dominant cycles. Boundaries perfections evolve inside the magnetosphere to the EESD balanced actions-reactions having mass energy compliance with everything in the troposphere, tropopause cycling nullities, yet affect dormant, stagnant, stratified and warmed, buoyed air mass that bulges the stratosphere.

Air mass volume that domes into the stratosphere grows by intercepting, aggregating floating randomly air mass in volume of boundaries perfections cycling nullities of the light fluids, which slows cycling rates by of random air mass volume upward directionality. The light fluids cycling still affects the random air mass a lower portion but not a portion that domes into the stratosphere which, in fact, cycles conforming to the stratosphere slower nigh dormant cycling rate. Thereby, entire impurities concentration mass segregates by residing in the buoyed air mass lower portion.

In any one Milankovich cycle, global temperature yields rising trend that CO₂, Methane, δ¹⁸O oxygen isotope respective concentration and global temperature follow; when fluctuation of each relative concentration and relative temperature change is prorated over time interval of any cycle, each relative concentration and respective temperature shows relative structure with concomitant relative flux similarity. The prior sciences impute all and each respective, relative concentration, temperature to rising trend in CO₂ concentration, its respective, relative flux. None of it is valid.

Likewise, the prior technologies science promulgates critical CO₂ levels emission guidelines, to sustain, preserve and spawn the Earth's environment and atmosphere. And, of course, none of that is valid, also. The Universe absolute balances eternal cycling and cosmological gravitational dynamics, as the EESD in environment energy, impose atomic elements balancing fundamentals, affecting internally boundaries perfections to the MEHC energy absolute balancing. The Earth's epigene boundaries bounding the gravitational sink core portion modulates energy within, which, therein, modify solar insolation into the MEHC yielding the epigene surfaces. Elastoplastic mass of the elastoplastic shield covering of the stratosphere in the gravitational, magnetic fields energy spawns, attracts electrical charges respective densities yielding mass weight respective ions mass charge. The respective pressure mass weight, ions mass charge comprise the stratosphere energy of ultimate integrity, which transmits the magnetosphere enormous energy damped fluxing to the tropopause, troposphere boundaries whose energy of ultimate integrity is that of the stratosphere.

Magnetic fluxing lines in the magnetic field optimally bear brunt of solar radiations and wind pressures energy by utmost elastoplastic damping inside the stratosphere ultimate integrity and in the remaining energy transmitted to boundaries perfections of the troposphere-the tropopause. In Hadley, Ferrel and Polar Air Cells, the Air Cclls, the light fluids cycled in boundaries perfections of the troposphere, tropopause, and the stratosphere boundaries relative actions reactions envelop the Air Cells and the Subtropical and Polar Jet streams. The light fluids mass weight density, the electrical charge in the gravitational and the magnetic fields effects elastoplastic propagating flux energy damping and latency, wherein the Earth's angular velocity distributes fluxing energy well within ultimate integrity of the elastoplastic shield a potion that covers the gravity field lee side.

Science behind the Milankovich cycles computes global insolation energy in the atmosphere, as solar energy actions provokes reactions by cycling air masses in the Air Cells and Jet Streams, cycling energy. The Air Cells, Jet Streams energy actions, as the tropopause, troposphere action, spawn the epigene surfaces reaction disclosed by ice, soil-rock deposits, impurities concentration content disclosed by deep core borings which disclose processes energy that spawns the deposits.

The scientific community overlooks effects of the Air Cells and Jet Streams as energy source action that effects soil, ice deposit as its reaction. CO₂, Methane, 8¹⁸0 oxygen isotope respective concentration, then, is not the energy source action spawning global air warming but its reaction, effectuating infinity upon infinity balancing actions relative reactions in sequences of boundaries perfections affecting the MEI IC inside the Fluid Elements, Advanced Processors in the Universe.

The stratosphere elastoplastic shield covering restricts tropopause, troposphere cycling the nullities nullity. The Milankovich cycles energy, complying with the obliquity cycling, 50 times in only the last 2 million years, energy of the tropopause, troposphere spawned reaction exceeds, insolation energy action. In each instance, cycling CO2 concentration under 220 ppm, very close to concentration that grants life on earth, does not preclude air warming phenomenon. All of that and more the deep core samples show. Foremost, the core samples show, low CO₂ concentration science, is delusional. It can fail, only! In last 2 million, 50 times, in 4.5 billion years many more times, to Sir Eddington famous quote on flawed sciences, “there is nothing for it but to collapse”.

Computer models validate CO₂ emissions restriction benefits. However, wind turbines, solar panels electric power generation effect the prior flawed sciences, counterproductive technologies under disguise of renewable, clean energy, deserving Sir Eddington stated “deepest humiliation”. Earth's insolation Magnification in the tropopause, troposphere generate global air warming root causes, effectuating the First and Second Law, PPLLS nullities cycling boundaries perfections to nonconformance, chronic misbalancing. Likewise, the deep core borings further show increasing the Air Cells rates of cycling lowers temperature; such rates causal effects spawn glacial periods.

Aforesaid rapidly energetically syphoning the dome of air mass doming into the stratosphere occurs at the Ferrel Cells highest latitudes as thickness at altitude about 16 km drops to the Polar Cell abutting about 9 km thickness; a growing dormant, stagnant, stratified, warmed, and buoyed the air dome rises, pushing into the stratosphere by Ferrel and Polar Cells confluent cycling. The polar ice caps in the early Pleistocene Epoch spawn the Ferrel, the Polar Cells relative interfacing near N30° latitude wherein in the late Pleistocene and now Holocene Epoch that interfacing nears N60° latitude. In the latter instance, the air dome rather than syphoning rapidly and energetically drains slowly thru the magnetic field a cusp and the stratosphere affected the elastoplastic shield. Then, the air dome syphoning lasts thru millennia; the Air Cells cycling rates barely increase. In turn, impurities concentration, temperature show marginally drops; the obliquity cycle beat skips.

In unusual unambiguity, the deep core borings duly reveal the global air warming root causes of cycling energy effectuating the Air Cells cycling the light fluids cycling rates. Fluids' cycling environment cycles in reaction response to that energy action, especially impurities concentration which includes their spawned responses. Especially water vapor and CO₂ relative concentrations penetrate interstitial space of the light fluids molecules, which, in turn, become insolation opaque and rise in temperature. Impurities concentration concomitant sharp peaks are followed by rapid relative drops to lowest lows, which, in turn, effects sudden increases in cycling rates of the light fluids is a response to the plasma fountains energetic rapid release that syphons most of growing stagnant stratified randomly buoyed environment energies restrains the Air Cells energy cycling. Unblocking and blocking of the light fluids relative energy cycles spread from the Ferrel Cells to the Polar, the Hadley Cells, analogous to impurities concentration cycling, dissipating throughout both Hemispheres. Said core samples further disclose boundaries perfections of epigene surfaces continual balances with the EESD environment energy and cosmological gravitational dynamics.

Insolation energy in Milankovich cycles, the EESD, environment energy spawn cosmological gravitational dynamics, which balance in the atmosphere by partial transfer to epigene surface, as relative energy reaction, action precisely balanced energy of impurities concentration in deposits. Thus, epigene energy balances precisely; magnetosphere boundaries fluxing enormously balance precisely, but barely; the elastoplastic shield covering of stratosphere balances itself, transmitting damped precisely energy, while the troposphere-tropopause do not precisely balance. The EESD in environment at or near peak obliquity siphons the troposphere, tropopause to precise balances. The First, Second Law, the MEHC absolute energy conserving, fundamental sciences make such apparent, which global air warming sciences, the prior gravitational theories stunningly discount.

The Pleistocene Epoch aforesaid data, provided in entirety by the deep core samples, confirm explicitly global air warming natural phenomenon as old as the atmosphere itself, comprising the Air Cells cycling directionality and absolutely negligible, dispensable CO₂ concentration energy, in cosmological gravitational dynamics absolute environment energy, the EESD, which engender merging fluids in fluids' boundaries perfections embracing the MEHC quantum energy accuracy.

Scientific community, the IPCC rational to effect controlling global air warming goes beyond genuine comprehension—it absolutely, positively cannot succeed. Global air warming root cause is not effect of CO₂ concentration energy which stays suspended in the light fluids, while cycling. Cosmological gravitational dynamics environment, the EESD, affects all cycling energy, cycling rates in the Universe. The EESD effect the Air Cells cycling rates of fluids, the energy relativity structures. Stratosphere, tropopause and troposphere boundaries perfections the energy relativity structures, including life on Earth, rely on the Air Cells' energy cycling rates and directionalities.

The prior sciences Gravitational Theories deep and profound flaws of the First, Second Law magnify, stunning concomitant omission of cosmological gravitational dynamics, the MEHC and boundaries perfections; the Advanced Processors, the fundamental Fluid Elements and the EESD cycling energy environment the Universe energy balances fully. The prior sciences miss all of it.

Insolation remains stable and steady, while epigene surfaces engender boundaries perfections by energy of erosion, deposition and concomitantly by both. That energy of deposition is energy reaction of epigene surface to energy of action and the EESD in environment energy, comprising cosmological gravitational dynamics in environment. Energy of deposition as energy of reaction with the EESD in environment energy concomitantly evolve boundaries perfections with epigene surfaces. The deep core borings data of soil and ice deposits, respective impurities concentration concomitantly and individually pertain to relative depositions reaction energy. Reactions energy always associates with energy of action wherein soil or ice deposit characteristics reveal relative energy of dissipation, dispersion and transport responses to concomitant mass and energy action.

Said impurities, any and all concentration present in the deep core borings possess absolutely enormously insufficient energy to effect global uniformity to dissipate, disperse, transport, and to produce soil and ice deposits. Impurities concentration show concomitantly similar structure of fluxing and relative highs and lows thru Pleistocene Epoch. All of that points to single energy of action source, which as a general rule physically is not present in core borings but is known from known similar energy processes which yield characteristics of core samples. Global air warming by 200 to 400 ppm CO₂ concentration requires dissipation, dispersion and transport energy action it simply does not possess; its mere presence in core borings shows mass that has no such energy.

While CO₂ concentration as one of impurities in air that incrementally affects air temperature effects just that, incrementally raises air temperature, only. It is the light fluids energy of cycling action as the EESD in environment energy, which cycle tropopause, troposphere energy of action cycling Air Cells mass, which effects the Air Cells cycling energy that is global air warming root cause. Only one source can engender global mass energy uniformity, which dissipates, disperses and transports soil and water vapor into deposits, where gravitational field predominantly spawns ice with soil actual deposits. Thus, it is Air Cells mass energy cycling which magnifies, as supra enumerates, Earth's insolation energy by quantum accuracies that spawn global air temperatures.

Structure technologies are based on energy of deformation and volume change which elastic, shear and bulk moduli grant within elastic limit of materials. Therewith, outside boundaries of a structure are constructed, effected, which under load, inside these boundaries yield elastic strains, which, in turn, results in a stable structure. Analogous to energy principles and methodologies of structure technologies energy added and taken out in present instance thru boundaries perfections of epigene surfaces stabilizes boundaries perfections of the troposphere and tropopause; and, that is exactly what the light fluids cycling nullities quantum energy of the EESD in environment and boundaries perfections of tropopause, troposphere and magnetosphere boundaries do and is cause of energy release to space, also. Thus far, none of these spawns eternally boundaries perfections.

Fluxing energy of deformation and volume change by boundaries perfections of an Advanced Processor yields the MEHC conserving absolute mass energy, within boundaries perfections, and in ordinary structures, as well. In ordinary structure energies flow, as if stresses flow. Inside any boundaries perfections, air elastoplastic fluids in the magnetic and gravitational energy fields, the light fluids mass flows as energy flows, yielding the Advanced Processor and yielding the energy relativity structures of interacting cosmological gravitational dynamics. Nigh perfect boundaries, in fact, embody the light fluids cycling the nullities nullity cycling gravitational, magnetic energy fields evolving into boundaries perfections by balancing of imbalances. Earth energy boundaries evolves the energy relativity structures of the light fluids in the gravitational and magnetic fields.

Earth's gravitational and magnetic fields concomitantly evolve the relativity structures by the Universe omnipresent cosmological gravitational dynamics to boundaries perfections of the three absolutely stunning paradigms—the tropopause, troposphere boundaries, the magnetosphere, and epigene surfaces. Light fluids relativity structures by the gravitational, magnetic field disposition and relative energies synergy compatibility affecting the elastoplastic shield shielding air masses.

In general, and instead a ring or rings of planetary dust of substantial mass energy decoupling occurs rather than the light fluids ionized sphere spawning boundaries perfections comprise thick stratosphere's elastoplastic shield. The EESD in environment energy engendering Magnification factors, by the light fluids cycling nullities yield global air warming root causal effects analogous to resonating frequencies cycling energy in structures. Gravitational, magnetic field dispositions relativity strengths synergy and compatibility balance the light fluids cycling the nullities nullity; the minimum energy balancing flux the energy relativity structures configuration, orientation and rotations, which in time domain affect the ultra-longevity boundaries and boundaries perfections.

Boundaries perfections reverberate unnoticeable concomitant balance by the energy relativity structures, in general and also the Solar System, in particular, except on boundaries of the Earth's magnetic and gravitational energy fields and the First, Second Law and the MEHC, which spawn the omnipresent mass and energy absolute conservation. Magnetosphere boundaries perfections, cosmological global gravitation dynamics in the Solar System, and Earth concomitant flux to the minimum energy balancing affect the energy relativity structures, relative energy sums of Earth's gravitational, magnetic fields, which constitute the energy relativity structures of the atmosphere.

The stratosphere embraces the intermediary gravitational sink and the elastoplastic shield and the energy relativity structures of ionized elastoplastic spherical form of the light fluids mass and energy, energy dampening which imposes the EESD, the MEHC in environment energy absolute perfection. The plasma energy of volume changes effects plastic deformations damping, wherein the magnetic field, gravitational sink energy and buoyancy force resilience yield elastic damping.

In time domain, the energy relativity structures, Air Cells, Jet Streams levitates stratosphere's elastoplastic shield, which magnetic and gravity fields' energy anchors. The Solar System's also cycles cosmological gravitation dynamics the nullities' sums, the energy relativity structures, and the energy relativity structures Air Cells and Jet Streams spawning the light fluids energy actions and relative energy reactions in Earth's gravitational sink and magnetic field cycling energy flux.

In rime domain, soil ice deposits yield energy record of the EESD environment energy action reaction. In all instances, reactions and depositions energy equals actions energy cycling MEHC, EESD absolute perfections and the deep core boings impurities concentration fluxing records the energy relativity structures cycling reactions, to cosmological gravitation dynamics in the energy relativity structures energy actions. Quantum energy yields the energy relativity structures of the troposphere, tropopause and magnetosphere boundaries and epigene boundaries spawning energy of distortion and volume change, damping, fluxing, which reverberates actions, reactions energy. Cycles by energy of distortion and volume changes concomitant impurities concentration cycling the deep core borings consistently note by all-time highs subsequent rapid drops to all-time lows.

Cosmological gravitation dynamics keep the energy relativity structures in boundaries during

Pleistocene Epoch. Concentration of CO₂, methane gas in gravitational field mass energy budget remains unchanged; AGW is not present at that time and, yet, enormous volumes of mass energy escape the gravitational sink. The Intermediary gravitational sinks affecting the stratosphere, the elastoplastic shield of mass energy outflows plasma into Solar System energy sinks, by balancing imbalances. Earth's gravity field sink readily spawns boundaries perfections of epigene surfaces, which disclose troposphere, tropopause inability to eternally engender its boundaries perfections.

The atmosphere innately affects global air warming, wherein the troposphere, tropopause, the energy relativity structures fail to cycle eternally energy to affect boundaries perfections. Planets evolve predominantly a hot or an entirely frozen surfaces shows the troposphere, tropopause fails to affect boundaries perfections, and the light fluids cause global air warming. Polar ice caps and glaciers retreat boosts the Magnification factors which slow the Air Cells cycling rates. Thereby, in turn, the plasma fountains prolonged outflowing weakens gravitational, magnetic field energy.

Top doomsday scenario collapses boundaries perfections of the energy relativity structures of the troposphere and tropopause and the Air Cells and the Jet Streams cycling energy significantly amplifying the insolation Magnification factors dissipates the energy relativity structures. In best sciences prognosticating, North Pole ice cap demise has doomsday scenario start in four decades.

Doomsday scenario two distends boundaries perfections, the energy relativity structures, and the troposphere, tropopause of the intermediary gravitational sink by AGS energy emissions and, in turn, forcing plasma energy outflowing at precession and eccentricity dominant frequencies, as well as, a continual outflow. Thicknesses of the troposphere, tropopause at North and South Pole is 9.0 km, only. Wherein the top and second doomsday scenarios embrace propensities to merge.

Doomsday scenario three has the Magnification factors of Magnifications global air warming energy of distortion and volume changes, which break integrity of the energy relativity structures of boundaries perfections. Repeatedly, in each instance, impurities concentration at all-time low, in time domain, affirm the deep core borings global temperature rises, by global air warming; the deep core borings reveal Magnification factors energy sever boundaries perfections of the energy relativity structures, the tropopause-troposphere, which spawn global air warming all root causes.

Nigh zero CO₂ concentration yields global air warming, also. The deep core borings show it. Cycling structure similarity consistency in fluxing impurities concentration, temperature found in soil, ice samples of deposits, which scientific community globally correlates, thereby, is showing time domain same cycling energy transports effected soil, ice deposits. Globally correlating soil, ice deposits structure of fluxing impurities concentration, in turn, shows fluxing in energy source impurities concentration global transport. One energy source global disposition is cycling global impurities concentration and temperatures. Of course, the Air Cells energy is that energy source.

Doomsday scenario four effects the light fluids spawning violent climatic events unbalanced, asymmetric distribution of mass energy, especially by relentless precipitations, wherein erosional effects shortens fluids inflowing into the tropical belt, magnifies Magnification factors, which, in turn, spawn continental groundwater low levels, with barren central portions, and global famines.

In insolation environment, the light fluids cycled impurities concentration in interstitial voids gain radiations thermal energy that by convection, or by contact by conduction heat environment. Predominant among impurities, water vapor cycles and transfers bulk of that energy by changing phases. The light fluids thermal energy limited portion, by precipitations temperature difference, transfers to groundwater. Bulk heat energy transfers rate in insolation environment mass volume greatly exceeds such transfers rate into groundwater mass volume. Surface waters phase changes cools groundwater, yields global air warming and magnifies of the EESD in environment energy.

Condensations and evaporations thermal energy balances boundaries perfections, only, when the troposphere-tropopause is impermeable, which is not the case. Said heat energy transfers rate of insolation energy to groundwater show the plasma fountains outflowing affects the light fluids loss to space mass energy directionalities flowing diametrically which opposes directionality into the gravitational sink. Said directionalities and directionality is prima facie credibility that shows flows in Quantum Theory theorizing that future meets present; the present meets the future, only.

Planets subliming ice surface emits vapor into gas environment, raising its temperature above freezing on otherwise entirely frozen planet. Concomitantly, cycling of air particles starts, due to established temperature gradient. Much later in time domain, a first plant emits first CO₂ into the air as temperatures stay above freezing. That sequence, in time domain, is prima facie credibility that water vapor and cycling of air in environment, both precede CO₂ cycling. All three correlate to δ¹⁸O oxygen isotope and yield fluxing air temperatures. The doomsday scenarios superimpose mass energy of the gravitational field flowing directionalities directionality opposed to Air Cells, Jet Streams cycling, which, as the EESD in environment energy, cycles impurities concentration.

The global air warming root causes are the mantle cooling, where cosmological gravitational dynamics superimposing fluids environment, affecting the EESD in environment energy, therein, magnifying insolation energy. Explicitly, insolation energy magnifies the EESD in environment, spawns the light fluids cycling energy optimal water vapor contents, slows Air Cells mass energy cycling, boosts ambient temperatures and flow energy directionalities diametrically opposing the Earth's gravity cycling directionalitics. Whereby, impurities concentration by optimal emissions from epigene surfaces into the troposphere, tropopause fluids boosts, also, ambient temperatures.

The EESD in environment energy magnifying insolation energy yields energy imbalance that shows up in Earth's energy budget and in Pleistocene Epoch and inside boundaries perfections of the magnetosphere. At obliquity dominant frequencies, plasma outflowing relieves and balances imbalance; in turn, Air Cells boost cycling rates and precipitation frequencies, which drop global temperature and of all impurities' concentrations, which lower flowing the energy directionalities diametrically opposed to gravitational sink. In time domain span, energy flowing directionalities and precipitation frequencies effect impurities concentration relative drops from highest peaks to lowest lows, spawning global tcmperature, impurities concentration transition into glacial period.

Insolation energy magnifying erodes steadily the gravitational, magnetic fields in interglacial periods by outflowing plasma, as supra explains, from Pleistocene into Holocene Epoch. In each of the four doomsday scenarios, cycling energy three directionalities one direction, with the other two, effect the root lead causes of failure modes, and CO₂ and impurities concentration excess as contributing effect, only. CO₂ concentration, in all instances not dominant impurity, points at the EESD and cosmological gravitation dynamics, cycling of energy as the failure modes root cause.

In the last 300 years and especially in the last 30 years, global industry is dumping fluids and energy byproducts into the atmosphere which, as supra explains, is tenuously coupling to Earth's gravitational sink, comprising the intermediary gravitational sinks. Collectively, those fluids and energy byproducts comprise potentially one volume of the atmosphere as supra notes. All which yield the mass energy flowing directionalities diametrically opposed to gravitational sink, which, in turn, attenuate the Air Cells energy cycling, which, in turn, boosts the troposphere, tropopause impurities concentration, which, in turn, magnifies insolation temperature, all of which boosts air temperature. All which effects global air warming, wherein CO₂ is a concomitant impurity, only.

Herein, details science behind Milankovich cycles, confirmed by the deep core borings data. Wherein, cosmological gravitational dynamics with the EESD cycling energy in environment in Pleistocene, Holocene Epochs affect global air temperatures and impurities concentration effects. Bungling cosmological gravitational dynamics (and the EESD cycled energy in environment) by experimentalists-theoreticians, in the prior art flawed sciences, convinces global citizens that low CO₂, AGW emissions solves global air warming issues, which, of course, is fundamentally false.

The experimentalists-theoreticians address no energy emission issue. AGW energy emission absolute nullities is necessary; Earth's actions in Pleistocene Epoch to Uniformitarianism Theory cycling of cosmological gravitational dynamics within fluxing cycling temperature ranges in that Epoch, which, likewise, are unacceptable, since plasma continual outflows to space are no longer acceptable. Troposphere, tropopause mass volumes present thicknesses are too shallow, already.

In the last eight decades, bungling experimentalists and theoreticians at large usurp, dominate and impose delusional Gravitation Theories deep flaws and the Second, First Law and the energy relativity structures undefined boundaries misuse. Form of energy and mass energy transposition flowed substitutions yields imaginary science. The Universe evolves perfection of everything by energy cycling conformance to 100% Heat Rate efficiency. Wherein, bungling experimentalists, theoreticians misapply the minimum balancing energy of the energy relativity structures, the Air Cells cycling energy to generate electrical energy, calling it clean renewable energy. In fact, low and moderate Heat Rate devices solar panels, wind turbines sap energy from the energy relativity structures, the minimum balancing energy, with the troposphere, tropopause ultimate longevities.

Of course, deeply flawed the prior sciences and art effects catastrophic climate change. Low, moderate Heat Rates with respective, moderate mass energy byproducts comprise directionalities diametrically or significantly opposing Air Cells' energy directionalities cycling 100% Heat Rate efficiency. Stunningly, said prior sciences profound deep flaws substitute CO₂ concentration 200 ppm above all-time laws for inefficient cycling rates by the Air Cells, the EESD, and the MEHC. The Air Cells energy deposits soil and ice found in the deep core borings, not CO₂ concentration; that energy embodies, is by far global temperature rising dominant driver, not CO₂ concentration.

Eight decades ago, scientific communities, at al. declare and, thereafter, accept deeply flawed cosmological theories, wherein wind, solar power generating energy for consumption effectuates prima facie credibility of sciences neither grasp nor comprehension of cosmological gravitational dynamics Earth sciences. The Universe evolves boundaries perfections in everything and yields, comprises, and encompasses the Theory of Everything, comprising bound boundaries perfections of everything, the fundamental, the Advanced Fluid Elements, which also underscore perfections of everything in environment energy mechanisms concomitantly evolved boundaries perfections.

Herein, declared science of the Milankovich cycles, cosmological gravitational dynamics and the deep core borings impurities data concomitantly disclose prima facie credibility that the prior science and art imperil global citizenry. Undefined structure and mode of failure adjoin the First, Second Law in absentia. Flaws of such science transfer fundamental science structure mechanics from said assorted and delusional sciences mixture into counterproductive global energy policies.

By the Uniformitarianism Theory, Earth's energy budget 5% to 6% imbalance balancing continues thru the Pleistocene, the Holocene Epoch. Therein, the energy relativity structures, the troposphere, tropopause, energy actions transfer mass energy into the energy relativity structures of the stratosphere, which at obliquity 41 ka dominant frequency outflows plasma to space, which may start to occur at precession 21 ka frequency, also. All the energy relativity structures, energy actions mass energy lost to space to date is absent in the prior art Earth's energy budget. The Air Cells Jet Streams cycling energy losses concomitantly raises impurities content in the light fluids cycling nullities, eventually reside in epigene soil deposits, out of the energy relativity structures.

Each of the four doomsday scenarios failure mechanism has propensity to migrate into any of the other three. The insolation energy Magnification inside the energy relativity structures yields continual energy outflows, which, in turn, concomitantly spawns global air warming phenomena; the energy relativity structures cycled energy outflows concomitantly advance the failure modes. In most scenarios, cosmological global gravitational dynamics spawns the EESD in environment energy, which, in turn, yields the energy relativity structures environment energy outflow cycles.

Milankovich cycles flux the ultra-longevity boundaries the minimum energy balancing which fluxes and evolves nigh boundaries perfections, yielding the tropopause, troposphere and epigene surface respective boundaries structure. In balancing imbalances, the EESD, the MEHC absolute energy conservation spawns an energy relativity structures energy fluxing boundaries structure to the MEHC absolute conservation to the minimum energy balancing, plasma outflows energy and epigene evolutions; boundaries perfections do the minimum energy balancing, the EESD, MEHC and epigene surfaces flux, precession, and eccentric obliquity outflow plasma needed frequencies to balance the energy relativity structures, the light fluids, cycling energy boundaries perfections.

Milankovich cycles defines environment insolation energy, affirmed by the deep core borings impurities concentration. Milankovich cycles show cycling energy primarily embracing the light fluids cycling energy cycles, by mass volume of over 99%, effecting the Air Cell, the Jet Streams cycling energy cycling mass volume 100%. The prior science compounds bungling fundamental sciences energy transfer structure mechanics to substitute 400 ppm CO₂ concentration energy for the Air Cell, Jet Streams energy, thus, to effect “clean, renewable energy” global energy policies.

Thus, wind turbine, solar panel devices “clean, renewable energy”, in fact, advance global air warming by converting irreplaceable cycling energy which sustain the Air Cells, Jet Streams, the energy relativity structures energy cycling troposphere, tropopause fluid into electrical energy for general consumption. Said structures sustain the stratosphere energy relativity structures, which, in turn, sustains the global gravitational and magnetic fields relative strengths, mass, and energy.

The wind turbine, solar panel devices squander the light fluids cycling nullities energy of depositing suspended impurities concentration into epigene sediments, thus, bolstering impurities concentration, which includes environment very powerful greenhouses gases, methane and water vapor. Thereby, overall, these devices boost the cycling nullities' CO₂ concentration constituting CO2 in environment, as well, affecting in part recent 60 ppm surprising jump to 420 ppm. Wind turbines, solar panel relative moderate 55%, low 20% respective efficiency Heat Rates block and redirect the light fluids energetic air stream. The devices syphon, redirect cycling energy cycling nullities which lower relative impurities concentration and temperatures. The Uniformitarianism Theory, the MEHC absolute perfections affirm it; these devices force not oppose climate change.

Energy directionalities, atmosphere proximities to energy sinks embody insolation energy Magnification-One thru Thirteen in the intermediary gravitational sinks, spawning the doomsday scenarios three directionalities and three diametric directions: fluids global precipitations, plasma outflowing two cusps to cosmological sinks, three directionalities. The three diametric directions embody the EESD of the relativity energy, cosmological global gravitational dynamics inside the energy relativity structures, enormously affecting the Earth's climate. Wind turbine, solar panels proximate energy sink maximally obstruct the light fluids, radiations energy Earth's gravitational sink flows. Obstructed insolation energy directionalities to energy sink maximally retain energy.

Air Cells' energy dominates environment proximate Earth's gravitational sink. Wind turbine and solar panel devices obstruct, reflect and deflect Air Cells energy from inflowing energy sink, in part, traceable and shown, by most recent 60 ppm, CO₂ concentration jump. Insolation energy asymmetrical, violent precipitations distribution frequency and polar vortex cycling eccentrically to geographic poles, into Temperate Zone climate, reveal imbalances in Air Cells energy cycling. Wind turbines, solar panels dismantling are warranted, which, thus, avoids such climate changes.

In time domain, impurities concentration in the deep core borings shows structure similarities which affirm all individual and concomitant impurities concentration effected energy by the light fluids, which, in turn, is energy spawning concomitant evolving epigene surfaces while spawning boundaries perfections. Energy cycling towards boundaries perfections is energy which modifies tropopause, troposphere towards boundaries perfections concomitantly evolves epigene surfaces, the magnetosphere boundaries, also. The core borings impurities concentration concomitant flux discloses fluxing of the light fluids energy by Milankovich cycles energy cycling in environment.

Concomitantly, Milankovich cycles insolation with epigene impurities concentration embody relative insolation energy action, epigene surfaces reaction, effecting prima facie credibility facts shown tropopause, troposphere and magnetosphere integrity relative strengths are weakening. In Pleistocene Epoch, boundaries perfections do effectuate plasmas outflows two threshold types of plasmas outflow that rebalances energy outflows and relative integrity of boundaries perfections.

The Early Pleistocene Epoch first threshold type, erupting by bursting pressures, engenders a concentration impurities sharp peak, reaffirmed all-time highs following impurities concentration reaffirmed all-time laws. Second threshold types, the late Pleistocene Epoch contrasting outflow of plasmas outflowing appears that give false impression of obliquity beat or beats skip, whereby plasmas outflowing moderate pressures threshold fluxes impurities concentration, which stays in a relative fluxing range. Threshold types disclose the troposphere, tropopause spawning, cycling energy fluxing pressures with boundaries perfections integrity retained 14.7 psi relative pressure, in fact, disclosing cosmological gravitational dynamics compression depression relative pressure.

In science technologies, principles and methodologies cycling energy concomitant structures affirm these applied sciences and technologies and the First, Second Law confirming the Air Cell cycling the light fluids as the EESD in environment energy. Quantal quanta comprising quantum mass of the nullities nullity of epigene and tropopause, troposphere and magnetosphere spawning boundaries perfections of relative boundaries effectuate a respective structure methodologies and principles relative analogies. The First, Second Laws energy of deformation and volume change, therein, effectuate said Magnification factors, where fluids associate with boundaries perfections.

Global air warming boosts concomitantly evaporation rates, violent asymmetrical distribution precipitations frequency, with geographical areas flooding, central continental areas groundwater low levels, and drying up in general. All these associates with Air Cells cycling rates slowdown, which, in turn, associates with high impurities concentration in air Magnification factors yielding global air warming Earth's insolation energy comprising the EESD in environment. Fortunately, the Earth effects plasma outflows unique concomitant rebalances of boundaries perfections of the magnetosphere and tropopause, the troposphere boundaries and epigene surfaces. Unfortunately, Earth has lost enormous air mass energy, which now comprises 6 to 16 km in overall depth, only.

In space, Heat Rate 100% efficiency energy cycles rule. The absolute technologies, the PMII the FEIIPMII technologies, continue in part the prior application technologies claim; the absolute technologies of cosmological global gravitational dynamics spawn the ultra-longevity boundaries of the super plant, with epigene surface cycling the light fluids energy within the magnetosphere, engender 100% or greater Heat Rate efficiencies, which oppose global air warming phenomenon.

The PMII and the FEIIPMII technologies embody cosmological global gravitational dynamics, the MEHC absolute conserving, the 100% or greater Heat Rate efficiency energy cycling and the nullities' sums cycling energy and the ultra-longevity boundaries of the magnetosphere, the light fluids. Heat Rate 100% or greater efficiency spawns the light fluids cycling concomitant thermal energy transfers by gravity flowing the aqueducts length portion prior to inflowing the condenser units, thru the condenser units and the aqueducts length entire remaining portion by cosmological global gravitation dynamics and insolation energy forcing evaporation, condensation. All which, including electrical power generation, comprise useful energy affecting boundaries perfections of respective epigene surfaces, wherein the tropopause, troposphere boundaries energy transferring, the aqueduct length provided precludes a potential plasma outflowing. When fusion with fission balances nuclear power energy generation respective energy cycling effects nigh eternal cycling.

The 100% or greater Heat Rate efficiency cycling shows Magnification factors energy power inside boundaries perfections cycling the light fluids and electrons, yielding the nullities sum's in omnipresent cycling, which comprise energy inside energy fields concomitantly but successively exchanging mass energy and radiation energy transfers, climate changes cycling. And, the super plant, Regions 1-5 do exactly that. All that affirms, declaims science behind Milankovich cycles, a stunning difference in global technologies bulk power plants Heat Rate around 35%, in general. The light fluids flowing energy highest Heat Rate efficiencies effectuate the global, cosmological gravitational dynamics partial portions energy redirections of the mega bulk power directionality, effectuating means for electrical power generating, the mega bulk power energy cycling synergy.

The electromagnetic transducers power input comprising the minimum energy balancing, the minimum displacement energy maximize the light fluids cycling, the bulk power transfer highest Heat Rate efficiencies and effectuate the ultra-longevity boundaries of the ultra-transport system.

The electromagnetic transducers are devices grounded by the Regions 3, Regions 5 a network site interconnected grounding grid grounded all super plant mechanical and electrical equipment. The Electromagnetic transducers warrant the super plant safety equipment rating that qualifies by construction and maintenance. However, the super plant, ultimate longevities plant qualifying its components, thus, derives maximal unprecedented Heat Rate efficiency benefits. In a power loss accident, the minimal energy displacements relegate Regions 3 displacements energy to the prior art status, where the electromagnetic fluids fixed volume, viscosity spawns a beneficial damping.

In the prior Theories of the Universe mass energy dynamics huge, most stunning oversight in evolution and/or creation of boundaries perfections existence is sustained by technologies, which comprise the Advanced and the fundamental Fluid Elements as well as the atoms. After-all, flow and spin and/or displacement of electrons is atomic energy inside boundary, flowing every which way, complying with laws of conservation of mass energy and the Laws of the Thermodynamics.

In the Universe, mass energy reverberates and cycles, to evolve into nullities by energy of deformation and volume change in boundaries perfections, clustering the Fluid Elements and the Advanced Processors and all which comprises cosmological gravitational dynamics, the EESD in environment. The prior Theories, the prior art misally apparent unavoidable sciences the Second Law solutions to global air warming may balance energy cycling dynamics of the Earth's gravity field. Fundamental energy devices stunning, low Heat Rate efficiency is licensable; whereas, the Super Plant, the sui generis boundaries perfections energy devices cycled energy dynamics claim solely the Heat Rate 100% efficiency that may include a crucial coupling of energy devices, also.

No prior device cycles nullities' interactions, cosmological global gravitational dynamics and boundaries perfections in concert. Regions 1 thru 5 do it and the Super Plant does precisely such global energy dynamics cycling nullities of the Universe Energy structure according to the Laws of Thermodynamics and the MEHC, the FEIIPMII and the PMII technologies, which universally affect maximal Heat Rates efficiency cycling potential energy of the Earth's gravity field energy. Wherein, the absolute technologies do continuc in part the FEIIPMII and the PMII technologies.

Ultimately Heat Rate of the super plant accounts for gravitational field useful energy to cycle cooling water evaporation/condensation and underground aqueducts lengths even when the super plant is refueling. Heat Rates fluctuation quantified on calendar year time periods is appropriate. Heat Rate computing inside boundaries perfections comprises that Heat Rate efficiencies fluxing engendering boundaries perfection. In that instance, such Heat Rate pertains to energy budget of the tropopause, troposphere. All of which plasma energy outflowing to space ultimately govern.

Global air temperature rise forces the light fluids mass energy cycles to distend boundaries of boundaries perfections with insulation energy the Magnification factors slowing the gravitational sink cycling rates. The light fluids, plasmas escape to space restore cycling rates, boundaries and global air temperatures and sums up global air warming, Milankovich cycles fluxing phenomena.

The underground aqueducts cycle the light fluids inflowing gravitational sink, boost all fluids cycling rates, spread and disperse precipitations, engendering useful energy to entirety; that sums up principles of Heat Rate 100% efficiencies, Heat Rate efficiencies, and boundaries perfections.

The prior art energy outflow adverse directionalities from epigene surface into atmosphere by epigene surface atmosphere an intermediation. Atmospheric precipitations, the plasma fountains affect the energy directionalities to respective global, cosmological sink. The prior art, the prior Theories imperil life by a conscientious disregard of cosmological global gravitational dynamics.

The Earth's gravitational sink outflowing energy that cools the mantle affects life on epigene, in glacial periods preserving life dormancies, while during interglacial periods it dries up epigene interior land masses. The EESD escaping, radiating, irradiating energy into space forces all of it, by energy dynamics cycling the nullities' sums in atmospheric environment propagate the EESD, bound by the magiictusphere boundaries, epigene surfaces, comprising the global climate system.

Wind turbines, solar panels technologies syphon energy form global nullities' cycling energy of the EESD in environment energy, spawn the energy directionalities adverse global cycling and climate associated causal effects imbalance. Globally air rising temperatures embody the EESD in environment cycling energy nullities, comprising cycling mass and energy densities within the magnetosphere and epigene boundaries perfections. Cosmological global gravitational dynamics balance enormous energies of the energy directionalities, energy of distortion and volume change by climatic, volcanic, tectonic events and asymmetric distributions precipitation volumes change.

Cycling AGW CO₂ emissions, a small fraction that exceeds 0.04% of CO₂ in the atmosphere, cycles within the light fluids mass energy cycling and inside hydrosphere vapors boundary in the atmosphere. Around 0.03% of CO₂ cycling inside the hydrosphere is sustaining life environment on Earth. Even 0.01% variances in CO₂ budge in the atmosphere discloses the light fluids, water vapors inadequate cycling rates in the tropopause, troposphere and the hydrosphere, respectively.

In invoking electrical energy analogies, energy flowing dynamics reveal that solar panels and wind turbines in atmosphere's energy dynamics spawn dislocating directionalities, disconnecting radiation respective effects comprising discontinuities, open circuits in cycling radiations and the light fluids cycling loops. Wind turbine, solar panel devices devour the Air Cells cycling energy, in turn, effecting Heat Rates moderate and law efficiency energy conversions. While their power generation makes no particulates emission, that spawns generation energy directionalities cycling against the Earth's gravitation sink, favoring cosmological energy sinks, the magnetic field cusps directionality. Purging power grid systems of such energy power generation is highly warranted.

The light fluids cycling nullities mass and energy sums dominates global nullities cycling energy and concomitant climate change. Historical geology, the Uniformity Theory show energy in the nullities' sums effect the Air Cells impurities concentration. Earth's glaciation prima facie credibility, where Milankovich cycles reveal, cosmological global gravitational dynamics forcing the Earth's climate system changes, affected CO₂, impurities concentration spawned changes and concomitant glaciation cycles, evolving epigene surfaces, and, in turn, the Magnification factors.

And, in glaciation history, cognitive glances at the climate system reveals that vapors buildup in the atmosphere is accompanied by CO₂ buildup, during glacial or interglacial period. Climatic events unbalancing energy and plasma outflowing release unsymmetrical, energetic distributions huge precipitations, the light fluids unbalance released energy radiations into space, respectively.

The unsymmetrical distributions huge precipitations maximally precipitated water vapors from the troposphere, tropopause maximally drop global temperature, maximally drop impurities concentration, air transferred concentration portions, into Earth's gravity field sink; cosmological global gravitational dynamics, Earth's gravitational sink, the mega bulk power cycles effect it all.

The deep core borings continuous sampling thru epigene surface 2 million years of ice, soil-rock layers deposits during the Pleistocene, Holocene Epochs comprise the early Pleistocene Epoch, taken from 2 to 1 million years ago, shown Milankovich cycles uncannily cycling at 41 ka obliquity dominant frequency, except for the beat skip 1.2 million years ago. Supra explains that beat skip and subsequent repeated beat skip appearance in the late Pleistocene, Holocene Epochs.

Balancing it all in environment, the EESD, and plasma outflowing and the unsymmetrical distributions huge precipitations do balancing the relativity energy, the relativity energy field, the energy relativity structures to affect, comprise Uniformitarianism Theory boundaries perfections.

The light fluids to space losses confirm the atmosphere spawns the intermediary gravitational sinks by proximities and directionalities to energy sinks. The Uniformitarianism Theory beyond a doubt affirms energy of the EESD cycling climate change with CO₂ energy levels as byproduct.

The Universe comes is three dimensional directionalities spider web that generates and yields in boundaries perfections gravitational sinks spherical and globose bodies at each web node. The prior sciences with prior art overlook misplace cosmological gravitational dynamics, which come with the Universe as a mason architect to configure, shape and balance everything to accuracy of quantum energy by spawning the MEHC naturally and innately and always, which spawns paths, directionalities in direction of least energy resistance. Whereas the stars' nuclear reactions origin dates to the Big Bang, nexuses of cycling nullities mass and energy date to origin of gravitational sinks, respectively. Wherein, cosmological gravitational dynamics embody and impose all of the present evolving appearance of the Universe comprising the Uniformity Theory, which embodies Milankovich cycles. The ultra-transport system engenders the absolute technologies set forth and delineate by cosmological gravitational dynamics to mass energy same eternal longevity cycling.

Milankovich cycles reveals likewise—cosmological and global gravitational dynamics cannot retain boundaries perfections of the magnetosphere. Consequently, global air warming occurs as energy accumulates in boundaries perfections, until energy blow-off occurs that fully resets all of cosmological global gravitational dynamics. In fact, Milankovich cycles confirm and the Theory of Uniformity affirms it, the atmosphere cannot yield CO₂ concentration cycled energy dynamics that engenders environment temperatures and stunningly affects eternal boundaries perfections of the magnetosphere. But opposite holds true, cosmological gravitational dynamics effectuates the EESD overall energy, the light fluids global temperatures and CO₂ concentration in environment.

The light fluids nigh mass energy densities balance, cosmological global energy dynamics, and the nullities' sums embody boundaries perfections of the magnetosphere boundaries, seem to occur. In fact, such is not the case; the magnetosphere boundaries violent, continuous, enormous fluxing, stunning deformations energy shown stunning power is the case, which in no way a CO₂ presence can affect. These facts disclose the prior, the IPCC sciences engender grave oversights.

The atmosphere suspends oxygen in nitrogen and including ions of both in bobbles inside the magnetosphere boundaries. Nitrogen and oxygen bobbles jointly and in common suspends water vapors, all of which jointly and in common suspend CO₂ gases. Atmosphere constituents jointly, and in common, effect thermal energy gradients in the atmosphere. By definitions, cycling fluids cycling directionalities and energy gradients are mutually orthogonal. Energy gradients embody thermal and pressure gradients orthogonal to cycling directionalities. Celestial bodies yield mass energy cycling nullities energy gradients and directionalities from energy sources to gravitational sinks. The Earth is entirely mass energy device. The Uniformitarianism Theory affirms the light fluids cycling compositions content that effects concomitant cycling energy chronic unbalancing, which cycling the compositions content temperatures spawns the glacial, the interglacial periods.

Aforesaid points at glaciation history, energy cycling the nullities' sums and inadequate rates of cycling, specifically by the light fluids nitrogen, including water vapor, and hydrogen, oxygen, affecting global air warming that accrues vapors and various gases small amounts including CO₂. High CO₂ concentrations is the light fluids inadequate cycling energy “canaries in a mine” effect.

Solar panels power generation siphoning solar energy naturally directed toward warming the mantle actually ends up warming the atmosphere, an unintended compliment by the Second Law. Wind turbines siphon most, not all, energy portion cycling locality air, which siphons short loops cycling energy and, in turn, adversely affecting long cycling loops energy, yielding condensation which precipitate most impurities concentration comprising vapors, CO compounds, all which, in turn, radiates radiation to space. The attempted unthinkable competing with cosmological global gravitational dynamics, by energy subpart Heat Rate efficiency devices, in turn, further warms the atmosphere by the First and Second Law and the Theory of Uniformity unintended compliments.

Entirely and comprehensively setting forth quantum mass and energy comprising boundaries perfections of the atomic elements and said fundamental and the Advanced Fluid Elements in the Universe affirms fundamental Laws sciences disclosed technologies in these applications, which, likewise, unmask the prior sciences and art deeply flawed highly counterproductive technologies.

An idling air mass bulb enlarged volume attaining altitude proximate the hydrosphere highest elevations disperses under very strong lasting air currents, only. Air bulb enlarging idled volume unrestricted enlarging by gravitational field force at high elevations segregates by density and air impurities concentration, which effects mass energy volume mechanisms, eventual disconnecting of magnetic lines by mass energy persistent blow off by plasma outflowing into space outflows.

Earth's gravitation is not in absolute possessions of its light fluids. Siphoning of solar energy from the Earth's gravitational sink, magnetic field energy must, also, spawn climate changes that permanently attenuate energy cycling in both energy fields stipulated by the Second Law, which, in turn, permanently attenuate both energy fields. Theory of Uniformity energy—the atmosphere energy—cosmological gravitational dynamics cycling energy evolves the Earth life energy forms, life uniformitarianism energy cycling and energy fluxing, the prior sciences art and cosmological global gravitational dynamics profound stunning omissions, gets lost in CO₂ low emissions hype.

Cosmological global gravitational dynamics effectuate the light fluids idled opened loops and closed loops cycling and impurities concentration and water vapor condensate transported energy into Earth's gravitational sink. Open idling loops flux idles air mass bulbs whose volume grows, distends into cycling energy closed boundaries to block, reflect the light fluids cycling, spawning the idling air mass bulbs air volume trapping entire locality impurities concentration that idles, or strays from cycling loops. The idling air mass bulbs isolated volume mass, retains radiations and irradiations energy large portion, which insolation energy further heats up and distends enlarging its volume, especially into elevated altitudes, yielding mass volumes that further slow air cycling. And, such is very similar energy in environment wind turbines, solar panels mechanically spawn.

The light fluids hemispheric idling of a stagnant energy mass may affect cosmological global gravitational dynamics outermost magnetic lines disconnect or cusps an outflow, wherein cosmic radiation wind pressures blow off the ionosphere mass and energy idling portions and rebalances effects of plasmas blown off to space. Concomitantly, cycling nullities boost cycling rates which optimize precipitation of water vapor and impurities concentration rates, as the deep core borings of ice, soil deposits show. Cycled rates boost lowers the Magnification factors, insolation energy in the EESD in Earth Advanced Processor, the energy relativity structures and the ultra-longevity boundaries, the tropopause, troposphere, magnetosphere and epigene boundaries nigh perfection.

Universe mass energy down to molecules and atoms innate energy quantum cycling electrons evolve boundaries perfections by continual testing presence of the ultra-longevity boundaries and the MEHC proven by atoms and molecules, which invariably evolve the Advanced Processor. In mass and energy cycling nullities to quantum accuracies any and all paralysis, comprising idling, engendering energy with mass cycling directionalities of nullities, embodying the MEHC and the Advanced Processor, Earth's magnetosphere, must without fail evolve the boundaries perfection. The magnetosphere boundaries adverse directionalities energy cycling flux bolsters cycling rates alternate directionalities evolving the MEHC. If the MEHC fails, boundaries perfections do fail.

And, that is what Milankovich cycles really show. In each instance thru billions of years, the Earth's mass and energy gravitational dynamics response to cosmological gravitational dynamics mass energy fail to yield the MEHC of the atmosphere and, in turn, fail boundaries perfections of the magnetosphere. Cycling nullities energy balances unbalances is root causal effect of all it all.

It may appear that the Universe eternal balancing with unbalancing of boundaries perfections mass energy lacks ultimate purpose, which, of course, is not the case. Milankovich cycles shows the magnetosphere cycled nullities engender boundaries perfections cycling into nullities failures which glaciers, the polar caps ice, the deep core borings, impurities concentration deposits affirm concomitantly, respectively. The light fluids' cycling energy cycles the glaciers, polar caps mass volume respective energy in gravitational sink, also, effecting soil, ice constituents mass volume.

That energy dwarfs air impurities concentration energy. Gravitational sink cycled energy yields the mega bulk power, the deep core borings soil, ice deposit volume. That energy, cycling the nullities' sums of gravitational sink, effects plasma energy losses to cosmological sinks, also.

Likewise, Milankovich cycles incontrovertible prima facie credibility show cosmological and global gravitational dynamics in the Earth's gravity field sink, fluid volume, and energy cycle the nullities' sums and energy, pressure and volume in boundaries perfections of the magnetosphere. The nullities' sums fluid magnetic lines disposition enormous flux sustains atmospheric pressure at sea level of 14.7 psi, affecting mass energy volumes in boundaries perfections. Deforming the magnetosphere boundaries magnetic lines disposition to mass and energy balances comprises the MEHC and mass and energy absolutely conservation, or outermost magnetic lines do disconnect.

In fact, Milankovich cycles shows CO₂ is a contributor to mass and energy and definitely not the root cause of global are warming, “greenhouse effect”. Furthermore, Milankovich cycles prove beyond reasonable doubt comprising prima facie credibility, CO₂ emissions cuts may help, but yield zero chance of success. The ice cores data reveal that at any CO₂ concentrations, which includes concentrations needed to support life, global air temperatures unavoidably show a rising trend. In geological past, the Earth's gravitational sink stunningly optimal attempts at the MEHC self-conserving consistently fail; numerous glaciation periods and several shifts in dispositions of the magnetic field are shown not to work. All mass energy balancing perturbations in the Earth's gravitational sink binds the atmosphere's mass and energy in boundaries perfections by the ultra-longevity boundaries of the intermediary gravitational sinks also generates balancing imbalances.

Mass energy perturbations affecting the atmosphere rising temperatures imbalance trends embody mass part with energy part varying inside participating precipitation by mass and energy cycles, all of which affect continuous imbalances for 4.5 billion years. Of course, the root causal effects comprise the energy directionalities difficult, also destructive, turbulent mass energy nigh balancing in the Earth gravitational sink and magnetic field, which violate boundaries perfections of the magnetosphere and epigene boundaries. CO₂ concentrations 0.02% to 0.04% by molecular density mass volume directionalities to epigene surface of gravitational sink only follow the light fluids cycling energy. All which relegate CO₂ concentration energy as a global air warming root cause. Energy cycling aforesaid cycling directionalities, energy gradients comprise the EESD, in environment energy, are rising air temperatures root causal effects, assisted thru several centuries of the prior sciences art; that art has: a) on average energy devices Heat Rate of less than 27%, b) the atmosphere as integral part of the Earth's gravitational sink. Aforesaid concurrently establish the atmosphere unique, exclusive nigh perfections of the intermediary gravitational sinks cycling mass energy in environment spawning the magnetic field. Aforesaid reveal the Universe cycling mass and energy by mean machine Heat Rates, 100% efficiency. Cycling unlimited mass energy which cycles the light fluids radiations and radiations wind pressures, inside time longevities, the Universe balances, modifies and eradicates anything cycling energy at less than 100% efficiency.

Universe balancing mass energy down to the light fluids quantum energy lowers potential energy of everything cycling analogous to a skater in a spin pulling the extremities into his body. Perpetual mass and energy to and from gravitational mass energy sinks within frictionless cycled environment yields limitless energy to balance mass energy cycling into absolutely low potential.

The celestial mass energy bodies and energy cycling nullities in cosmic space comprising cosmological gravitational dynamics requires an affirmative energy response of a nigh perfection presence toward boundaries perfections. Energy actions of cosmological gravitational dynamics within the Earth gravitational sink, the magnetosphere boundaries prompts mass energy reaction, action superimposes the EESD with mass present energy, where outflows of plasmas must occur.

Geographical regions energy action, reaction can dominate, or affect cycling the nullities' sums. Thus, the EESD in environment energy may yield energy action, energy reaction or a sum of superimposing energy. Milankovich cycles disclose that invariably thru 41 ka intervals energy reaction exceeds energy actions, forcing the magnetic field lines individual or group disconnects, and associated plasmas mass outflow, which cosmological global gravitational dynamics impose.

Both, wind turbine and solar panel technologies, generating “renewable”, “clean” electric power, conceal deep, profound ramifications which imperil the human race. Such devices utilize gravitational field energy reaction spawning perfections of the magnetosphere boundaries. Force of energy action and cosmological gravitational dynamics, omnipresent on, in the magnetosphere boundaries, enforce energy of volume changes and distortion in these boundaries, penetrating the atmosphere. Most forces of energy action act unavoidably on gravitational sink, epigene surface. Said energy devices energy transfers effect adverse energy cycles directionalities in environment.

Cycling directionalities in environment energy transport, transfer spawn the MEHC, Heat Rate 100% efficiency. Wind turbines, solar panels bulk electrical energy generation respectively effect moderate to low Heat Rates which effect intellectual technological bungling. Environment cycling of energy transfers of reaction by the gravitational sink should greatly overwhelm, pacify energy of action in geographical regions. At elevations within the hydrosphere vapors' boundary energy cycling and fluxing reaction, action affect nigh equilibrium. Bulk energy syphoning from hydrosphere environment by wind turbines, solar panels is outright, exactly wrong action to take.

Boundaries perfections in atoms, the Fluid Elements, also, the Advanced Processors, celestial entities, engender the ultimate longevity of boundaries perfections, cycling energy of the PPLLS, spawning the EESD respective environment. These effectuate the MEHC absolute conserving in the light fluids evolving energy genres of boundaries perfections which the super plant promotes.

The ultra-transport system nigh infinitesimal, incremental displacements and flowing the light fluids self-conserving genres, which self-configuring boundaries perfections of dispositions and alignment of high energy piping symmetric configurations fully erect wind cones exemplify. Relatively short piping length portions between mechanical devices effect length portions free of inflow/outflow end flow effects, yet flow the light fluids flow orders of magnitude greater energy than a transverse direction energy sums, which include gravitational force effects. Any quantum, especially an electron, engendering eternal boundary affecting boundaries perfections of the light fluids mass energy, effecting the light fluids fluxing, cycling mass energy genres, comprising the ultra-longevity boundaries spawning eternal cycling dynamics occupy GODPARTICLES spaces. The applied science eternal perfection boundaries disclose GODPARTICLES summary motions.

Presence of the mass energy self-structuring genres is apparent in the wind cones which show wind direction and magnitude. The energy self-structuring genres of the light fluids, the absolute technologies, the super plant (SP) effect by the electromagnetic fluids nigh infinitesimal creep, in small total movement associated with optimal stiffness that configures the ultra-transport system.

The mass energy absolutely highest conservation, a conduit First Fluid Element cross-section flowing high energy uniform homogeneous fluid embodies the high energy piping entirely round optimally straight lengths free of an elbow, an inflow or an outflow end flow effect. Said effects, especially elbow flowing effects embody transport system flows in major mechanical equipment, the reactor, the SGs, and the turbine. The ultra-transport system deviating dispositions perfection is minor and balanced by two high pressure pumps at each of the SG, one in each cold leg return.

The super plant (SP), the Second Law energy directionalities discerned, placates the EESD in environment, cycling the light fluids heat energy portions of condensations radiating to space and condensates heat energy portions radiating into the gravitational sink, by cycling the condensates and the condenser units thermal energy release into the condensates cycling the aqueduct lengths.

The First Fluid Element underground aqueducts cross-section lengths effectuate cycling energies maximum conductance which cycles the EESD in environment cycling rates to atone for thermal energy differences in groundwater cycling epigene crust and the light fluids surface water runoff evaporations with condensations, precipitations cooling epigene crust fluids. The thermal energy difference, in time reduced differences raises energy of the gravitational sink and magnetic fields to resist the plasma fountains outflow, which provides time for radiating thermal energy to space.

Cosmological global gravitational dynamics within gravitational sink and the light fluids cycling underground aqueducts comprising the absolute technologies spawn evaporations, condensations in the atmosphere sole technologies for opposing global air warming changed climate. Likewise, reveal energy devices that assist, only; do not impose cosmological gravitational dynamics of the EESD in environment, which either evolves, balances, or bolsters the ultra-longevity boundaries; the condensates contain precipitated dissolved atmospheric gases and flow decidedly in direction of stronger gravitational sink and magnetic field dominances over the atmosphere's mass energy.

Glacial history, interglacial periods positively point to lack of sufficient condensations which radiates the EESD in environment thermal energy into space. Mainly in 41 ka cycles, a portion of atmosphere blows-off. Belatedly, the condensates follow, lower environment temperatures yield vapors condensate more diatomic thermally cool atmosphere spawned a glaciation period. In the last 2.8 million years, such occur, affirmed by the deep core borings thru soil ice deposits. While evaporations and condensations, atmospheric presence of triatomic and multi-atomic gases, yield the EESD in environment, where the Magnification factors further magnifies rising temperatures.

Furthermore, aforesaid provide insight how the Mars lost its light fluids, and how balances of cycling nullities separate the light fluids from planetary bodies by cosmological and gravitational sinks dynamics which by means of the EESD precludes idling of the light fluids, unless sustained in ice phases state, while budget of CO₂ concentrations, which cycle thru geologic times, remains constant. Of course, cosmological configuration of mass, distance separations, orbital plane and inclination, planetary precession and invariable plane amongst others spawn macro cosmological effects beyond control, but energy cycling in gravitational field is not. However, the accuracy of that cycling is to quantum energy, which, thus, includes CO₂ concentrations as secondary effects.

Cycling of CO₂ mass and energy nullities in the atmosphere comprise much smaller mass and energy bulb than cycling water vapor mass and energy bulbs which, in turn, is much smaller than constituted by nitrogen, oxygen and, of course, the ionosphere such bulbs. All aforesaid nullities cycle within mass and volume energy respective mass energy bulbs causing nitrogen and oxygen volumes which do changed, which historically points to cycling nitrogen and oxygen reoccurring issues in cycling nullities of water vapor mass and energy bulb inside or in oxygen, inside, within nitrogen mass energy, respectively. Earth's energy cycles has no AGS reoccurring history, while CO₂ mass arid energy cycling relative concentrations, in ppm, are repeating in glaciation periods.

Unavoidably, temperature variations during the glaciation periods are mass energy effects spawned changes inside mass and cncrgy bulbs engendering the EESD in environment energy of cosmological gravitational dynamics and the global gravitational dynamics, which engenders the climate system fluxing ppm—compositions energy cycling nullities global cycling nullities' sums.

Actually, historically reoccurring causal effects of rising CO₂ levels in environment is the Earth's gravitational field affecting global dynamics of the EESD in environment that responding to cosmological gravitational dynamics affect boundaries perfections imbalances cycling nullities cycling inside the magnetosphere boundaries. Cycling energy of oxygen bulbs in nitrogen bulbs, in turn, effects inadequate energy cycling rates in water vapor bulbs, which, in turn, is inadequate cycling energy cycling rates in CO₂ bulbs. Wherein CO₂ presence in air is slowing down cycling rates by increasing air temperatures, which, in turn, increases volume and, thus, mass comprising respective bulbs of the climate system cycling air mass towards the three directionalities and heat energy gravitational sinks, which are one and the same mass energy. Or, vice versa, cycling CO₂ mass cycles in relationships to cycling water vapor, oxygen and nitrogen, in the climate system's respective bulbs of fluxing mass and energy, whose volume the gravitational and magnetic fields restrict. In time domain, the climate system blow-off into space the light fluids enormous mass.

The ultra-transport system ultra-conserves the bulk power. The super plant pressurized water reactor ultra-conserves the light fluids mass and energy in the Regions 1-5 effectuates boundaries perfections clustering and the MEHC, the light fluids causing optimally lightest pressures toward boundaries perfections outermost limit, as the magnetosphere meliorates equipment deviations or nonconformance which saps energy of the ultra-transport system affected boundaries perfections.

The Super Plant affects HVAC the light fluids optimal low pressure optimally low energy cycling in Regions 3 ultra-longevity boundaries. Condensation optimally moderated temperature of aqueduct cooling fluid flow prior to outflowing on epigene surface emits marginal water vapor plume of energy to boost the ultra-longevity boundaries of the troposphere, tropopause; however, the troposphere, tropopause, the magnetosphere and epigene surface rebound mass cycled energy maximally conserved energy upon an impact of a boundary of boundaries perfections. Regions 3 emit energy to utilize boundaries perfections of the underground aqueducts and epigene surfaces.

The aqueducts grant strategic positioning of its outflowing fluids outflow that effects optimal evaporation, plumes of water vapors, which, in turn, effects subsequent, steady, optimal intervals of uniform precipitation distributing. Such evaporation and precipitation distributing, assisted by cosmological global gravitational dynamics, is useful energy producing the super plant Heat Rate above 100% efficiency, especially dunng periods of refueling and low electrical energy demand, troposphere, tropopause boundaries spawn. The uniform distributing precipitation boosts fluid's cycling rates, within boundaries perfections of the tropopause, troposphere, and epigene surfaces.

Cosmological global gravitational dynamics balancing unbalances by energy in precipitations fluxing cycling rates boost the super plant useful energy transfers, which, further, boosts the Heat Rate above 100% efficiency which the MEHC, with cosmological global gravitational dynamics, impose as the EESD environment energy. The useful energy transfers, affected in the tropopause, troposphere energy actions affect useful energy reactions inside the magnetosphere boundaries to the EESD, cosmological global gravitational dynamics, to magnify the super plant useful energy.

Comprising the Heat Rate maximum efficiencies most beneficial energy transferring, comprising beneficial energy transferring affecting the troposphere, tropopause, and electrical power cycling electrons perpetual fluxing at or greater than Heat Rate 100% efficiency yield the applied science and the gravity, magnetic fields energy strengths, environment conserving by GODPARTICLES

Proven heat pump technologies show preferred temperature moderating method in closed environment is by fluid air cycling rates thru a cooling source and closed environment, especially when maximal energy conserving occurs. Theoretical sciences last eight decades is with no legs.

The transducers and the electromagnetic fluids of the super plant grants base plates, bracings, wall penetrations and expansion contraction devices precise movement in the primary, secondary piping loops configuration radial, polar and vertical displacement strains' energy precise fluxing. The expansion contraction devices, expansion and contraction devices refers to the same devices.

The light fluids cycling Regions 5 accordingly, herewith, as epigene surface counterparts to the underground aqueducts and the troposphere, troposphere cycles energy in environment, comprise offshore structural decks—platform varieties, which effectuates means for supporting solar panels or photoelectric cells and means for generating and transmitting retail or bulk electrical energy as are known in the art, in turn, diminishing detrimental, locally excessive, asymmetric distributions of epigene water vapor evaporations, which complies with the FEIIPMII PMII technologies; said means include the panels or cells configuration and structural protections in environment, in turn, precluding dead zones low oxygen hypoxic areas in water column below all such construction, in turn, to permit water, vapors environment beneficial circulation effectuated by gravitational sink.

The primary, secondary piping loops of the ultra-transport system cycle the bulk power, wherein the electromagnetic fluid transducers affect Regions 3 wall penetrations, bracings and base plates radial, polar and vertical displacements with Regions 3 expansion contraction devices controlling radial, polar, vertical and radial strain displacements, with Regions 3 polar, vertical, radial strains respective displacements by the containment, the annex building cycling maximally low stresses. Wherein, expansion contraction devices is the calibrated electric input set for 2000 psi axial stress and adjusted, empirically established, above potential stress by the minimal energy displacement.

The transducer devices concomitantly configure the ultra-transport system; Regions 3 composite construction exigent radial displacements assists entire plant configuration of the electromagnetic fluid devices to absorb most displacements and cyclical loads, and elastomeric bearings to absorb most of foundation displacements in tectonic event movements. The transducers, the elastomeric bearings affect least energy of distortion, maximally sustainable structural impermeable integrity of the super plant site boundaries which includes subgrade bentonite slurry walls surrounding the site entirely safe operations which minimally dissipate energy in maximal transfers of light fluids thermal energy into bulk electrical energy and yield thermal and mechanical highest efficiencies.

Thermodynamics hydrokinetics energy highest conserving, in seismically benign locality, orients the condenser-units which orient the turbine buildings and the reactor vertical symmetry plane of respective alignment and elevation, in turn, setting forth configurations of the high energy piping loops, electromagnetic coils disposition concentric gaps about the expansion contraction devices.

The transducers effect means for sustaining the plant locked in highest Heat Rates' configuration that yield optimally friendly and beneficial operation generating electrical power in environment; in a lost power event, the transducers, the backstops flux small displacements in electromagnetic fluids confined fluid residual viscosities, and the super plant unimpaired integrity safe shutdown.

The PMII, the super plant (PMIISP) epigene proper in the magnetosphere boundaries perfections embody gravitational units' longevities and boundaries perfections to boundaries complying with dynamics of the FEIIPMII technologies, the EEDS, and epigene seismic events. The transducers seal all wall penetrations of the containment building as a gravitational unit, with any or all of the plant electromagnetic devices, engendering means to dissipate incongruous, yet sustain, retain, or lock into continual plant operating, optimal configurations and the Regions 3 compartmentalized.

Unless illustrated in a drawing and stipulated otherwise in detail description of such a drawing, a supply, return line connects each electromagnetic device with the fluid, a centralized fluid supply under pressure tank, which effects optimal fluid continuity in each device, engendering analogies with magnetosphere boundaries perfections effecting crucial improvements, power supply inputs to the fluid in each of the transducers spawns the fluid strengthened, or plasticized shear strength; including rheostats, applied precisely voltage sets the fluid bulk modulus, moduli shear strengths, according to monitored exigent boundaries' displacements at the strategic localities of structures.

Encircling the plant site, bentonite slurry walls construction thickness isolates below grade all the site fluids, abates seismic event dynamics soil structures interaction displacements and assists the containment building elastomeric bearings dynamic response, showing magnetosphere analogies. A plant site slurry walls, berms enclosed, a site drainage and flood protection is known in the art.

The ultra-transport system of the super plant comprises unique vertical plane symmetry with thermal, static and dynamic loads and displacements having that plane symmetry; the electromagnetic fluids electromagnetic devices confine displacements to that plane symmetry comprising vectors sum in, infinitesimal transverse vectors a sum to that plane, in that plane, and axial displacements expansion and contraction devices, the transducers affect displacements Heat Rate maximum efficiencies, spawning the ultra-longevity with the ultra-conserving of Regions 3.

The super plant composite construction configurations, engendering symmetrical, and/or in plane of symmetry high energy cycling displacements with ultimately configured routing embodies the transducer devices and principles, methodologies, innovations, and inventions (PMII) Maximum Principal strain theory systemic failure design methodologies, by the minimum energy balancing.

Structures, the transduceis and the fluid elastic, shear and bulk moduli fluxing stiffness by power inputs to the transducers avoid out of symmetry displacements. The cooling water gravity inflow outflow maximum conserving energy aligns the condenser units, the turbines and the super plant.

The cooling water gravity flowing effects means for flooding the annex, the primary containment building portions, in an accident event, up to the reactor vessel head, to the PMIISP set elevation, and the super plant, the PMIISP, the ultra-transport system set elevations. Entirely symmetrical, balanced configuration site of the super plant hydrodynamic energy embodies these three cooling means: underground aqueducts, cooling towers and deep wells cycling Regions 4 fluids mass and energy. Structural subgrade supports buried, high density concrete aqueducts with stainless steel liner; ultra-conserved hydrodynamics energy effects the cooling water and, in turn, engenders the subgrade maximal thermal energy radiation transferred into epigene mass; the PMIISP maximum ultimate cycling unprecedented thermal, mechanical efficiencies atone the EESD cycling epigene fluids, especially when aqueduct fluids' temperatures reverse epigene thermal energy outflowing.

The PMIISP successive boundaries gravitation unit unbounded longevities engenders boundaries perfections and buried thermal aqueducts an energy shunt device flowing, cycling the light fluids to convert fluids atmospheric energy cycling to steady uniform precipitation of dissipated energy into gravitational sink over optimally wide Regions 4 geographical areas; precipitation dissipated energy returns fluids, evaporations mass energy, back into epigene mass, which abates innate and anthropogenic global air warming by cutting down, minimizing said Magnification factors boosts of insulation energy. Such atone epigene, atmosphere fluid processes by lowering EESD effects, and simultaneously, electrical energy is generated at highest mechanical and thermal efficiencies.

Bentonite slurry wall encircles the PMIISP site and on both sides of site aqueducts, extended into impermeable stratigraphy. Said site comprises test wells and surficial means for sustaining site's groundwater level below reactor foundations, and means for disposing of that water any quantity.

Aforesaid aqueducts underground effectuate fluids energy highest conservation by the First Fluid Element sui-generis boundaries affects third circulating loop thermal energy cycling gravitational sink mass and energy comprising fluids minimal energy losses, optimal thermal energy transfer—combating innate and AGW global air warming effects. Fluid Elements technology engendering longevities and energy cycling energy loops optimal heat transfers avoid causal effects excessive evaporations, vapor emissions and detrimental processes; all these diminish magnitude of energy shortages, water scarcity, energy shortage innate and anthropogenic global warming (AGW) and abate periodic plasma outflow, the magnetic field lines periodic disconnect at shoulders of cusps, and the EESD effecting potential forbidden mechanisms, Earth's light fluids' plasma outflowing.

Essential cooling, comprising a shallow, water retention dish of stainless steel plate shell structure below grade engenders water capacity requirements, structural integrity and, also, comprises complete support for mechanical cooling towers cooling means for essential cooling during the super plant continuous essential operations in rare accidents or seismic events.

Said structure comprise stainless steel ribs, grade beams, diaphragms, and heavy traffic roadway structural subgrade construction, to withstand seismic events energy; the beams, diaphragms, and ribs comprise cutouts which facilitate conformance to laminar flow rates in all instances, verified in hydraulics laboratory; wire reinforced liner enveloped field spliced fiberglass sheets surrounds the shell as a protective cover. Gravity flow, from closest aqueducts location, keeps the dish full, comprising a rare event piping means, shutoff valves, positive controls at all pipe ends inflowing, outflowing water circulations within annex building compartments, and gravity flows flooding of the primary containment; the super plant ancillary construction and berms known in the art shield positively all such piping. The structural integrity, the subgrade effectuates means for supporting mechanical cooling towers' means for effecting the super plant's essential cooling in rare events.

the super plant comprises the primary containment a dome floor slab and hermetically sealed equipment access hatches above each of the SG; unbound longevity of the super plant requires the hatches have the primary containment polar crane full access into annex building compartments, granting means for replacing, or refurbishing the SGs through the annex building hermetic sliding doors and removable panels. Multiple hatches engenders access means for robotically removing reactor vessel parts.

The annex building embodies all of said devices; structural welds are full penetration welds. The national construction standards govern, such as: UBC, ACI, ASTM, IEEE, and ASME especially

Section III. Preferred stainless steel alloys, comprising over 10% chromium, grant embodying of magnetic properties, wherein presence of nickel inhibits stainless steel magnetic properties. Said bolt and/or stud assemblies torqued tensions are statistically verified to 100% compliance, during refueling outages; said structural insulation, a calcium silicate, trade name ZIRCAR exemplifies; materials forced thermal expansions coefficient differences in stainless steel, steel with structural insulation, and countersinks and alike gaps are sealed with a caulking, Thermeez 7030 or similar.

Super plant machinery and piping fluxing electromagnetic fluid stiffness grants low stresses very finite, very small, and prescribed movements, controlling high frequencies exigent displacements stress magnitudes in the super plant configurations having ultimately low stresses configurations. The super plane embodies energy fluid flows thru piping, equipment machinery, the containment and turbine buildings ultimate alignment configuration and orientation and elevation dispositions spawning thermal, mechanical optimal efficiencies, optimal longevities and subdivided buildings site ultimate safety. Owner elects from the prior approved art the super plant remaining portions.

Aforesaid reveals light fluids as valid and true environmentally friendly energy sources. Heavier fluids displace the light fluids which as the EESD in environment energy outflow Earth magnetic and gravitational fields, engendering the doomsday scenarios. The light fluids nuclear to thermal energy transfers cycling the bulk power in the ultra-longevity of boundaries perfections, whereby the super plant simulates in most respects a gravitational unit celestial body cycling mass energy.

The PMIISP is gravitational unit energy light fluids shunt in all these important details: plant site location, orientation and elevation with longevities and efficiencies, consistent with all of Earth's natural processes and dispositions, participate and compete in such processes against a Universal demand for the light fluids energy, by directing the light fluids into the Earth's gravitational sink, boosting magnetic, gravitation field strength, conserving water and reversing global air warming.

Regions 5 circuit boards, mother boards cycle energy according to claim 1, affect insulation thin sheets stack of mostly circular diameters of substantially rounded, stacked random concentric, or nonconcentric, each side entirely a flat surface—all stacks as a diverse page sizes book; the sheets generally embody cutout voids along with straight, nigh straight printed circuits, in both faces. A nigh flat basic circuit printed on each side of the thin sheets interconnects to a sheet above, below or above and below, or connects to any electrical component along a perimeter or on top or under a protruding sheet, a sheets stack, or sheets stacks respective sizes protruding portions or residing in a cutout void or cutout voids; the sheets embody a circuit board or a mother board configuring said electrical components and the cutout voids comprising fluid ducts; the sheets and the printed connecting fuse positively; stacking the sheets stacks the fluid ducts; innate, innate and forced, or innate, induced and forced, or innate and forced and induced a once flow thru cooling an ultimate cooling effect has the circuit board or the mother board absolute Heat Rate maximum efficiency, yielding concomitantly the ultra-conserving of electrical, the flow thru cooling respective energy; said circuit or mother board supplied power by the super plant cycles electron GODPARTICLES cycle the Heat Rate 100% efficiency, or higher; if higher, Earth's gravity infinitesimally slows its evolution—the evolution energy forcing potential plasmas fountain outflow infinitesimally slows.

The circuit board, the mother board comprising an electrical device or the printed circuit, the fluid ducts each cross section relative configurations, spacing dispositions, energy cycling the absolute technologies algorithms concomitant modeling electric current, fluid ducts thermal radiation outflows, energy flows and the printed circuits and fluid ducts parameters and cross-sections affect readily; beneficial consumed energy ratios maximum sums sum affects the circuit, the mother board and the electrical device a respective Heat Rate efficiency; common and/or transistor temperature switches turning on-off ventilation fan or fans housed in a manifold or manifolds along respective perimeters of the circuit board, the mother board, and the electrical device yields the ducts fluid flow rate relative to electrical current and affects PMII technologies.

Reiterative algorithms and parameters computing the First and Second Fluid Elements disclosing boundaries perfections respective cross-sections computing U.S. Ser. No. 13/999,105 sets forth and details; these show entirely rounded and also globose-elliptical cross-sections that fit best stacking of the sheets, spawning highly uniform, homogenous fluids, boundaries perfections born cross-sections. Cycling electrons electrical current embodies maximally uniform and homogenous flowing fluid.

Stars' outflowing radiation comprises potential energy sources energy peaks springs of energy in the relativity energy field. Plasmas flowing directionalities, according to the Second Law, reveal potential levels relative differences. Plasmas velocities magnitudes reveals potential energy level differences relative magnitude. In space, planets may spawn much smaller potential energy peak by possessing atmosphere, as the Earth does. The early Pleistocene Epoch reveals that the Earth, in 41 ka intervals regularity, outflows plasma to effectuate energy balance of its gravitational sink cycling energy to the relativity energy field balancing by cycling potential energy levels' energy.

Early Pleistocene Epoch energy cycles disclose that the minimal energy displacements surpasses the minimum energy balancing in 41 ka intervals. In turn, that reveals that the Earth overheats, as an energy device cycling energy, and, therefore, outflows energy, balancing itself to the relativity energy field potential energy preserved boundaries perfections of the tropopause and troposphere and, in turn, the magnetosphere which by enormous flux balances energy to absolute perfections.

That the Earth global gravitational sink overheats regularly reveals imperfection in cycling to the MEHC absolute conserving cosmological gravitational dynamics set reference cycling balancing the relativity energy field energy. All of which bring back Heat Rate efficiencies methodologies.

The ultra-transport system axial stress, energy, herein, 2000 psi as the minimum energy balancing is strictly arbitrary, which the minimal energy displacements should not surpass, since yield tension-compression energy cycles highly detrimental to of exigent boundaries longevity, and the minimum energy balancing set from nigh 1000 psi to nigh 2000 psi the expansion and contraction dcvices to affect the minimal energy displacements settings is preferred, to avoid tensile stresses.

The high energy piping loops hot legs embody disk stiffeners on 42 in centers, to preclude the hot legs piping spools a longitudinal splitting of the hoop stresses; the minimal energy displacements the longitudinal splitting of the piping spools precludes a guillotine, double pipe break that in the prior art necessitated isolation valves. Regulated need is the isolation valves regulatory mandate; the disk stiffeners provide for connecting pipe braces and hangers, which grants axial movement.

The circuit, the mother boards illustrate concomitant energy cycling the printed circuits, the fluid ducts ultimately straight energy conduits comprising cross-sections of boundaries perfections and maximal Heat Rate efficiencies. In turn, each board illustrates that imperfections in gravitational global sink energy cycling the underground aqueducts may overcome, provided number and their construction timely completion to achieve atmospheric sustenance of crucial, exigent boundaries.

The Holocene, late Pleistocene Epochs, Milankovich cycles illustrate the atmosphere, the energy relativity structures exigent boundaries continual weakness and plasma outflows 21 ka precession intervals, as well. In turn, the underground aqueducts respective cross-sections cycling energy in environment is entirely cycling in boundaries perfections of respective the cross-sections entirely cycled by gravitational sink and the energy relativity structures, insulation energy in environment energy, the EESD. All of such cycle above 100% Heat Rate efficiency; since there is no external energy input and granted no minor cross-sections flow supra nigh energy eternal cycling affirms.

The underground aqueducts, Heat Rate nigh eternal cycling reveals cycling energy fields tapping cosmological global gravitational dynamics omnipresent energy cycled energy into infinity. The ultra-transport system, the super plant, in turn, likewise taps into energy infinity, especially when energy cycling the underground aqueducts shaves-off the relativity energy field, potential energy peak and transfers that energy into Earth's gravitational sink, all of it qualifying as useful energy.

The underground aqueducts comprise in part energy cycling Regions 5 epigene surfaces to which gravitational field optimally connects maximally grounds the circuit board and the mother board. In the circuit, the mother board, electrons cycle inside boundaries perfections of the short printed circuit cross-sections, epigene surfaces, the energy relativity structures and the magnetosphere, to Heat Rate 100% or higher efficiency, as the light fluids cycling in Regions 4 yield useful energy.

The light fluids and cooling water cycling Regions 1-5 comprising the underground aqueducts of the super plant aqueducts, engendering several lengths in Regions comprise cross-sections of the First Fluid Element the PMII, FEIIPMII technologies, the absolute technologies, to affect a breeder device structure that breeds GODPARTICES. Wherein, inflows into said aqueducts, the aqueducts, cycle—beneficial, useful energy—embedded almost entirely in the light fluids environment cycles. The beneficial, useful energy, comprises thermal energies of conduction, radiation and convection. The aqueducts by conduction transfers portions of each of said three forms of thermal energies as one and the same energy that opposes evolving of Earth's gravity sink, comprising directionalities into rather than the past history directionalities out of the mantle. Beneficial, useful cnergy directionalities, by the three thermal energies, oppose volcanic eruption, tectonic movements and tsunami. Other directionalities, by said three thermal energies, radiate to space, air being thermal energy conduction insulator. Underground convection thermal energy being one and the same thermal energy form has the beneficial, useful energy one and the same as two of three thermal energies have, the previous explains. The light fluids upon outflow from the aqueducts and exposure to solar insolation gain convection thermal energy to evaporate and condensate water vapors to radiate thermal energy radiations to space, cycling as one and the same thermal energy in the beneficial, useful energy same cycles—global air warming avoidance. More of such cycles cycling the light fluids opposes evolving Earth's gravity sink; therein, atom, or molecule of the light fluids cycles GODPARTICLES or above the Heat Rate 100% efficiency. aqueducts underground lengths engender the EESD environment beneficial, useful energy, which boosts gravitational field strength, magnetic field strength and the light fluids cycling rate, which boost boundaries perfections of the energy relativity structures and the magnetosphere, therefore, blurs distinguishing byproduct from product that produces millennia electrical power abundance,

Desperately neccasary at this time is one to three percentage points boost in Heat Rate efficiency Earth's gravity field, wherein a momentum of that boost in time may spawn the 100% efficiency. Said boost requires similar Heat Rate efficiencies boost the mega bulk power is cycling, wherein one percentage may be realized by disuse of wind turbines and solar panels even if these devices Heat Rate efficiency is 100%, which we know is not. In turn of events, if GODPARTICLES the super plant breeds save life on Earth taken GODPARTICLES name designation is well deserved.

The underground aqueducts cooling water inflow and outflow embody the underground aqueduct lengths portion prior to and after passing the condenser units. The underground aqueduct lengths portion after the condenser units embodying sufficient length to lower cooling water temperature proximate surface water temperature at an epigene surface outflowing qualifies evaporations and condensation of that water as useful energy. In turn, said evaporations and condensations qualify energy flowing the aqueducts underground lengths thru cross-sections of the First Fluid Element, which effect the MEHC absolute conserving, as useful energy, in turn, qualifies the evaporations and condensations radiations emission into epigene surface subgrade and space as useful energy.

All above spawn the MEHC absolute conserving of mass energy and significant useful energy in Heat Rate efficiency computing to completely overpower consumed energy when the super plant is in refueling modes, or runs at capacity of less than 100%. The aqueducts underground lengths, the MEHC absolute conserving spawned hydrodynamics gravity flow thermal energy transfers to gravitational sink counters, also, minimizes the thirteen Magnification factors and magnifications of the EESD, therein, especially energetic floods unsymmetrical distributions huge precipitations rushing surface runoff into tropical belt in spite of the Earth's equatorial bulge; climatologic data locate the underground aqueduct lengths, the aqueduct lengths directionality to a surface outflow of cooling water and the aqueduct underground lengths, cooling water sources selected locations. The underground aqueducts cooling water globally disposed in a geographical area must embody gravitational field sink maximally bound energy concomitant, uniform symmetrical precipitation.

The super plant absolute technologies, comprising Regions 4 aqueducts underground lengths, the aqueducts underground lengths, with First Fluid Element cross-sections yielding the MEHC absolute conserving, conforming to PMH, FEIIPMII technologies, the PMII, the FEIIPMII technologies effect principles and methodologies, which connect into cosmological global gravitational dynamics energy—cosmological global gravitational dynamics energy global insulation and solar insulation respective energy yield technologies for connecting such energies.

Absolute conserving of environment energy effectuates interconnection of the EESD, comprising energy in environment engendering maximal conductivity that modulates respective dynamics of cosmological global gravitational dynamics reverberated energy cycles in boundaries perfections succession. It is analogous to matching power phases to connect a power plant into a power grid.

Energy absolute conserving engenders maximal conductivity and the light fluids energy ultimate cycling of cosmological global gravitational dynamics from the energy relativity structures into Earth's gravity field sink, rather than more potent plasmas maximal conductivity plasma outflow into space, into more distant gravitational fields. All which amply illustrates the MEHC absolute conserving with interconnecting energy cycling across boundaries perfections of celestial bodies. The MEHC absolute conserving illustrates the relativity energy field means for balancing, ability to energy balance boundaries perfections in balancing the relativity energy. The MEHC absolute conserving governs, forces absolutely energy cycling, energy imbalances fluxing in the Universe.

The cycling energy, energy imbalances fluxing explain, affirm the applied science fundamentals, revealing cosmological global gravitational dynamics and Milankovich cycles sciences, and vice versa, the sciences explain, affirm the energy cycling, energy imbalances fluxing in the Universe, herewith, cosmological global gravitational dynamics and Milankovich cycles science explained.

Likewise, the cycling energy, energy imbalances fluxing in the Universe spawn enormous flux of boundaries perfections in the magnetosphere and the early Pleistocene Epoch plasma outflows on 41 ka periods, while during the late Pleistocene, and especially Holocene Epoch, plasma outflows on 41 ka , occasional 21 ka interval. Planet supported life may not conform to the relativity energy potential energy field, cosmological gravitational dynamics, the MEHC absolute conserving, and the Universe energy cycle. Root cause behind that are entire fauna and flora, which cannot meet, combine the MEHC absolute conserving and eternal energy cycling fluxing demand the Universe sets. All which cause the plasma fountains enormous fluxes of the magnetosphere, and Mars lost water and very likely the life on Mars lost to cosmological gravitational eternal energy dynamics.

The super plant, the ultra-transports system, comprising Regions 4 energy shunt, the energy shunt, including thermal radiation from Regions 1, 2 and 3 to Regions 4 and 5, cycles the MEHC absolute conserving energy, cosmological global gravitational dynamics embody boundaries perfections of the ultra-transport system, epigene surface, the super plant, the energy relativity structures and magnetosphere boundaries relatively and respectively; the energy shunt taps into cosmological gravitational dynamics and the light fluids cycling energy spawning boundaries perfections affected boundaries, from the ultra-transport system to the magnetosphere boundaries, which sustains, boost thermal energy radiating into space, into gravitational sink and concomitantly generates abundant electrical power which ultimately opposes global air warming.

The Heat Rate maximum efficiencies most beneficial energy transfers comprising beneficial energy transferring affecting the troposphere, tropopause, and electrical power cycling electrons perpetual fluxing at or higher than Heat Rate 100% efficiency, yield the applied science the gravity and magnetic fields energy strengths and environment conserving GODPARTICLES.

Maximal conductivity environment energy electrical power cycling yield GODPARTICLES and mother boards, circuit boards maximal conductivity ultimately least resistance energy flow paths.

Essential energy cycling into gravitation sink break down unless the MEHC absolute conserving, maximal conductivity resides in gravitational fields environment. Otherwise, global air warming is unavoidable. Fauna-flora, AGW and all else, except the super plant technologies, effect global air warming, which cosmological global gravitational dynamics imposes. Pleistocene, Holocene Epochs, Milankovich cycles reveals the Earth's gravitational sink missing maximal conductivity, gravitational sink energy cycling genre similar to maximal conductance cycling electrical energy.

Cosmological gravitational dynamics embody boundaries perfections' boundaries relative energy and maximal conductivity by boundaries perfections innately fluxing and by the MEHC absolute conserving cycled succession of boundaries perfections cycling energy in environment, which, in turn, in succession, engenders boundaries perfections with ultimate relative energy. All of which is revealed by Milankovich cycles, impurities concentration cycles prelude to the magnetosphere enormous fluxing, and subsequently plasma outflowing. All these engenders global air warming.

Boundaries perfections cycle Milky Way Galaxy energy inside infinite successions of boundaries perfections cycling absolute conserved energy to the MEHC permeated Earth's gravitational sink and the energy relativity structures. The tropopause, troposphere cannot naturally flux Heat Rate 100% eternal efficiency cosmological gravitational dynamics do. Humans, fauna, and flora flux, cycles energy below that Heal Rale efficiency and cannot do better, evidenced by short lifespans.

Global air warming, plasma outflowing and the magnetosphere dynamics enormous fluxing yield Earth's gravity field and the Universe energy structure cycle boundaries perfections incompatible energy cycling dynamics. The latter spawns eternal Heal Rate 100% efficiency which the energy relativity structures cannot affect; supra explain. The absolute technologies engender sole means for conforming to cosmological gravitational dynamics and Earth's energy cycling both of which effectuate one and the same ultimately finite energy technologies. The absolute technologies and cosmological gravitational dynamics with cosmological global gravitational dynamics identically cycle the Universe, the Milky Way Galaxy, the Solar System energies cycle the Earth's energies field. The super plant clustering the fundamental Fluid Elements, the ultra-transport system with the Fluid Elements and the fundamental Fluid Elements respective boundaries perfections cycles, fluxes bound energy in boundaries perfections of molecules, atoms, ions, isotopes, and electrons.

Confrontational, incompatible energy cycles in cosmological, global energy cycling, fluxing and boundaries perfections, the energy relativity structures, the Advanced Processors is unavoidable, pertaining to fluid compositions of cosmological gravitational dynamics and cosmological global gravitational dynamics cycled energy. Cosmological gravitational dynamics' fluids composition plasmas cycling energy flux deliver frictionless energy, which does not absorb insulation energy.

The cycling energy cycling the relativity energy structures embody impurities concentration fluid composition of emitted gases and vapors evaporated from epigene surface, fauna flora and ocean waters. Comprising the light fluids, nigh 99% by volume, the relativity energy structures cycling fluid entirely molecular composition engenders viscosities and vapors phase changing properties, inside natural temperature variations global ranges. Maximal conductivity eternal cycling energy plasmas flux vs. the ultra-longevity of the energy relativity structures molecular fluids flux effect enormous differences, Mars and Milankovich cycles in the Pleistocene, Holocene Epochs shows.

Cosmological gravitational dynamics cycles energies into perfections—do as I do and conform or perish. Such is present Mars environment after inability to preserve its water and the light fluids. Cycling, fluxing the light fluids and impurities concentration inside boundaries perfections of the energy relativity structures, the tropopause and troposphere do not meet maximal conductivity of cosmological gravitational dynamics. Earth's gravity faces long fight to preserve the light fluids.

Cosmological research, observations and the Pleistocene, Holocene Epochs, Milankovich cycles, the deep core borings, all attest to molecular fluids innate cycling in boundaries perfections. The energy relativity structures, and the nullities' sums is unsustainable by Earth's gravitational field, inside cosmological gravitational dynamics fluxing, cycling by cosmological global gravitational dynamics molecular fluids, inside a geological time interval, lasting no more than several epochs.

The super plant absolute technology, comprising applied science PMII and FEIIPMII technologies—the PMII and FEIIPMII technologies—the MEHC absolute conserving—cycling energy the light fluids and the MEHC Regions 5, engendering maximal conductivity that maximally interconnects and couples the light fluids cycling Earth's gravitational field sink, also, the tropopause, troposphere cycling energy balances, to oppose global air warming in space time.

The super plant during its lifespan, comprising the underground aqueducts lengths, directionality and the surface outflowing of the cooling water upon epigene surface conforming to climatologic data qualifies the evaporations, condensations radiations respective emission into epigene surface subgrade and space as useful energy. In fact, entire cycling of the light fluids comprising cooling water gravitational energy cycling thru the aqueducts, and the energy relativity structures cycling insulation energy qualify as useful energy; the surface outflowing in geographical areas globally, naturally and concomitantly binds uniformly symmetrical precipitation to gravitational field sink maximally bound energy. The National Oceanic and Atmospheric Administration has good data. Armed with stunning useful energy production during its millennium lifespan, the super plan, the super plant technologies, can indefinitely cycle the circuit board an electron in the printed circuit.

The super plant absolute technology, the ultra-transport system, comprises the bulk power ultimately aligned routing Regions 1 primary coolant loops, Regions 2 secondary coolant loops, Regions 3 ultra-conserving, ultra-longevity energy cycling, affecting no emission into environment, Regions 4, the energy relativity structures maximal conductivity, and Regions 5 the light fluids, electrical power cycles, and gravitational field maximum conductance.

The super plant absolute technology, the ultra-transport system comprises the bulk power ultimately aligned routing Regions 1 primary coolant loops, Regions 2 secondary coolant loops, Regions 4 cooling water cycling in underground aqueducts lengths and from cooling water source locations to an outflowing affecting Regions 4 portion of hydrosphere ultra-conserving, ultra-cycling maximal conductivity Regions 4 cycling Earth's gravity field bulk power and the energy relativity structures cycling gravitational field and Earth's climate changes.

Maximal conductivity in boundaries perfections pertains to the light fluids energy circulating the energy relativity structures. Regions 1-3 effectuates the fundamental Fluid Elements boundaries sequent cluster Fluid Elements Regions 1-5 cluster into the Advanced Fluid Elements, the energy relativity structures and the magnetosphere as boundaries perfections of the Advanced Processor. The electron indefinite cycling, fluxing effect 100% Heat Rate efficiency potential and perpetual motion inside boundaries perfections inside the printed circuit and the mother board engendering applied sciences GODPARTICLEs affecting own and boundaries perfections sequence. All such show the Universe eternal cycling is cycling atomic energy technologies a nuclear energy source.

### BRIEF DESCRIPTION OF THE DRAWINGS

While claimed inventions are susceptible of embodiment in many different forms, there is shown in and will herein be described in detail(s), specific embodiments with the understanding that the present disclosures can be considered as exemplification of the principles of the inventions and is not intended, to limit inventions and innovations to the embodiments illustrated or not illustrated.

The super plant, the ultra-transport system energy processes, buildings, features and advantages are better understood by reading the following drawings brief description of presently illustrated embodiments of said inventions, when considered having the accompanying drawings, in which:

FIG. 1A shows a containment building, an annex building of a reactor building symmetrical, half-section elevation view taken generally orthogonal to a two turbine buildings inline configuration generally symmetric orientation, one on each side of the reactor building, and an ultra-transport system a high energy piping loops inline aligned a primary, a secondary coolant loops hot legs;

FIG. 1B is a partial half-section elevation view generally take orthogonal to the FIG. 1 A view;

FIG. 2 shows a half sectional elevation view of a cross section of hydraulic seal device sealing a high energy piping penetrating a wall of a primary containment and/or an annex building wall;

FIG. 3 shows a half sectional elevation view of a cross-sectional of a transducer device sealing a high energy piping penetrating a wall of a primary containment and/or an annex building wall;

FIG. 4 shows a cross-section elevation view taken generally about one of two centerlines of a transducer device and an equipment support leg and base plate;

FIG. 4A shows a transducer device and bracing members' cross-section elevation general view of a steam generator/separator, a high energy piping floor penetration restraint or rotated clockwise or counter-clockwise a reactor and an annex building a high energy piping wall penetration seal;

FIG. 5 shows a high energy piping wall cross-section elevation view and a vertical orientation of an expansion/contraction device three thermal gaps, four portals and a backstop;

FIG. 5A shows sectional view of a backstop fluid compartment and portal FIG. 5 shows;

FIG. 5B shows FIG. 5 a thermal expansion lead, innermost gap and, also, potentially a last gap.

### DETAILED DESCRIPTION OF THE DRAWINGS

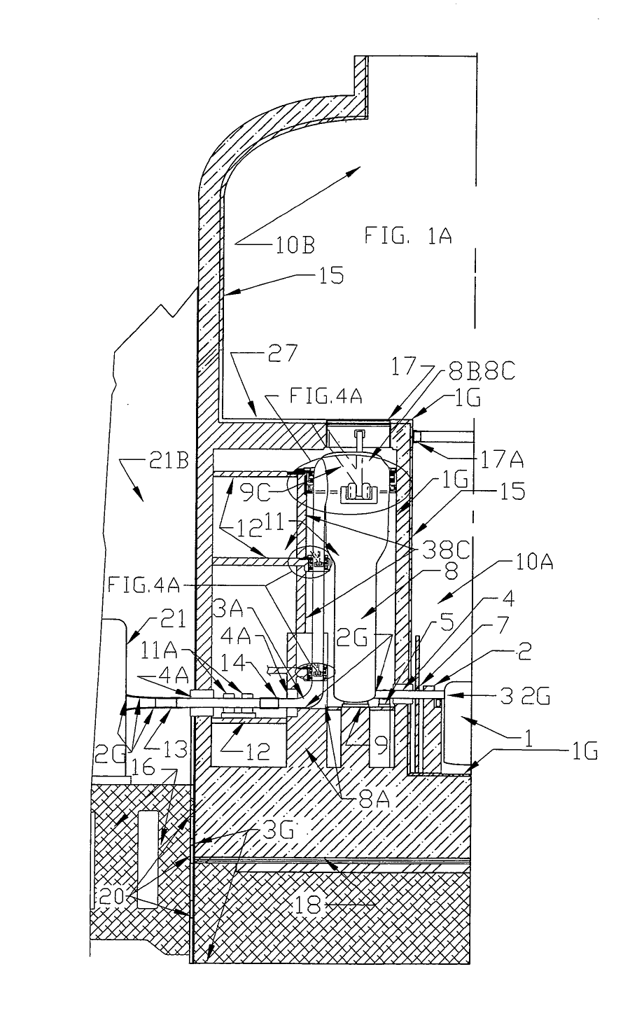

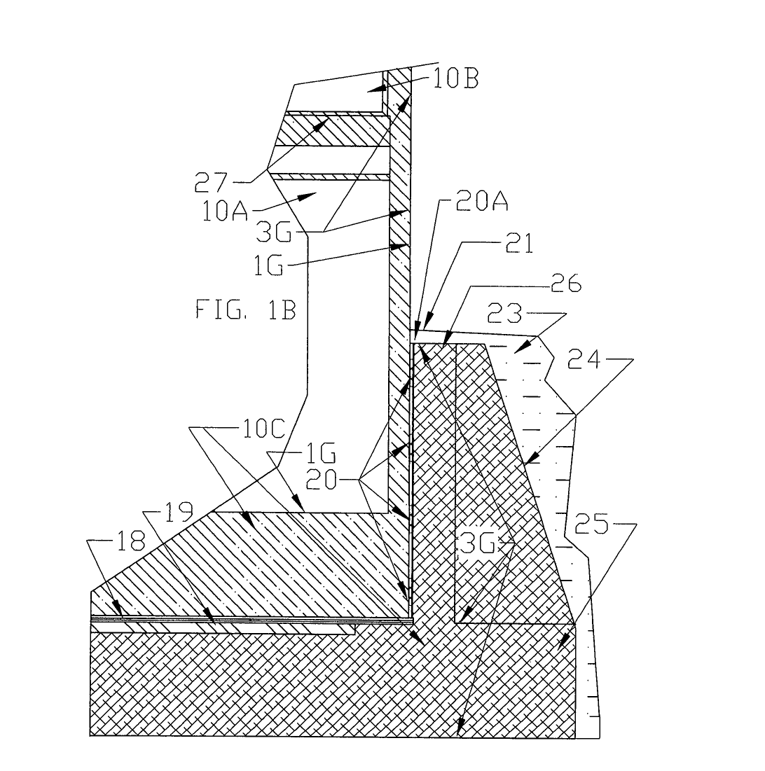

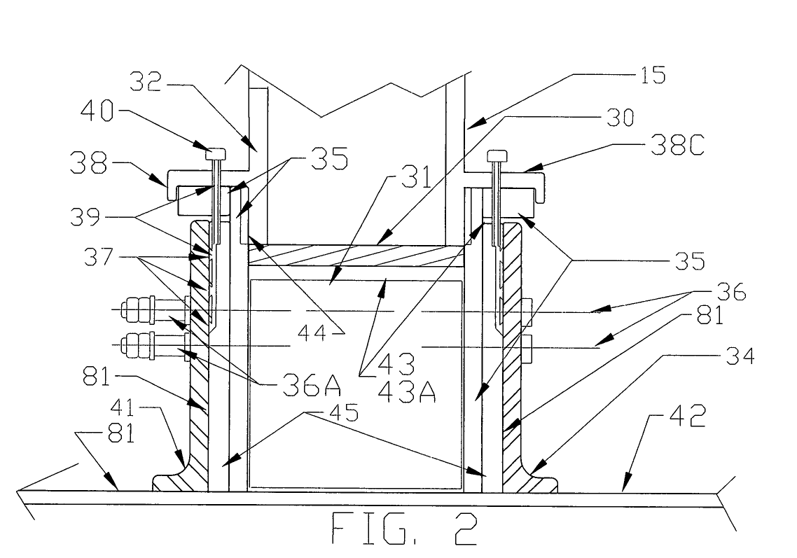

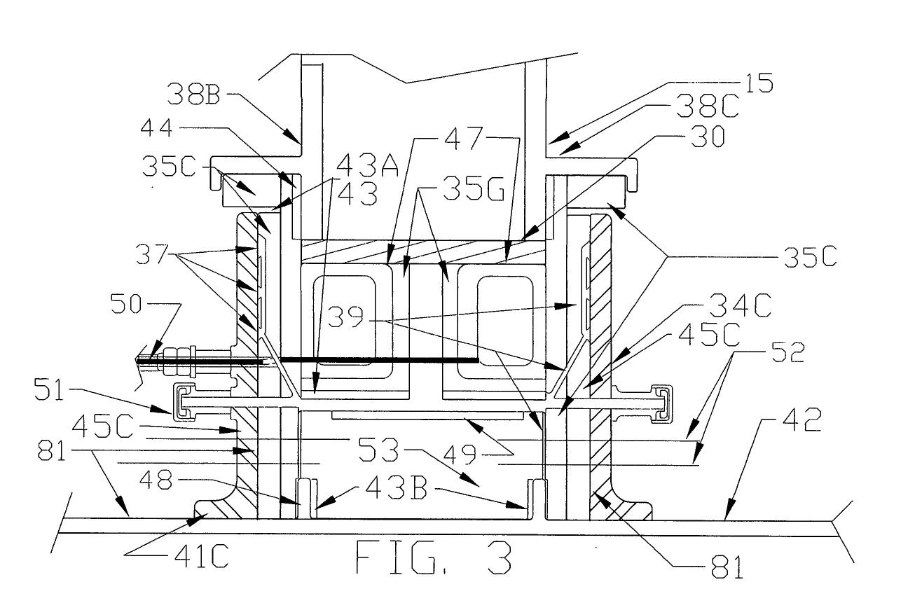

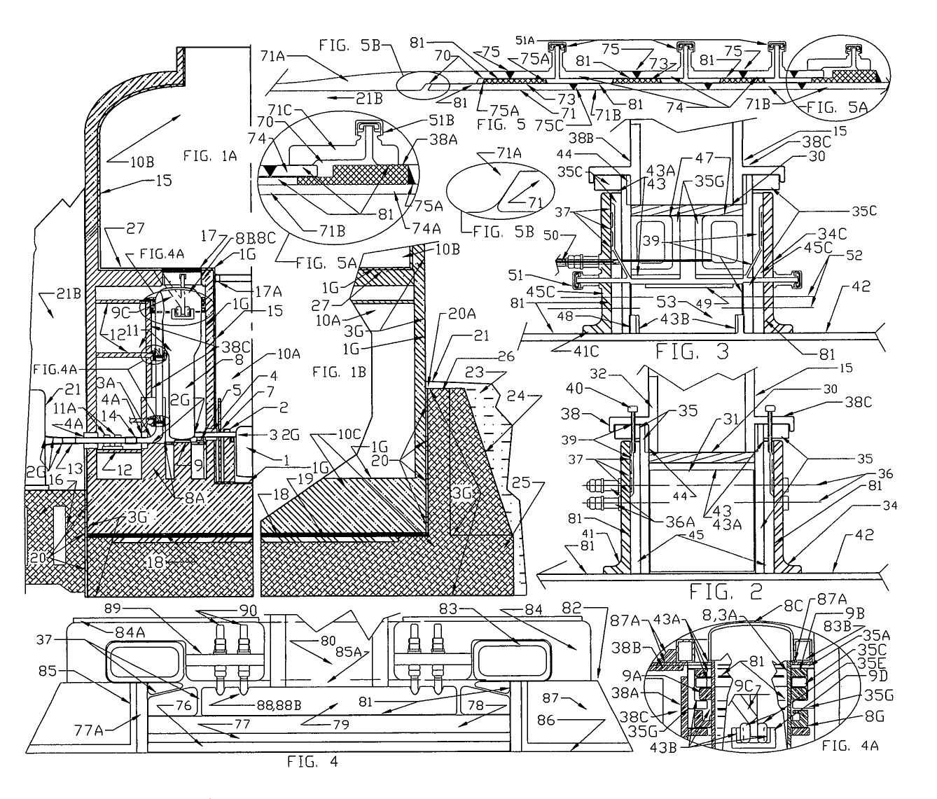

FIG. 1A shows an elevation view cross-sectional half-portion of reactor building 100, comprising primary containment 10A, primary containment dome 10B and foundation 10C, and a portion of one of two turbine buildings 21B, foundation 16 portion. Turbine buildings 21B, foundations 16, and reactor building 100 comprises generally symmetrical inline oriented buildings. Two turbine buildings 21B, reactor building 100 affects the ultra-transport system coolant ultra-short hot legs, primary loops 3, secondary loops 3A, and includes high pressure nozzle 13. The ultra-transport system 3 3A 13 ultimately inline and symmetrically aligned about symmetry plane about reactor vessel 1 in every respect, extends horizontal from sides of two steam generators 8 to the reactor vessel, to two turbines 21 in turbine buildings 21B. Loops 3A an upright piping portion an entire length and lower elbow effects comprise components of steam generators 8. The reactor building 100 and foundation 10C outer faces comprise Regions 3, boundaries 3G. Boundaries 2G embody the ultra-transport system hot legs straight segments 3, 3A and cold legs' returns Regions 3.

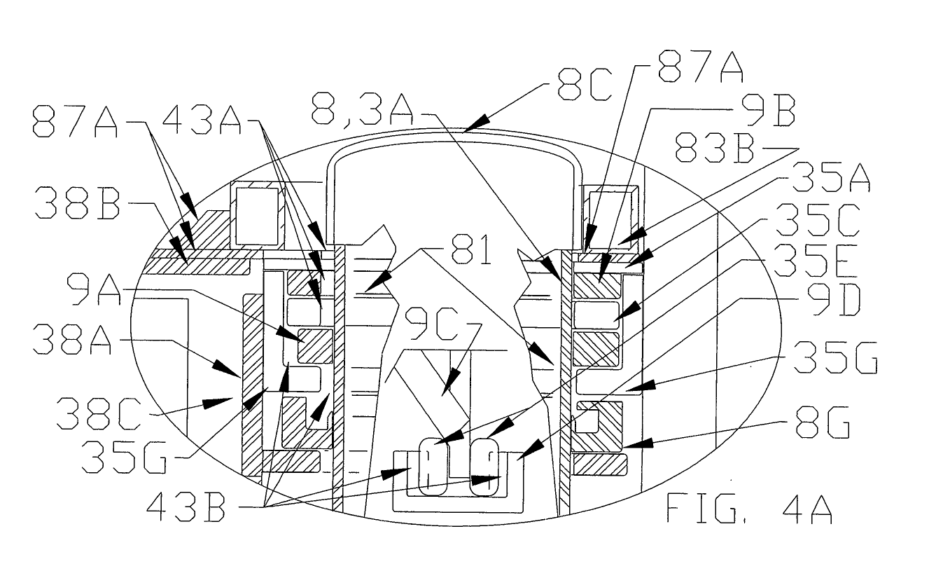

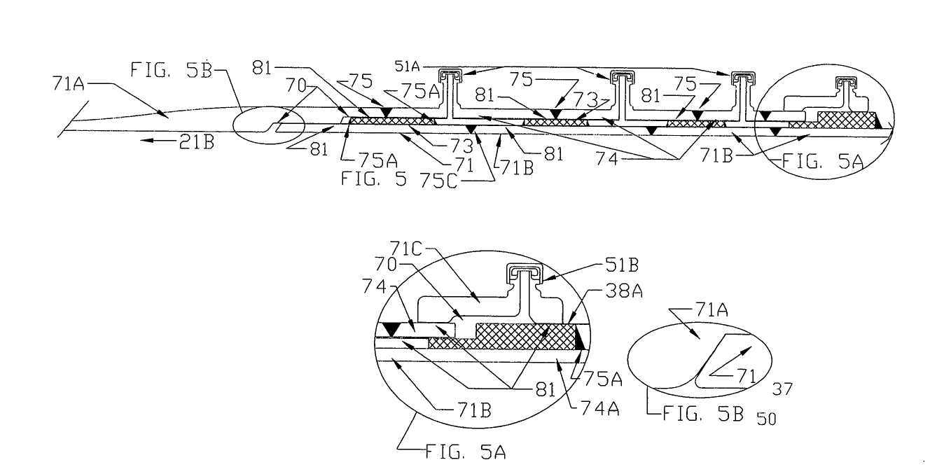

Electromagnetic transducer devices, FIG. 1A, 2, 3, 4, 4A, 5 and 5A show in FIG. 1A, seal respectively selected wall penetrations seals 4 4A (FIG. 1A, FIGS. 2, 3 and 4A) and concomitantly configure movement of piping primary 3, secondary 3A 13 loops (FIG. 1A) and four base plates 5 of two high pressure pumps 5, symmetrically configured at each of two steam generators 8, base plates 9 (FIG. 1A and 4). The ultimately inline, symmetrically aligned and configured, in upright symmetry plane, high energy piping two primary loops 3, two secondary loops hot legs 3A 13 two expansion contraction electromagnetic transducer devices 14 (FIG. 1A and FIG. 5, 5A and 5B) one in each of two loops 3A 13 of reactor vessel 1 configure all axial movement displacements.

FIG. 1A elevation shows symmetric the ultra-transport system hot legs in upright plane of symmetry shown one-half portion; that upright plane symmetry concomitantly comprises upright plane symmetry in upright orthogonal plane to one of FIG. 1A. FIG. 1B elevation view shows the reactor building 100, one-half portion, in that upright plane; in this configuration comprising two turbine buildings 21, FIG. 1B comprises the reactor vessel and potentially elbows associated with the reactor vessel, all of which, including all other electrical and mechanical devices considered state of the prior art integral parts, including the reactor vessel 1, are not shown in FIG. 1B. All high energy piping cold legs coolant returns, similarly taken and not shown, and FIG. 1 hot legs 3 3A 13 comprise an ultra-transport system extending to two turbines 21, buildings 21b associated condenser units in the buildings 21B, which embody symmetry in said upright orthogonal planes, including FIG. 4A bracing 9C shown in FIG. 1A. The reactor building 100 FIG. 1A and FIG. 1B shown, comprising foundation 10C 24 25 26, comprise the ultra-transport integral part enclosure, which seals high energy piping penetrations cold legs coolant returns FIG. 2 or FIG. 3 shown seal.

The reactor building comprises primary containment 10A, dome 10B and annex building 11 housing steam generators 8, high pressure pumps 5, and high energy steam lines 3A 14, FIG. 1A, FIG. 1B show. Two steam generators 8 symmetrical high energy piping configuration about reactor vessel 1 is shown. the ultra-transport system of 4 or 8 steam generators is contemplated.

Primary containment 10A, dome 10B inside surface stainless steel plate15 lines, effecting dome 10B outer surface composite concrete construction upper Regions 3, boundary 3G portion. Regions 3 upper boundary other portion, likewise not shown, houses a HVAC system, equipment an excess and a main equipment excess hatch for reactor building 10, as is known in the prior art; Regions 1 portion boundary 1G, primary containment 10A an outside face, from top of base slab 27 elevation, annex building 11, to foundation base footing 10C enclose Regions 3 boundary 1G. Tubular, reinforced structural insulation 7 known in the art bolsters reactor vessel shield wall 2.

Annex building 11 surrounds primary containment 10A wall outside face and Regions 1 portion that comprises primary containment 10, Regions 1 portion, including a refueling channel and an outside face of walls and that channel excess hatch and the main excess hatch for primary containment 10A, Regions 1 from foundation 10C to top of floor slab 27, the refueling channel a rectangular cross-section length, height that end with the excess hatch, comprising boundary 2G.

All transducer devices (FIG. 2, 3, 4, 4A, 5 and 5A), excessed and serviced from inside the annex building 11, effect the ultra-transport system hot legs self-aligning and self-configuring by energy of ultimately inline aligned symmetrically configured the high energy piping two primary loops 3 secondary loops two hot legs 3A 14 13, each with expansion contraction electromagnetic transducer device 14 (FIG. 1A and FIG. 5, 5A and 5B). These high energy piping lengths, by high energy flowing straight line and away from acting inflow outflow effects, oppose any changes to maximally straight alignments, assisted and controlled by electrical power and guided by precise predetermined displacement vectors and in situ extensometers measured and cameras monitored.

Summary of the Inventions explain the predetermined displacement vectors spawns energy of the minimal energy displacements and the minimum energy in situ magnitudes measured, monitored energy displacement vectors. The transducer devices in total 14 affect hot legs 3, 3A 14 13 axial displacement energy nigh 2000 psi, granted by all of the transducer devices, which is 1/10^{th} of the prior art grated, precluding composite constructions all stress concentrations exigent interactions.

Floor slab 27, here, based on two steam generators (SGs) 8 configuration, comprises two equipment access hatches 17, for each compartmentalized building 11, SG 8, steam line 3A, SG 8 globoid 8B, structural insulation 8C, two braces 9C, and removable ring strut 17A. Two solid rubber tire carts 11A effect means for moving and locking each to floor 12 surface and attaching the carts to at least two steam line 3A disk stiffeners; high pressure nozzles 13 embody means for sustaining quality steam and pressure; and in annex building 11 trust blocks 8A and 8C and SG 8 base plate 9 (FIG. 4) transmit steam line 3A loads to foundation; as needed, shim plates welded to wall inserts steel 15 32 embody two parallel and even surfaces perpendicular to pipe spool 42.

FIG. 1B shows containment building elevation half sectional view orthogonal to FIG. 1 A sectional elevation view 10A 10B, base/footing foundation 10C, in two turbine buildings 21 configuration; foundations 10C 25 comprise Teflon plate, between stainless steel plates 18, bentonite packaging in sheets on top of compacted sand backfill 19, spaced stainless steel cables elastomeric bearings 20 in stainless steel ducts 20A, retaining wall 26 24, structural backfill 23, and clay layer 21 seal.

FIG. 2 shows a half sectional elevation view generally taken about a vertical symmetry plane thru respective containment wall penetrations device 4 4A, which seals high energy piping 3 3A, with these parts: pipe spool 42, inorganic fullerene (IF) coating 81 on outer diameter surface, effects a torsional and axial slip thru a wall and sleeve 30; flange 34, counter flange 41; two annular disks 45 with inner diameter surfaces coating 81 negative tolerance fit, fit over pipe spool 42; six faces annular structural insulation spacer 31; two structural insulation backings 35 in backing rings 38 38C; and two bolt or stud assemblies 36 thru backings insulation rings 35, flanges 34 41; and two fluid lines 39, branches 37 completes the parts list; the parts comprise machined complement of completely matching surfaces. Backing rings 38 comprise concrete embedded steel plates and backing rings 38C weldments to containment 10A liner 15. Assemblies 36, 2-rows, 10 bolts in a row comprise: a bolt or a stud, a spring, a washer at each end of the spring and a locknut for each nut; flange 34, one disk 45 and insulation backing 35 bear on inner face, while counter flange 41, the other disk 45 with insulation backing 44 bear on the insert plate and that wall outer face, seal respective wall penetration 4 4A by assemblies 36, springs 36A post tensioning means; said parts precisely fabricated surfaces thermal and negative tolerances pre-stressed are assemblies 36 post-tensioned; sleeve 30 penetrates steel reinforced thick concrete wall, with each end groove welded to insert plates 38, or liner 15 and insert plate 38, effectuating two parallel even surfaces. Flange and counter flange inner faces, coated with IF MoS₂ or WS₂, bear respectively on IF coated disks 45, 3-disk grooves 37; disks inner face bear on insulation backings 35 44 against each face of the wall penetration, effectuating wall's positive seal around perimeters of penetrations. This device further comprises three concentric grooves 37 in outer face of disks 45 and two concentric circles of assemblies 36 staggered bolt holes thru spacer 31, disks 45 and thru flange 34 and 41 which in outer faces are countersunk. Said assemblies 36 through said insulation spacer, disks, flange and counter flange with the washers, in compression under torqued nuts affecting said parts assembly that bears on insulation backings 35, seals assembled parts perimeter; assemblies 36, countersunk bolt-holes and washers caulked and pressurized seal the device in assembling of parts. Three 37 concentric groves, clear of the bolt holes, are lubricating turbine paste packed and pressurized by force of gravity. Said lubricating turbine paste seals grooves, in mutually opposing lubricated IF surfaces, sealing high energy piping loop radial thermal movements along IF lubricated surfaces. Shim plates welded to liner 15 and insert plate 32 insert plates 32 (4A) yields means for affecting two flat, parallel surfaces, which are orthogonal to said pipe spool 42. The thick wall, annular insulation cylinder 31, including machined precisely all surfaces and assembly 36 holes disposed longitudinally on concentric circles, presses against insulation backings and opposing flange 34, counter flange 41, under bolts (studs) tensioning; the bolts (studs) pass thru spacer bolt-holes and provide for space gaps 43, from spacer 32 to steel sleeve 30, affecting the device granted internal radial displacements. Flanges 34 41 and disks 45, with 5-10 nanometers IF embedded coating on machined surface of inside diameters, are heated to high temperatures and slid over spool 42 cold length, comprising machined outside diameter and the IF surface coating, and cooled disposed in respective positions; one of the flanges and its disk is shop pre-stressed with the other flange and disk field pre-stressed into place. Imposed thermal pre-stress force-fit yields hoop stresses. Said flange, counter flaage, disks and spool, with said inorganic fullerene solid lubricant slips surface, constitute said device sealed wall penetration 4 4A that grants axial-radial displacements thru the device; between insulation backings in a tight fit, spacer 31 is free of high stresses; assemblies 36 bolt-holes short upwardly slots grant reactor vessel and piping loops' centerlines thermal vertical displacements. Thermal expansions biaxial compressions additively seal wall penetrations 4 4A. Disks 45 bearing either on structural insulation 35, liner 15 or insert plate 32 seal surfaces around wall penetration 4 4A; backing ring 38C, 38 welded to either liner 15 or insert plate 32 comprises outstanding edge bent radially inward into a lip, which confines insulation backing 35 and flange 34 or counter flange 41, imposing structural insulation backing ring 35A bearing surface allowed thermal gaps 43A in the disks, flange and counter flange; insulation backing ring thickness entire surface bears on backing ring 38C or 38 and blocks a slip of insulation ring 35 inside the backing rings, while liner 15 and insert plates 38 radially matching tongue and groove 44A precludes any rotation of insulation backing 35 and permits disks and flanges radial movements granted by gap 43A; at operating loads, insulation backing rings 35, backing rings 35A confine disks 45, counter flanges 41 and flanges 34; each backing ring 35 inverted L-shape is fillet welded on both sides to liner 15 or the insert plates, as a wall penetration backing rings 38 38C pipe restraints—backstops. Cold return legs of primary coolant loops 3 comprise assemblies 36 oversized bolt-holes vertical slots sealed by pressurized caulking under oversized washers; that grants reactor vessel 1, upright steam generators 8 comprising loops cold legs return 3 radial and upright movements allowed by gaps 43A, in addition to upright, axial-radial thermal movements 43 and 43A in loops 3 hot legs. Piping penetration 4, 4A operating temperature thermal expansions force disks 45 and flanges 34 closing of gaps 43, 43A, which forces spool 42 loads transfer to backing rings 38C, 38; thru rings 35 disks 45, turbine paste-fluid lines 40 lubricating seals grooves 37 and interfaces of flanges 34, counter flanges 41 and disks 45, internals of containment wall penetrations 44A,where precision fabrications of complete compliments of surfaces, lubricating turbine paste-fluid surfaces in-wall axial pre-stress, thermal and negative tolerances pre-stress in mechanical assemblies and thermal expansion innate biaxial compression effect positive sealing of all containment wall penetrations.

FIG. 3 shows a half sectional elevation view generally taken about a vertical symmetry plane thru high energy piping 33A respective containment wall penetrations 44A, with the FIG. 2 exchange of spacer 53, for spacer 31; electromagnetic turbine lubricating fluid, instead of lubricating paste-fluid, with fluid lines 51 39; electrical power line 50, into electromagnets 47, with counter flange 41C, flange 34C, disks 45C, backing insulations 35C, backing rings 38C 38, IF surfaces' coatings 81, bolt assemblies 52, and spacer 53 inside diameter with spool 42 outside diameter at operating temperate precise tolerance fit, soft-iron tube 49 embedded in outside diameter with thermal gaps 43B, at retainer disks 48; wherein illustrated, detailed, enumerated and described parts—precision fabrication surfaces complete compliments thermal and negative tolerances pre-stress and in-wall axial pre-stress and thermal expansion innate biaxial compressions embody completely matching complements of mechanical assemblies with electromagnetic assemblies of two ironclad, annular housing electromagnets 47 embedded in structural insulation 35G; fireproof electrical power line 50; electromagnetic fluid supply line 51 branches 39 and concentric grooves 37; electromagnetic and mechanical assemblies constitute in-wall device electrical power means for magnetizing the assemblies and modulating electromagnetic fluid bulk modulus moduli as means for allowing the fluid three directional displacements to grant high energy piping means granted three directional of vector movements into least stressed disposition thru the wall penetration—attaining the piping means for high flexibility to high rigidity support stiffness; device modulating electrical power to electromagnets, in response to piping stresses extensometer readings, affects the support stiffness granting piping innate movements to low stress dispositions and the penetration seal redundancy; FIG. 3 electromagnetic supply line 51 ties-in into pressurized electromagnetic fluid tank; entirely symmetrical lower elevation view has supply line 51 return to the tank. Iron filings, said turbine paste-fluid amalgamate embodies means for achieving electromagnetic fluid preferred stiffness.

FIG. 4 shows a cross-sectional elevation view taken generally about steam generator 8, base 9, or high-pressure pump 5 (also turbine 21, a generator) in symmetry plane of structural steel support leg 80 entirely rounded thick base plate 79, on elliptical bearing plate 78 and identically elliptical structural insulation plate 76 and stainless steel plate 77, completely bound by elliptical structural insulation rim plate 77A, with stainless steel rim plate 85 anchoring at each support 80 respective in-situ elevations 86 floor elevations 82 that keep high energy lines 33A optimally level. Plates 76 77 78 bear on rim plates 77A 85 upwardly extension which positively confines each plate and bounds granted movements of plate 79 over plate 78, along IF coated surfaces interface 81. Plate 79 includes at least four of machined parallel channels 88 embodying support 80 vector direction thermal movements under operating loads. At least four threaded studs 90, one stud per channel, comprising egg shaped endpoint 88B threaded through its threaded hole in pin arm 89 presses on each of channel 88 grooves, locked by washers, nuts, locknuts and reverse thread lock nuts. Arm plates 84 are welded to plate 85, radial stiffeners 87; channels 88 and studs 90 and endpoints 88B restrict plate 79 movements to channels 88 said vectors direction. At least two pairs of plates 84, symmetrical about leg 80, welded to plate 84A and plates 82, effectuate further leg 80 anchoring. Plate 79 embodies contact surfaces IF coating 81, with machined 85A, drilled 37 lubricant access paths; electromagnet 83 ironclad housing embodies weldments to plate 85 to stiffeners 87; inside electromagnet 83 electromagnetic fluid, the fluid, covers plate 79, in mechanical electromagnetic complete complements assemblies embodying high energy piping configuration, equipment base plates symmetrical about reactor vessel and turbine-generator upright plane of symmetry; in such configuration, displacements and loadings as affected force are transmitted, in symmetry plane of said configuration, and lateral loadings balanced and bounded within piping walls and equipment casings and upright loads balanced by piping and equipment weight and loads transmitted to base plates; the base plates in-situ elevations are set for high energy piping horizontally optimal routes spawning said plane of symmetry. Electromagnetic assemblies electrical power input effectuates means for modulating the electromagnetic fluid stiffness moduli and bulk modulus that comprise means for dissipating large portions of thermal, static, and atoned static portion of dynamic loads by the assemblies granted movements; remainder small portions of the loads, except for the fluid further atoned dynamic loads portion, within magnetized elasticity range of said fluid, are passed to structures, comprising means for preferred stressing of structures; the fluid inelastic deforming atones the dynamic loads oscillating amplitude short duration peaks portion, by dissipation of the peaks, in dynamic loads damping dissipated peaks as such fluid affects its return to elastic range; wherein, electromagnetic fluid creep affects and attunes the base plates granted major axis creep; the fluid brief excursion into inelastic range is artificial; it is controlled by extensometers, which monitor displacements with power supply sustained means for raising the fluid elastic range with means for raising fluid stiffness; displacements of base plates in the plane of symmetry effectuate movements in that plane of symmetry only granted transverse lateral infinitesimal displacements; symmetry orients major axis of the elliptical plates in the plane of symmetry, affecting horizontal force vector in that plane; pressure pumps 5, one on each side of SG, affect resultant force in said plane of symmetry, for skewed major axis vector sum in that plane. Plate 79 round forms sliding surfaces yield least interfacing areas; square and rectangular plates 79 are likewise contemplated. Minor axes of plates 77A 85 only permit plate 79 grated movements in and along the major axis.

FIG. 4A of FIG. 1 A shows a cross-section elevation view generally taken thru symmetry plane of electromagnetic and mechanical complete complements assemblies of bracing devices—for SG 8 upper end of steam line 3A (FIG. 1A); electromagnet ironclad housing 83B welded to radial plate stiffeners 87A, about housing 83B perimeter; the stiffeners, housing welded to floor insert plate 38B around floor opening, floors 12, plate inserts 38A and trust block 38C; steel ring spacers 9A 9B IF surfaces coatings 81; thermal gaps 43A 43B; structural insulation: ring plate 35C, and ring plate 35A—covers of floors 12 opening inside radial stiffener plates 87A, globoid 8C, ring flange 35G; two SG8 four braces 9C welded to hatch 17 frame, eight for trust blocks 38C high energy piping 8 (FIG. 1A) (shown brace is behind SG 8); welded dishes 9D, braces 9C ends' backstops comprising ring 35E; thermal gaps 43A; and structural insulation drip pan 8G. Plate inserts 38A, around SG 8, of floors 12 and trust-blocks walls 38C 8A (FIG. 1A), support pan 8G, flange 35G, and stacked plates 35A 9B 35C 9A. Structural steel framing at trust-block 38 comprises welded plates into Flange 35A welded to plate inserts 38A. Said symmetry plane embodies turbine 21, reactor vessel 1 centerlines symmetry plane. Plates 35A 9B 35C 9A as spacers comprise thermal expansion respective gaps 43A 43B with plates 35A 35E bearing on flange 35G, with the stacked plates 35A 9B 35C 9A in polar direction bearing on flange 35G effect radial displacements, only. Housing 83B and the staked plates and pan 9D, as the assembles prefabricated sets and parts, are lowered in place in half sections and welded, with housing 83B only comprising upper and lower welded section and abutted casings welded, enclosing electromagnetic coils. The coils are wired in parallel, cable circuits to electrical power source. Such electromagnets are preferred, although one wire electromagnetic assemblies are simpler; the fluid fills housing 83B inn annular; the complete complements assemblies of bracing devices embody high energy piping displacements; Said assemblies, in-situ configurations, are set for high energy piping horizontally optimal routes affected in planes of symmetry. Electrical power input to electromagnetic assemblies effectuates means for modulating the electromagnetic fluid stiffness moduli and bulk modulus that comprise means for dissipating large portions of thermal, static and atoned static portion of dynamic loads, by the assemblies granted movements; remainder small portions of the loads, except for the fluid further atoned dynamic loads portion, within magnetized elasticity range of said fluid, are passed to structures, comprising means for preferred stressing of structures; the fluid inelastic deforming attunes the dynamic loads oscillating amplitude short duration peaks portion by dissipation of the peaks, in dynamic loads such damping dissipated peaks the fluid effects to return to elastic state range; the fluid creep attunes the braced member granted elastic movement finite displacements. The fluid brief excursion into inelastic range is artificial; finite to infinitesimal displacements are monitored extensometers and cameras; power input comprising means for raising the fluid elastic strength and stiffness; plates 35A 9B 35C 9A symmetry in said symmetry plane grant very small total movements and in that symmetry plane transverse displacement no more than infinitesimal.

FIG. 5 shows a wall thickness symmetrical cross-sectional elevation view generally taken through centerline, in upright symmetry plane, of precision fabrication, thermally and negative tolerances pre-stressed, steam lines 3A expansion and contraction device 14 (FIG. 1A), and turbine building 21A direction spool 71A to which three spools 74 are successively butt welded—spools 71A 74 outer assemblies—effectuating three inside diameters. Precision, negative tolerances, fabricated two outside diameters of spool 71 and three spools 71B successively butt welded—spools 71 71B inner assembly. Sleeves 73 in centric portions of spools 71 71B in negative tolerance fit are fillet 75A welded both ends; spools 71 71A identical negative tolerance pre-stress engenders the inner, the outer assembly negative tolerance pre-stress and thermal pre-stress added, in entire device 14 pre-stressing fabrication and assembly; spools interfacing surfaces of inside, outside diameters cylindrical surfaces 81 embody interfacing coatings of embedded inorganic fullerenes (IF), MoS₂ or WS₂. Spool 71A constitutes an obtuse angle with a barely sharper angle precision machined a smooth surfaces transition to two larger diameters comprising total effect presses with lead spool 71 and that spool and sleeve 73 whose machined weld 75A matches precisely said barely sharper angle surfaces in device 14 fully closed position and in fully open position comprising entire gap 70. That gap is matched by gap 70, shown in closed position in FIG. 5B, wherein the other of the two smooth transition surfaces matches precisely rim bevel of lead spool 71—with exceptions of a rounded point of spool 71 and spool 71A, first of said two smooth transition surface, comprising the obtuse angle long fillet leg into inside diameter surface. The exceptions, with otherwise fully matching gap 70 surfaces complete compliments, at gap closure, engender suction which induces closing of the device. Spool 71C gap 70 comprises spool 74 and backstop 38A entirely matching interface square ends detailed in FIG. 5A; spools 71B, 74 comprise respective butt welds 75C, 75; the device said fabrication is known in the art; compartment between sleeves 73, and at backstop 38A are pressure filled with electromagnetic fluid through respective portals 51A, 51B, shown as capped; in operation eight portals connect through fluid pressure lines to fluid supply pressurized tank which provides means for circulating the fluid when granted by four electromagnets entirely equal spaced around the device, each entirely horizontal in the upright symmetry plane of reactor vessel 1, turbines 21. The electromagnets anchored in suspension, with ample separation around device 14 effect inline two separate coaxial assemblies. The electromagnets comprise small disk abutting cylindrically oriented coils equal spaced axis, pointed at and equidistant from the spools embedded in in insulation half sleeves. Said coils, in parallel circuits are fireproof cable wired to a power source. In-situ configurations are set for high energy piping horizontally optimal routes effectuating the symmetry plane; electrical power input to electromagnetic assemblies effectuates means for modulating the electromagnetic fluid stiffness moduli and bulk modulus and comprise means for dissipating large portions of axial thermal, static and atoned static portions of dynamic loading in horizontal plane, by said assemblies permitted slow creep movements in reactor vessel and turbine upright plane of symmetry; remainder small portions of the loads, except for the fluid further attuning of dynamic loads portion within magnetized elastic range of the fluid, are passed to structures, comprising means for preferred stressing of structures; the fluid inelastic deforming attunes the dynamic loads oscillating amplitude short duration peaks portion by dissipation of the peaks, in dynamic loads damping dissipated peaks as such fluid effects its return to elastic range. Electromagnetic fluid creep stiffness effects and attunes allowed slow elastic creep in the device. The fluid brief excursion into inelastic range is temporary, extensometers and cameras monitored displacements entirely controlled by power supply effectuating means for raising the fluid elastic limit and increasing stiffness; said coaxial symmetry in the symmetry plane allows the symmetry plane displacements axial movement only, and laterally no more than infinitesimal displacement. Thermal, static and dynamic loads stiffness granted optimal slow creeping in the symmetry plane from reactor vessell to turbines 21 measured by cameras, extensometer readings optimally grant high energy piping loops, base plates and bracings effectuated preferred stressing, displacements.

FIG. 5A illustrates a section view not to scale thru device 14 symmetrical half portion in respect to a longitudinal axis of a backstop assembly enumerated and described toward the end of FIG. 5. FIG. 5B illustrates a section through device 14 closed position with fillets described FIG. 5 shown.

Electromagnetic wall penetrations, base plates, bracings, and expansion and contractions devices function in response to strategic extensometers readings in high energy equipment slow creeping; structures of the devices and confined fluid stiffness—elastic, shear, and bulk moduli spawned by power input into electromagnets preclude well within elastic strain range spurious displacements.

Each device functions in high energy piping loops slow creep in the symmetry plane, comprising electromagnetic means for locking piping system into maximal thermal, mechanical efficiencies.

1. A super plant comprises absolute technologies an ultra-transport system, an ultra-cycling light fluids bulk power electromagnetic fluids creep, stiffness precise balancing displacements energy, minimum energy balancing, minimal energy displacements for cosmological global gravitational dynamics conforming nullities relativity energy cycles to energy relativity structures comprising:
a reactor radially inline to steam generators (SGs), primary coolant loops piping hot legs to the SG, cold legs return portions inside a primary containment, comprising Regions 1;
the reactor, primary coolant loops piping Regions 1, radial inline hot legs from the SG to turbines, condenser units to the SGs, secondary coolant loops cold legs return, Regions 2;
a containment, an annex building a light negative pressure, Regions 2 portion, Regions 3;
underground aqueducts, hydrosphere, cooling water, mega bulk power cycling Regions 4;
and bulk power electrical distribution and environment cycled epigene energy, Regions 5;
and means for opposing global air warming, affecting Heat Rate maximum efficiencies of the ultra-transport system and Regions 1-5 ultra-longevity boundaries an ultra-fluxing, an ultra-conserving the bulk power, the mega bulk power, sustaining boundaries perfections, the magnetosphere mega bulk power and Regions 4 portions of mega bulk power portion.

2. The ultra-transport system according to claim 1, comprising the primary, the secondary high energy piping coolant loops cycling the bulk power ultra-cycling light fluids' nullities affects the interactions energy, the relativity energy, the minimum energy balancing and the minimal energy displacements, unifying and bolstering the ultra-transport system and Regions 3 overall integrity.

3. The absolute technologies in Regions 1-5 according to claim 1, wherein in Regions 1-2 radially inline piping hot legs embodies into the ultra-transport system wind cones self-alignment effects, where electromagnetic fluid displacement a creep, a stiffness responses to electrical power inputs engenders electromagnetic fluid creep and stiffness inside an electromagnetic transducer, and the minimum energy balancing, the relativity energy, affecting the ultra-longevity of the super plant;

4. The displacement response to electrical power input according to claim 3, wherein a displacement total displacement yields a minimum energy balancing of the relativity energy, by the stiffness in confined electromagnetic fluid and nigh infinitesimal creep, which also affects the ultra-longevity of the super plant, the ultra-transport system by affecting dynamic loads damping.

5. The fluxing total displacements of the ultra-transport system according to claim 1 comprising the minimum energy balancing and the relativity energy sustained low static stresses, spawn interactions among loads, stresses, strains, and displacements, where the minimum energy balancing, the relativity energy low static stresses dampen or entirely suppress dynamic loads by electromagnetic fluid stiffness and creep, which grants the ultra-longevity of Regions 3 structure;

6. The super plant technologies according to claim 1, comprising the relativity energy Regions 3 comprises displacement energy above the minimum energy balancing and the minimal energy displacements, where the calibrated electrical power inputs balance the two energy forms, a steady electrical power inputs portion affects the electromagnetic fluids stiffness, creeping, and volume change, while fluxing electrical power inputs dampens fluxing energies cycling balances.

7. The ultra-transport system, the super plant technologies according to claim 1, comprising in Regions 3, the relativity energy, the minimum energy balancing, the bulk power cycling inside the ultra-conserving and the ultra-longevity of the sui generis boundaries perfections and also the mega bulk power Regions 5 transferring power, electrical energy in the ultra-longevity, the ultra-conserving Earth's gravity field balances energy in boundaries perfections of the magnetosphere.

8. The self-alignment of the ultra-transport system according to claim 3, wherein wind cone effects embody a self-alignment by the ultra-transport system to absolutely maximum energy conserving and engender cycling energy absolutely Heat Rate maximum efficiencies that cycle in Regions 3.

9. The absolute technologies according to claim 1, wherein the ultra-cycling of the light fluids, cosmological global gravitational dynamics by energy of conforming nullities total energy displacements yielding electromagnetic fluids creep stiffness, the energy relativity structures, the relativity energy, the minimum energy balancing, the minimal energy displacements by the ultra-conserving, the ultra-longevity boundaries in the ultra-fluxing, successive boundaries perfections effectuate: the PMII, FEIIPMII technologies and inbred means which oppose global air warming.

10. The super plant absolute technologies according to claim 1 yielding closed systems clustering in the ultra-longevity boundaries embodies the minimum energy balancing and the relativity energy relative fluxing effected by the electromagnetic fluids stiffness, creep, and volume change energy affecting optimally least stresses, strains Regions 3 structures and the ultra-longevity boundaries.

11. The super plant absolute technologies, the ultra-transport system according to claim 3, wherein the ultra-transport system cycling energy ultimate transfers by the electrical power inputs into the transducers affect the minimum energy balancing, the minimal energy displacements in the ultra-transport system engendering the light fluids highest rate cycling Heat Rate maximum efficiency, affecting equal opposite reaction least energy flow from the transducers into Regions 3 structure.

12. The super plant according to claim 1, engendering energy self-structuring genres of the light fluids, in the super plant, effect by the electromagnetic fluids nigh infinitesimal creep, in small total movement associated with optimal stiffness that configures the ultra-transport system.

13. The cooling water cycling the mega bulk according to claim 1, comprising the First Fluid Element underground aqueducts cross-section lengths effectuate cycling energies maximum conductance which cycles the EESD in environment cycling rates to atone for thermal energy differences in groundwater cycling epigene crust and the light fluids surface water runoff evaporations with condensations, precipitations cooling epigene crust fluids; the thermal energy difference, in time reduced differences raises energy of the gravitational sink and magnetic fields to resist the plasma fountains outflow, which provides time for radiating thermal energy to space.

14. The underground aqueducts mega bulk power cycling according to claim 1, comprising the Heat Rate maximum efficiencies most beneficial energy transferring, comprising beneficial energy transferring affecting the troposphere, tropopause, and electrical power cycling electrons perpetual fluxing at or greater than Heat Rate 100% efficiency yield the applied science and the gravity, magnetic fields energy strengths, environment conserving by GODPARTICLES.

15. The ultra-transport system according to claim 1, wherein the primary, secondary piping loops of the ultra-transport system cycle the bulk power, wherein the electromagnetic fluid transducers affect Regions 3 wall penetrations, bracings and base plates radial, polar and vertical displacements with Regions 3 expansion contraction devices controlling radial, polar, vertical and radial strain displacements, with Regions 3 polar, vertical, radial strains respective displacements by the containment, the annex building cycling maximally low stresses.

16. The ultra-transport system according to claim 1, comprises unique vertical plane symmetry with thermal, static and dynamic loads and displacements having that plane symmetry; the electromagnetic fluids electromagnetic devices confine displacements to that plane symmetry comprising vectors sum in, infinitesimal transverse vectors a sum to that plane, in that plane, and axial displacements expansion and contraction devices, the transducers affect displacements Heat Rate maximum efficiencies, spawning the ultra-longevity with the ultra-conserving of Regions 3.

17. The super plant according to claim 1, comprising a shallow, at grade water retention dish of stainless steel plate shell structure below grade engenders water capacity requirements, structural integrity and comprises support means for mechanical cooling towers cooling means for essential cooling during the super plant continuous essential operations in rare accidents or seismic events.

18. The super plant according to claim 3 comprises the primary containment a dome floor slab and hermetically sealed equipment access hatches above each of the SG; unbound longevity of the super plant requires the hatches have the primary containment polar crane full access into annex building compartments, granting means for replacing, or refurbishing the SGs through the annex building hermetic sliding doors and removable panels; multiple hatches engenders access means for robotically leaving reactor vessel parts.

19. Region 5 circuit boards, mother boards cycle energy according to claim 1, affect insulation thin sheets stack of mostly circular diameters of substantially rounded, stacked random concentric, or nonconcentric, each side entirely a flat surface—all stacks as a diverse page sizes book; the sheets generally embody cutout voids along with straight, nigh straight printed circuits, in both faces. A nigh flat basic circuit printed on each side of the thin sheets interconnects to a sheet above, below or above and below, or connects to any electrical component along a perimeter or on top or under a protruding sheet, a sheets stack, or sheets stacks respective sizes protruding portions or residing in a cutout void or cutout voids; the sheets embody a circuit board or a mother board configuring said electrical components and the cutout voids comprising fluid ducts; the sheets and the printed connecting fuse positively; stacking the sheets stacks the fluid ducts; innate, innate and forced, or innate, induced and forced, or innate and forced and induced a once flow thru cooling an ultimate cooling effect has the circuit board or the mother board absolute Heat Rate maximum efficiency, yielding concomitantly the ultra-conserving of electrical, the flow thru cooling respective energy; said circuit or mother board supplied power by the super plant cycles electron GODPARTICLES cycle the Heat Rate 100% efficiency, or higher; if higher, Earth's gravity infinitesimally slows its evolution—the evolution energy forcing potential plasmas fountain outflow infinitesimally slows.

20. The circuit board, the mother board according to claim 19, comprising an electrical device or the printed circuit, the fluid ducts each cross section relative configurations, spacing dispositions, energy cycling the absolute technologies algorithms concomitant modeling electric current, fluid ducts thermal radiation outflows, energy flows and the printed circuits and fluid ducts parameters and cross-sections affect readily; beneficial consumed energy ratios maximum sums sum affects the circuit, the mother board and the electrical device a respective Heat Rate efficiency; common and/or transistor temperature switches turning on-off ventilation fan or fans housed in a manifold or manifolds along respective perimeters of the circuit board, the mother board, and the electrical device yields the ducts fluid flow rate relative to electrical current and affects PMII technologies.

21. The light fluids cycles Regions 1-5 according to claim 1 comprising the underground lengths of aqueducts spawn the EESD environment boosts boundaries perfections of the energy relativity structures and the magnetosphere, therefore, and the light fluids cycling rate, which entirely blurs distinguishing byproduct from product, generated millennia longevity abundant electrical energy.

22. The underground aqueducts according to claim 1, engendering Regions 4 lengths comprise cross-sections of the First Fluid Element the PMII, FEIIPMII technologies, the absolute technologies, to affect a breeder device structure that breeds GODPARTICES. Wherein, inflows into said aqueducts, the aqueducts, cycle—beneficial, useful energy—embedded almost entirely in the light fluids environment cycles. The beneficial, useful energy, comprises thermal energies of conduction, radiation and convection. The aqueducts by conduction transfers portions of each of said three forms of thermal energies as one and the same energy that opposes evolving of Earth's gravity sink, comprising directionalities into rather than the past history directionalities out of the mantle. Beneficial, useful energy directionalities, by the three thermal energies, oppose volcanic eruption, tectonic movements and tsunami. Other directionalities, by said three thermal energies, radiate to space, air being thermal energy conduction insulator. Underground convection thermal energy being one and the same thermal energy form has the beneficial, useful energy one and the same as two of three thermal energies have, the previous explains. The light fluids upon outflow from the aqueducts and exposure to solar insolation gain convection thermal energy to evaporate and condensate water vapors to radiate thermal energy radiations to space, cycling as one and the same thermal energy in the beneficial, useful energy same cycles—global air warming avoidance. More of such cycles cycling the light fluids opposes evolving Earth's gravity sink; therein, atom, or molecule of the light fluids cycles GODPART1CLES or above the Heat Rate 100% efficiency.

23. The super plant according to claim 1, comprising cycling environment energy Regions 5 energy shunt, the energy shunt, including thermal radiation from Regions 1, 2 and 3 to Regions 4 and 5 cycled the MEHC absolute conserving energy, cosmological global gravitational dynamics embody boundaries perfections of the ultra-transport system, epigene surface, the super plant, the energy relativity structures and magnetosphere boundaries relatively and respectively; the energy shunt taps into cosmological gravitational dynamics and the light fluids cycling energy spawning boundaries perfections affected boundaries, from the ultra-transport system to the magnetosphere boundaries, which sustains, boost thermal energy radiating into space, into gravitational sink and concomitantly generates abundant electrical power which ultimately opposes global air warming.

24. The Heat Rate maximum efficiencies according to claim 14, comprising beneficial energy transferring affecting the troposphere, tropopause, and electrical power cycling electrons perpetual fluxing at or higher than Heat Rate 100% efficiency, yield the applied science the gravity and magnetic fields energy strengths and environment conserving GODPARTICLES.

25. The super plant absolute technology according to claim 1, wherein applied science PMII and FEIIPMII technologies—the PMII and FEIIPMII technologies—the MEHC absolute conserving—cycling energy the light fluids and the MEHC Regions 5, engendering maximal conductivity that maximally interconnects and couples the light fluids cycling Earth's gravitational field sink, also, the tropopause, troposphere cycling energy balances, to oppose global air warming in space time.

26. The super plant according to claim 1, duly and fully, stays out of the troposphere energy cycling.

27. The super plant absolute technology, the ultra-transport system according to claim 1, comprises the bulk power ultimately aligned routing Regions 1 primary coolant loops, Regions 2 secondary coolant loops, Regions 4 cooling water cycling in underground aqueducts lengths and from cooling water source locations to an outflowing affecting Regions 4 portion of hydrosphere ultra-conserving, ultra-cycling maximal conductivity Regions 4 cycling Earth's gravity field bulk power and the energy relativity structures cycling gravitational field and Earth's climate changes.

28. The absolute technologies of claim 1, reveals the super plant key technologies which spawn boundaries perfections for energy device structures cycling energy dynamics to Heat Rate maximum efficiencies affecting the ultimate longevity of energy cycling dynamics. The absolute technologies do affect science technologies criteria for energy devices cosmological gravitational dynamics do to affect gravitational field energy dynamics cycling technologies eternal longevity.
